(19) United States
(12) Patent Application Publication
(10) Pub. No.: US 2025/0056703 A1
(43) Pub. Date: Feb. 13, 2025

(54) X-RAY SOURCES

(71) Applicant: Technion Research & Development Foundation Limited, Haifa (IL)

(72) Inventors: Amnon BALANOV, Haifa (IL); Ido KAMINER, Haifa (IL)

(21) Appl. No.: 18/790,246

(22) Filed: Jul. 31, 2024

Related U.S. Application Data
(60) Provisional application No. 63/516,583, filed on Jul. 31, 2023.

(51) Int. Cl. H05G 2/00

(52) U.S. Cl. CPC H05G 2/00

(57) ABSTRACT

An X-ray generator is presented comprising: an electron source generating an accelerated electron beam propagating along a first propagation path with a first general propagation direction; a first crystalline structure located in the first propagation path, and defining a first crystal plane oriented at a predetermined non-zero angle with the first propagation path, and configured to transmit the electron beam therethrough and generate parametric x-ray (PXR) emission being first directional emission along a second propagation path tilted with respect to the first general propagation direction; and a second crystalline structure located in the second propagation path and configured as a monochromator with respect to the PXR emission, and defining a second crystal plane oriented at the predetermined non-zero angle with respect to the second propagation path to thereby provide second directionality for the PXR emission.

### TECHNOLOGICAL FIELD

The present disclosure relates to X-ray sources, in particular compact X-ray sources.

### BACKGROUND ART

References considered to be relevant to background to the presently disclosed subject matter are listed below:
[1]Y. Hayakawa et al., “X-ray imaging using a tunable coherent X-ray source based on parametric X-ray radiation,” J. Instrum., vol. 8, no. 8, 2013, doi: 10.1088/1748-0221/8/08/C08001.
[2]Y. Hayakawa et al., “Computed tomography for light materials using a monochromatic X-ray beam produced by parametric X-ray radiation,” Nucl. Instruments Methods Phys. Res. Sect. B Beam Interact. with Mater. Atoms, vol. 309, pp. 230-236, 2013, doi: 10.1016/j.nimb.2013.01.025.
[3]A. Balanov, A. Gorlach, and I. Kaminer, “Temporal and spatial design of x-ray pulses based on free-electron-crystal interaction,” APL Photonics, vol. 6, no. 7, p. 70803, July 2021, doi: 10.1063/5.0041809.
[4]B. Sones, Y. Danon, and R. C. Block, “X-ray imaging with parametric X-rays (PXR) from a lithium fluoride (LiF) crystal,” Nucl. Instruments Methods Phys. Res. Sect. A Accel. Spectrometers, Detect. Assoc. Equip., vol. 560, no. 2, pp. 589-597, 2006, doi: https://doi.org/10.1016/j.nima.2006.01.054.
[5]B. Sones, Y. Danon, and E. Blain, “Feasibility studies of parametric X-rays use in a medical environment,” AIP Conf Proc., vol. 1099, no. March, pp. 468-471, 2009, doi: 10.1063/1.3120075.
[6]M. Shentcis et al., “Tunable free-electron X-ray radiation from van der Waals materials,” Nat. Photonics, vol. 14, no. 11, pp. 686-692, 2020, doi: 10.1038/s41566-020-0689-7.
[7]Y. Hayakawa et al., “Tunable Monochromatic X-ray Source Based on Parametric X-ray Radiation at LEBRA, Nihon University,” AIP Conf Proc., vol. 879, no. 1, pp. 123-126, January 2007, doi: 10.1063/1.2436021.
[8]Y. Hayakawa et al., “Simultaneous K-edge subtraction tomography for tracing strontium using parametric X-ray radiation,” Nucl. Instruments Methods Phys. Res. Sect. B Beam Interact. with Mater. Atoms, vol. 402, pp. 228-231, 2017, doi: 10.1016/j.nimb.2017.03.014.
[9]Y. Hayakawa et al., “Geometrical effect of target crystal on PXR generation as a coherent X-ray source,” pp. 677-691, 2010, doi: 10.1142/S0217751X10050020.
[10]W. S. Graves et al., “Compact x-ray source based on burst-mode inverse Compton scattering at 100 kHz,” Phys. Rev. ST Accel. Beams, vol. 17, no. 12, p. 120701, December 2014, doi: 10.1103/PhysRevSTAB.17.120701.
[11]P. Musumeci et al., “Advances in bright electron sources,” Nucl. Instruments Methods Phys. Res. Sect. A Accel. Spectrometers, Detect. Assoc. Equip., vol. 907, pp. 209-220, 2018, doi: https://doi.org/10.1016/j.nima.2018.03.019.
[12]M. B. Callaham, “Quantum-mechanical constraints on electron-beam brightness,” IEEE J Quantum Electron., vol. 24, no. 10, pp. 1958-1962, 1988, doi: 10.1109/3.8525.

Acknowledgement of the above references herein is not to be inferred as meaning that these are in any way relevant to the patentability of the presently disclosed subject matter.

### BACKGROUND

Since the X-ray radiation discovery in 1895 by Wilhelm Róntgen, X-ray sources have been applied to a wide range of applications: medical diagnosis and treatment, electronic inspection, food security, pharmaceutical quality control, international border security, and many other fields. Despite their widespread use, the X-ray physical generation mechanism in laboratory-scale facilities remained relatively unchanged since the first X-ray tubes, i.e., electrons accelerate from a cathode and impact a target anode placed in a vacuum tube. Bremsstrahlung, also known as breaking radiation, and characteristic X-ray radiation are the two main X-ray production mechanisms of this process. The typical X-ray tube emission has a broadband spectrum due to the bremsstrahlung radiation with a few sharp lines produced by the characteristic X-ray radiation. This spectrum depends mainly on the anode material and the acceleration voltage applied to the cathode-anode pair. Notwithstanding the recent increase in brightness by micro-focus sources and especially liquid-jet anodes, which enable new applications by phase-contrast imaging and high-resolution diffraction, the X-ray tube isotropic radiation limitation remained the same. In particular, the phenomenon that nonrelativistic electrons emit X-ray photons into the entire solid angle, with only smooth modulations due to polarization and self-absorption effects, severely limits the X-ray tube brightness.

### GENERAL DESCRIPTION OF INVENTION

The need for a narrow energy linewidth and directional X-ray source would be advantageous for many applications. A significant radiation dose reduction would be possible by eliminating the X-ray frequencies outside the range required for the specific application. For example, mammographic examinations performed with nearly monoenergetic X-rays will deliver one-tenth to one-fiftieth of the radiation dose of a conventional X-ray system. This estimate is similar to angiography and other radiography studies. In the past decades, intense, tunable, and directional X-ray sources in the form of enormous, expensive synchrotron and free-electron laser facilities were developed. These facilities open the doors to the spectroscopy of material dynamics and biological processes by producing ultrashort X-ray pulses. The coherence of such X-ray sources enables higher-resolution imaging through phase-contrast techniques, and next-generation security inspection of microchips. However, the size and expense of synchrotrons and free-electron lasers have been an obstacle to their widespread adoption in commercial and medical applications. These limitations motivate research into new physical mechanisms for X-ray generation with the potential to create laboratory-scale X-ray sources that are tunable and directional. Parametric X-ray (PXR) source is one of the most prospective physical mechanisms to achieve this purpose.

PXR is produced from the interaction between relativistic electrons and a periodic crystalline structure. PXR source has several excellent properties (which can serve various applications, including biomedical imaging), as follows: It is a quasi-monochromatic source with a low energy linewidth. The emitted X-ray photon energy can be tuned by the crystal orientation. The X-ray energy does not depend on the energy of the incident electron. The PXR beam divergence is low and inversely proportional to the incident electron energy (γₑ⁻¹). It has been investigated extensively over decades, since the beginning of the 1970s, both theoretically and experimentally, and has been demonstrated in practical applications, such as phase-contrast imaging using differential-enhanced imaging (DEI), X-ray absorption fine structure (XAFS), X-ray fluorescence (XRF), and computed tomography (CT) [1][2].

Despite the significant research progress, the main limitation of commercializing the PXR source is its limited flux. For example, practical mammography imaging requires an X-ray beam flux of

$$∼ {10}^{5} - 1 {0}^{6} \frac{photons}{{mm}^{2}} ,$$

yet the maximal flux achieved in recent experiments is two orders lower than this requirement [1]. Two parameters determine the PXR source flux—the yield. i.e., the average number of photons produced per a single electron, and the electron source current, i.e., the number of electrons that pass through the target crystalline per time unit. Even though the PXR yield is high relative to other electron-driven sources, the self-absorption of the emitted X-ray photons within the thick PXR crystal limits its yield. Moreover, the thermal load on the PXR crystal limits the maximal incident electron beam current. In other words, the inelastic scattering of the electrons in the crystal causes a temperature rise and thermal vibrations, a process in which the emission yield decreases.

In the present disclosure the inventors propose a compact realization of the PXR source and analyze several methods to enhance the source flux to suitable levels for commercial applications. First, the electron source current is optimized by studying the thermal load and heat dynamics on the PXR crystal. In particular, the inventors have found an upper limit to the electron beam current that can pass through the PXR crystalline. Further, the inventors examined advanced PXR schemes which can further enhance the PXR yield, especially for lower PXR energies. Then, the PXR source signal-to-noise ratio (SNR) was optimized as a function of the bremsstrahlung radiation for different PXR photon and electron energies.

The inventors have thus developed a new (compact) X-ray generator (PXR source scheme) and practical parameters for realization.

According to one broad aspect of the present disclosure, the X-ray generator comprises:
an electron source configured and operable to generate an accelerated electron beam propagating along a first propagation path with a first general propagation direction;
a first crystalline structure arranged in said first propagation path, the first crystalline structure defining a first crystal plane oriented at a predetermined non-zero angle with said first propagation path, the first crystalline structure being configured to transmit said accelerated electron beam therethrough and generate parametric X-ray emission, being first directional emission of a photon flux, along a second propagation path tilted with respect to said first general propagation direction, and
a second crystalline structure located in said second propagation path and being configured as a monochromator with respect to said parametric X-ray emission, the second crystalline structure defining a second crystal plane oriented at said predetermined non-zero angle with respect to said second propagation path to thereby provide second directionality for the parametric X-ray emission, thereby producing a directional output photon flux.

Preferably, the X-ray generator has optimized structural/operational parameters providing improved photon flux (e.g., up to ˜2 orders of magnitude), especially at low photon energies (soft X-ray), particularly suitable for X-ray crystallography and mammography. Optimization of operational parameters of the electron source may include heat dissipation (optimization of electron pulse charge and repetition rate allowed to increase the maximal average current by ˜2 orders of magnitude compared to prior art values, i.e., in the range 500 μA-3 mA). Alternatively, or additionally, optimization of operational parameters of the electron source may include high X-ray brightness (expressed by a small PXR linewidth). This can be achieved by using a thermionic RF gun having optimized (e.g., low of about 1 mrad) beam divergence and beam spot size (e.g., <2 mm). This represents a relaxed condition for the brightness of the electron source, contrary to other X-ray sources (e.g., Synchrotron and ICS) which require high brightness electron sources being unacceptable for usage in a PXR machine due to too high thermal load.

Also, preferably, the X-ray generator has optimized crystal material and geometry. For example, the crystalline structure may be configured as a stack of multiple crystals. The configuration may be such that a thickness of each crystal is thinner than the absorption length of the parametric X-ray emission within the material of the crystal, and a distance between each two crystals in the stack is large enough such that the escape path of the parametric X-ray emission avoids going through the adjacent crystal.

Further, signal-to-noise of the X-ray generator operation can be optimized by optimizing the detector's angular aperture and electron beam's energy to the desired application, i.e., to the desired photon energy (through the known variation of the emission angle with photon energy) and/or by using the second crystal structure as a bandpass device for filtration of the PXR source noise (bremsstrahlung and transition radiation).

In some embodiments, the X-ray generator is configured and operable as a tunable generator.

The electron source may comprise an electron gun and an electron accelerator.

The electron source may be configured to focus the electron beam onto a predetermined spot size on the first crystalline structure. The electron source may comprise a quadrupole magnet.

The electron source may be controllably operable with predetermined repetition rate of electron beam generation.

The first crystalline structure may comprise a stack of multiple crystals.

Preferably, the thickness of each crystal in said stack is smaller than a characteristic absorption length for absorption of said parametric X-ray emission within a material of the crystal.

A distance between each two adjacent crystals in said stack of the multiple crystals may be selected to provide that an escape path of said parametric X-ray emission avoids going through the adjacent crystal, thereby increasing yield of said parametric X-ray emission.

An overall thickness, Lₒₚₜ, of said stack of the multiple crystals may be about 0.1X₀, where X₀ is a characteristic radiation length of material of the respective crystal.

The X-ray generator may be configured such that a photon flux of the parametric X-ray emission is above 1.5×10¹⁰ for photon energies below 25 keV and for any one of the following materials: tungsten, molybdenum, copper, silicon; or is above 1.1×10¹¹ for photon energies below 25 keV for graphite.

The electron beam may be transmitted through said first crystalline structure substantially parallel to a crystal edge surface.

As noted above, the electron source may be configured to focus the electron beam onto a predetermined spot size on the first crystalline structure. The electron beam spot size is preferably smaller than an absorption length of the parametric x-ray emission in material of the first crystalline structure.

In some embodiments, the electron source comprises a pulsed thermionic RF gun. Said pulsed thermionic RF gun may be configured to operate at repetition rates between about 200 Hz and about 460 Hz. The repetition rate may be determined depending on said predetermined spot size of the electron beam and a thermal diffusion coefficient of the material of said first crystalline structure.

The X-ray generator may have dimensions of about 3×3 m².

The X-ray generator may further comprise: a power supply and/or RF modulator and/or a Klystron, and a control system; and/or an optical transition radiation (OTR) system configured and operable to monitor a position and width of the electron beam on said first crystalline structure.

The X-ray generator may be configured and operable to generate said electron beam with maximal average current values in a range 500 μA-3 mA.

Further, in this disclosure, the inventors provide a novel coherent inverse Compton scattering (ICS) scheme, a special regime of ICS in which the electrons emit coherently. This scheme is generally similar to a high-gain Free Electron Laser (FEL), but in which the centimeter-period undulator is replaced by an intense counter-propagating laser field with a micro-meter periodicity, enabling a much lower interaction length between the electron beam and the driving EM field. In this process, the electrons are micro-bunched into bunches much shorter than the X-ray wavelength, resulting in a coherent emission from the electrons, such that the X-ray beam intensity scales quadratically with the electron source charge and not linearly as in the incoherent ICS scheme, and increasing the source brightness by many orders of magnitude relative to the incoherent ICS regime.

The main advantage of the coherent ICS compared with the high-gain FEL is the much shorter interaction length required to achieve the micro-bunching, more than three orders of magnitude. Therefore, instead of the >100 m interaction length required in the undulator, tens of centimeters are needed in the coherent ICS case, enabling the realization of a high-brightness source in a compact dimension. The inventors have found the conditions on the laser source and the electron beam for the micro-bunching regime fulfillment. The inventors have also shown how some of the requirements for the electron source and the laser beams are interchangeable. In addition, the inventors derived the quantum mechanical upper limit on the flux and brightness of the coherent ICS source.

Thus, according to another broad aspect of the invention, it provides an X-ray generator comprising:
an electron source configured and operable to produce a pulsed electron beam;
a laser source configured and operable to produce a pulsed laser beam,
wherein the pulsed laser beam counter-propagates with said pulsed electron beam thereby generating an X-ray wave caused by undulation motion of electrons of said pulsed electron beam; and
wherein interaction between the X-ray wave and the pulsed electron beam provides electron micro-bunching with periodicity of an X-ray wavelength and generation of a coherent X-ray emission substantially co-propagating with the pulsed electron beam.

The electron beam produced by the electron source may be of energy spread substantially not exceeding 10⁻⁵.

The electron source may be characterized by one or more of the following: emittance <2 nm-rad; producing an electron beam spot size of a few micrometers;
producing the pulsed electron beam having electron pulse density of at least 10²¹-10²² 1/m³.

The laser source may be characterized by one or more of the following: the laser beam having a spot size ≥100 μm; having the spot size bigger than a spot size of the electron beam, e.g., the laser beam having the spot size of a few hundredths micrometers, and the electron beam spot size is of a few micrometers.

The laser source may be characterized by one or more of the following: producing the laser beam having intensity fluctuations <0.5%; producing the laser beam having Rayleigh range larger than the interaction length; producing the laser beam having duration at least 10 picoseconds for soft X-ray and at least 100 picoseconds for hard X-ray; producing the laser beam linewidth which satisfies Fourier transform-limited pulse duration and is smaller than the Pierce parameter defining said electron micro-bunching, e.g., an electric field strength of the laser beam is in a range of 100-250 GV/m; producing the laser beam having divergence smaller than divergence of the electron beam.

Parameters of the laser beam are preferably selected in accordance with an operative wavelength of the laser source and in accordance with parameters of the electron beam source.

For example, said parameters of the laser beam comprise two or more of the following: laser beam energy, power, duration, coherence length, waist spot size and Rayleigh length.

The laser pulse energy, Eₚ^{(laser)} may be selected to satisfy the following condition:

$${E}_{p}^{( laser )} > \frac{{ϵ}_{0} {\vert {E}_{0} \vert}^{2}}{2} \frac{K {λ}_{u}^{3}}{{πρ}_{FEL}^{5 / 2}}$$

where ϵ₀ is a vacuum permittivity; E₀ is an electric field of the laser source; λᵤ is the operative wavelength of the laser source; K is the undulator parameter; and ρ_{FEL} is a Pierce parameter. Here, the undulator parameter is determined as:

eE₀λᵤ/2πmₑc²

where e is the electron charge, mₑ is the electron mass; and c is the speed of light.

The laser pulse energy is typically in a range of hundreds of Joules (J) to a few kJ.

The pulse duration, τₚ, is preferably selected to satisfy a condition:

$${τ}_{p} > \frac{{λ}_{u}}{c} \frac{1}{{ρ}_{FEL}}$$

For example, the pulse duration is of a few hundredths picoseconds.

Preferably, the laser beam waist, w₀, is selected to satisfy a condition:

$${w}_{0} > \frac{{λ}_{u}}{π} \sqrt[4]{\frac{8 {k}_{u}^{2} {γ}_{e}^{3}}{π {r}_{e} {n}_{e}}} where {k}_{u} = \frac{2 π}{{λ}_{u}}$$

is a wave number; γₑ is the electron energy; rₑ is the electron radius, nₑ is the electron pulse density.

According to yet further broad aspect of the present disclosure, it provides an X-ray generator comprising:
a cavity defining a radiation propagation path between four mirrors, said cavity comprising an interaction region (point) on said radiation propagation path;
an electron source configured and operable to produce a pulsed electron beam propagating along an electron beam path towards said interaction region;
a laser source unit configured and operable to produce a pulsed laser beam propagating along a laser beam path towards said interaction region,
wherein the pulsed laser beam counter-propagates with the electron beam along said radiation propagation path thereby generating an X-ray wave caused by undulation motion of electrons of the electron beam; and
wherein multiple interactions between the X-ray wave, the electron beam, and the laser beam within said cavity at said interaction region provide exponentially increasing power of coherent X-ray emission of X-rays being generated to a predetermined saturation power.

### BRIEF DESCRIPTION OF THE DRAWINGS

The patent or application file contains at least one drawing executed in color.

Copies of this patent or patent application publication with color drawings will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIG. 1 shows schematically an X-ray generator of the present disclosure for generating PXR emission;

FIGS. 2A to 2C show parametric X-Ray scheme, spatial shape, and energy tunability, wherein FIG. 2A shows the PXR source scheme; FIG. 2B shows the PXR spatial emission; and FIG. 2C shows the PXR frequency tunability;

FIGS. 3A and 3B show PXR angular distribution, polarization and yield, wherein FIG. 3A shows the PXR spatial shape and polarization; and FIG. 3B shows PXR yield for tungsten (W), Molybdenum (Mo), Copper (Cu), Silicon (Si), and highly oriented pyrolytic graphite (HOPG);

FIGS. 4A to 4D show heat dissipation impact on PXR crystalline, wherein FIG. 4A shows an incident electron beam with energy Eₑ and pulse charge of Qₚᵤₗₛₑ impacting the target crystalline (The assumption is that pulse duration is much shorter than the dissipation process characteristic time. During this process, energy is transferred to the crystalline and converted to heat (Eq. (6)). The heat is being dissipated in two ways—through conduction and black-body radiation. The graph displays the temperature rise of an incident electron with a pulse charge of Qₚᵤₗₛₑ=700 nC and a beam area A=1 mm² as a function of the incident electron energy and different materials); FIG. 4B shows two extreme cases for heat dissipation: the first is when the thermal conduction is the dominant dissipation mechanism, and the second is when the black-body radiation is dominant, wherein the dominance of each heat dissipation process depends on the crystalline thickness (Eq. (8)) and the graphs showing that the heat dissipation is faster for thinner materials, i.e., they can potentially absorb higher electron beam currents; FIG. 4C shows the spatial heat dissipation process after electron pulse arrival for the case when the thermal conduction mechanism is dominant, wherein the characteristic time for the heat dissipation is R_{beam}²/4D; and FIG. 4D shows a target crystalline that can be shifted to increase the incident electron beam current, similar to the rotating anode in X-ray tubes;

FIGS. 5A to 5D exemplify the optimization of the electron beam source as a function of heat dissipation, wherein FIG. 5A shows schematically the electron source temporal shape with a pulse duration τₚᵤₗₛₑ and an average current Iₚᵤₗₛₑ in each pulse impacting the PXR crystalline layer and the temperature of the PXR crystalline layer rising from Tₘᵢₙ to Tₘₐₓ during the pulse and reducing back to Tₘᵢₙ during the relaxation time; FIG. 5B shows the Debye-Waller factor (DWF) influencing the PXR yield for different materials; FIG. 5C the optimized PXR temperature and electron beam current; and FIG. 5D shows the optimized repetition rate which depends on the incident electron beam radius and the diffusion coefficient of the material, wherein the electron beam radius used is R_{beam}=1 mm;

FIGS. 6A to 6D exemplify PXR schemes for enhancing the PXR yield, wherein FIG. 6A shows schematically X-ray attenuation length due to photoelectron absorption and the graph shows the absorption length as a function of the PXR energy for different materials; FIG. 6B shows schematically electron beam multiple scattering and the graph shows the scattering length as a function of the PXR energy for different materials; FIG. 6C shows the multiple crystals PXR scheme where the crystals are stacked upon each other with two fabrication conditions: (i) each crystal is thinner than the absorption length and (ii) the distance between the crystals is larger than the escape path of the emitted photon; and FIG. 6D shows the “edge PXR” scheme where the electron beam passes within the crystal, in parallel to the crystal edge;

FIGS. 7A and 7B compare the photon rate between a classic PXR scheme and special PXR schemes for different materials, under the optimized working point of the electron source current and the detector's angular aperture, wherein FIG. 7A shows the PXR flux for a standard PXR geometry; and FIG. 7B shows the PXR flux for enhanced PXR geometry; the spectrum is split into regions for different applications;

FIGS. 8A to 8D exemplify PXR source signal to noise ratio (SNR) and optimized target angular aperture, wherein FIG. 8A shows the PXR experimental setup and competing radiation mechanisms (e.g., bremsstrahlung and transition radiation); FIG. 8B shows a typical emission spectrum of a PXR source where the characteristic lines and higher Miller indices (hkl) PXR energies are excluded for clarity; FIG. 8C shows the optimized detector's angular aperture for different electron energies; and FIG. 8D shows PXR source signal to noise ratio (SNR) as a function of PXR energy for different electron energies;

FIGS. 9A to 9D exemplify the crystal monochromator for bandpass filtering of PXR source, wherein FIG. 9A shows the principle of noise floor suppression by the monochromator; FIG. 9B shows PXR's spatial dispersion for a single electron source; FIG. 9C shows DuMond diagram of a crystal monochromator; and FIG. 9D shows non-dispersive crystal arrangement in symmetric Bragg geometry;

FIG. 10 exemplifies the influence of electron beam spot size and divergence on the PXR linewidth for two different relations between the electron beam spot size and the electron divergence;

FIGS. 11A to 11D show a comparison between Parametric X-ray (PXR) and two other sources X-ray, i.e., inverse Compton scattering (ICS) and characteristic radiation, wherein FIG. 11A shows the ICS X-ray source scheme; FIG. 11B shows characteristic radiation production mechanism from a rotating anode X-ray tube; FIG. 11C shows flux comparison between PXR, ICS, and characteristic radiation; and FIG. 11D shows brightness comparison between PXR, ICS, and characteristic radiation.

FIG. 12 shows temperature temporal profile in the center of the crystal after electron pulse arrival; the plots refer to two cases—a square beam and a circular beam;

FIGS. 13A and 13B show temperature profile for black-body radiation dominant regime, wherein FIG. 13A show black-body radiation temperature temporal profile; and FIG. 13B shows the maximal current density achievable for black-body radiation regime as a function of the crystal thickness;

FIG. 14 shows PXR spatial dispersion shape;

FIG. 15 shows the atomic scattering factor F₀(s) for Tungsten, molybdenum, and copper as a function of the Bragg angle and X-ray wavelength;

FIGS. 16A and 16B show PXR yield as a function of the crystal thickness when the self-absorption phenomenon is neglected, wherein FIG. 16A shows a comparison between PXR yield for the case that electron scattering is considered versus the case the electron scattering is neglected; and FIG. 16B shows the ratio between the two cases shown in FIG. 16A;

FIGS. 17A to 17C show PXR energy linewidth parameters, wherein FIG. 17A shows electron beam spot size; FIG. 17B shows crystal thickness; and FIG. 17C shows crystal mosaic.

FIGS. 18A and 18B illustrate the analogy between high-gain Free Electron Laser (FEL) in Self-Amplified Spontaneous-Emission (SASE) mode and the coherent inverse Compton scattering (ICS) in the high-gain regime, wherein FIG. 18A illustrates an energetic electron beam entering the undulator and emitting an incoherent X-ray beam in the direction of the electron beam motion (“co-propagating” X-ray beam); and FIG. 18B illustrates an analogous phenomenon to the high-gain FEL using an inverse Compton scattering scheme where the centimeter period undulator is replaced by a micro-meter wavelength high-power laser which generates the undulation of the electron beam;

FIGS. 19A and 19B illustrate the micro-bunching process, wherein FIG. 19A illustrates a scheme comprising the electron beam, the counter-propagating micrometer laser pulse, and the co-propagating X-ray laser pulse; and FIG. 19B illustrates the micro-bunching process;

FIG. 20A schematically illustrates an X-ray generator according to the present disclosure for generating coherent X-ray emission;

FIG. 20B illustrates incoherent inverse Compton scattering X-ray source scheme; and FIG. 20C illustrates the physical process of inverse Compton scattering;

FIGS. 21A and 21B schematically illustrate requirements on the electron beam energy and emittance and the laser beam for the electron beam micro-bunching; wherein FIG. 21A shows the electron beam energy spread causes a portion of the electron to “escape” from the modulation and the micro-bunching process, thus decreasing the emission coherence between the electrons; and FIG. 21B shows that the laser fluctuation causes a linewidth spread of the X-ray wave;

FIGS. 22A and 22B show comparison between the high-gain FEL and the coherent ICS in the high-gain regime; wherein FIG. 22A shows the power gain length L₀ as a function of the X-ray wavelength; and FIG. 22B shows the Pierce parameter as a function of the X-ray wavelength for FEL and coherent ICS schemes;

FIGS. 23A and 23B show the Pierce parameter and the space charge dependence on the electron charge density; wherein FIG. 23A shows the pierce parameter as a function of the electron charge density for X-ray wavelengths of 7 Å and 1.75 Å; and FIG. 23B shows the space charge density (kₚ) and the gain length (F) as a function of the electron charge density;

FIGS. 24A to 24C show requirements on the X-ray diffraction condition and the laser pulse duration and power; wherein FIG. 24A shows that the FEL gain length is shorter than the Rayleigh length of the copropagating X-ray beam for effective interaction between the X-ray beam and the electron pulse; FIG. 24B shows that the laser pulse duration is longer than the gain length in order to have sufficient interaction time with the electron beam; and FIG. 24C shows a combined view of the counterpropagating laser and the co-propagating X-ray wave;

FIG. 25 shows required electron beam normalized emittance for fully coherent emission;

FIG. 26 shows the limitation on the laser beam fluctuations as a function of the electric field strength;

FIG. 27 shows the minimal laser beam waist as a function of the electron charge density for different X-ray wavelengths;

FIGS. 28A and 28B show the laser pulse duration (FIG. 28A) and energy limits (FIG. 28B) as a function of the electron charge density for different laser pulse power;

FIG. 29 shows the allowed electron charge density as a function of the electron energy;

FIG. 30 shows Peak brightness of the coherent ICS scheme in a high-gain regime as a function of X-ray energy for two laser wavelengths: λᵤ=1 μm and λᵤ=10 μm;

FIGS. 31A and 31B compare the frequency spectrum of the incoherent ICS (FIG. 31A) and the coherent ICS (FIG. 31B) as a function of X-ray energy and emission angle;

FIG. 32 shows the X-ray generator of the present disclosure for generating coherent ICS in low-gain regime;

FIG. 33 shows the coherent ICS low gain function as a function of the detuning parameter;

FIG. 34 shows the gain function as a function of the X-ray energy; and

FIGS. 35A and 35B illustrate the high-gain ICS and low-gain ICS emission energy. FIG. 35A shows the emission energy in the high-gain regime as a function of the electron charge density and the laser pulse energy. FIG. 35B shows the emission energy in the low-gain regime as a function of the electron charge density and the cavity loss. The required laser pulse energy is a few tens of Joules for NIR laser.

### DETAILED DESCRIPTION OF EMBODIMENTS

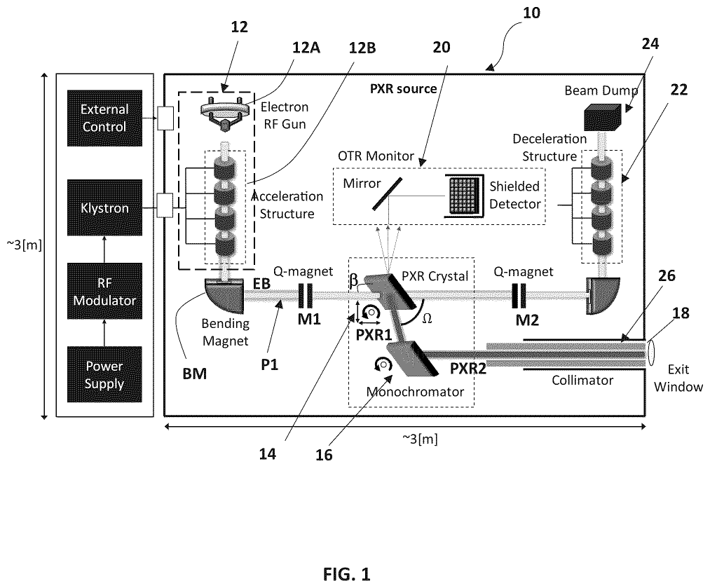

FIG. 1 exemplifies an PXR source/system 10 according to the present disclosure. The PXR system 10 includes: an electron beam generator 12, including an electron source 12A (based, e.g., on a thermionic RF gun) and an electron acceleration structure 12B, configured and operable for producing a relativistic electron beam EB propagating along a first propagation path P1 with a first general propagation direction. In the present non-limiting example, a bending magnet BM is optionally used to properly bend the propagation path P1 of the accelerated electron beam. Further provided in the system 10 are first and second crystalline structures 14 and 16. The first crystalline structure 14 is arranged in the first propagation path P1, and defines a first crystal plane oriented at a predetermined non-zero angle β with the first propagation path P1. The crystalline structure 14 is configured to transmit the electron beam EB therethrough and generate parametric X-ray emission PXR1 which is first directional emission propagating along a second propagation path P2 forming a non-zero angle C with the first general propagation direction P1. The second crystalline structure 16 is located in the second propagation path P2 and is configured as a monochromator with respect to the parametric X-ray emission PXR1. The crystalline structure 16 defines a second crystal plane oriented at the angle β with respect to the second propagation path P2 and provides second directionality for the parametric X-ray emission PXR1.

As also exemplified in the figure, two Q-magnets are accommodated in the first propagation path P1 and successively focus the accelerated electron beam EB: one Q-magnet M1 operates to focus the beam EB on the PXR crystal 14, and the other magnet M2 focuses the electron beam at a region before/upstream an electron beam dump. The so-focused electron beam then undergoes deceleration and beam dumping.

A double crystal scheme, based on a combination of the PXR crystal 14 and the monochromator 16, produces a filtered output PXR beam PXR2 with a fixed exit location (exit window) 18.

An optical transition radiation (OTR) subsystem 20 monitors the electron beam crossing with the PXR crystal 14. A deceleration structure 22 and a beam dump component 24 are used for the electron beam disposal. The output PXR beam PXR2 exits the system through a collimator 26 and the exit window 18. A power supply, RF modulator, a Klystron, and a control system feed and operate the PXR system 10. The estimated dimension of such PXR system can be ˜3×3 m², similarly to other tunable and compact X-ray sources, such as the inverse Compton scattering X-ray source.

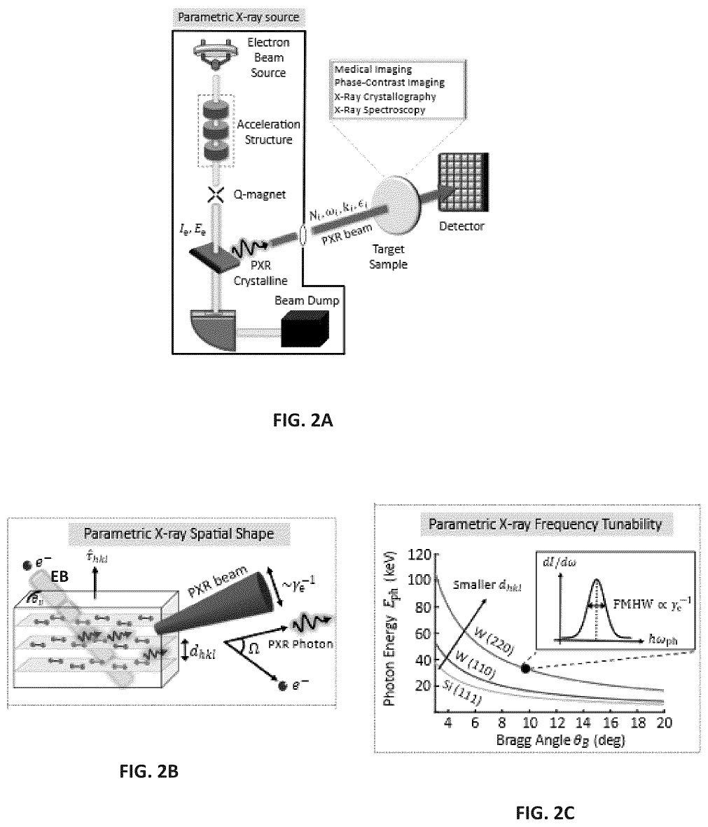

PXR radiation occurs when a relativistic charged particle passes through an aligned crystal relative to the charged particle beam as shown schematically in FIG. 2A. A collimated electron source beam impacts a crystal and induces polarization currents on the target material atoms. Each induced atom can be treated as a radiating dipole. When the Bragg condition of constructive interference between the dipoles array holds, an intense, directional, and quasi-monochromatic X-ray beam is emitted at a faraway angle from the electron trajectory.

In the present disclosure, an electron source beam is examined, but the technique of the present disclosure is not limited to the use of electron beam, since other charged particles exhibit similar phenomena.

FIG. 2B shows the spatial distribution of the PXR emission. The incident electron beam impacts the crystal Bragg plane f with an angle θ_{B}. The PXR photon is produced with an angle Ω relative to the electron trajectory. The Bragg condition holds for Ω=2θ_{B}. The PXR emission is spatially narrow and confined to a cone shape inversely proportional to the Lorentz factor of the electron γₑ⁻¹. This radiation is known as PXR by analogy to the optical radiation, also is also termed as: dynamical radiation, resonance radiation, quasi-Cerenkov radiation, or dynamical Cerenkov radiation.

Several equivalent descriptions exist for the PXR production phenomenon. A collimated electron source beam impacts a crystal and induces polarization currents on the target material atoms. Each induced material atom acts as a radiating dipole. When the Bragg condition of constructive interference between the dipoles array holds, an intense, directional, and quasi-monochromatic X-ray beam emits at a large angle relative to the electron trajectory, as shown in FIG. 2B. This can be interpreted as a combined effect between two conditions that hold: the Smith-Purcell condition from the dipoles parallel to the electron trajectory axis and the transverse plane dipoles constructive interference condition [3]. An equivalent interpretation of the PXR phenomenon is the diffraction of a virtual-photon field of an electron by the array of atoms in the crystal. The diffracted virtual photons appear as real photons at the Bragg angle corresponding to the diffraction of X-rays, i.e., the virtual photons diffract from the crystal planes the same as real photons diffract. The Bragg Law governs the X-ray diffraction conditions and relates the photon energy, the inter-lattice d-spacing between crystal planes, and the incident angle between the photons and the diffraction plane. Consequently, continuously tunable PXR production is possible with the rotation of the target crystal as described in FIG. 2C. The expression for calculating the PXR energy is given by:

$${E}_{PXR} = {ℏω}_{PXR} = \frac{2 π ℏc}{{d}_{hk 1}} \frac{sin {θ}_{B}}{1 - cos Ω} , \qquad ( 1 )$$

where dₕₖₗ is the d-spacing of the Bragg plane which corresponds to Miller indices (hkl), θ_{B} is the angle between the incident electron to the Bragg plane and Q is the emitted angle of the PXR photon relatively to the electron beam. Bragg's law is satisfied for the condition Ω=2θ_{B}, which produces the maximum PXR intensity. This relation allows PXR energy tunability in experiments by rotating the PXR crystal, i.e., altering the Ω and θ_{B} angles [4].

It should be noted that the PXR photon energy is effectively independent of the incident electron energy for relativistic electrons with energy above ˜5 MeV, and the photon energy is determined solely by the spacing between the crystal planes and the experimental geometry. The typical energy linewidth of the PXR can be as low as ˜1%.

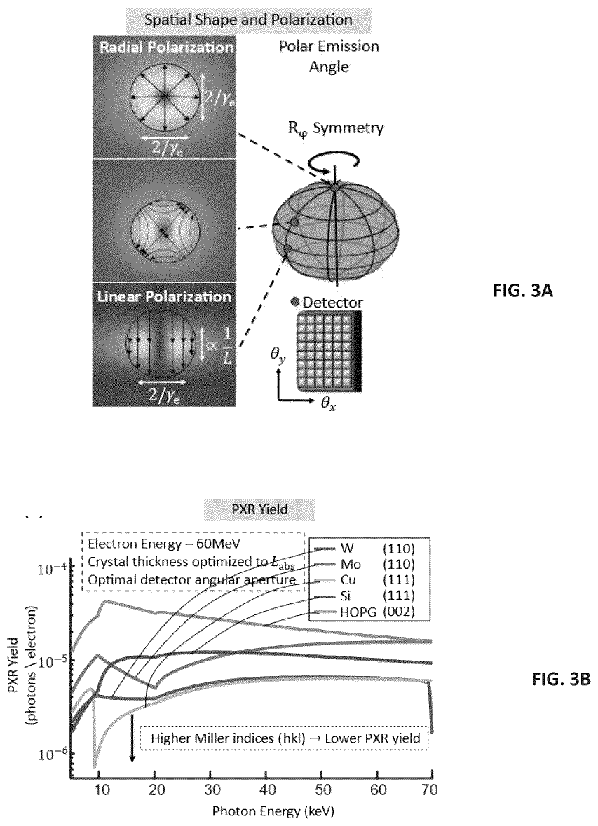

Except for the energy tunability by the crystal rotation, the PXR radiation has several additional characteristics which make it a prospective physical mechanism for a compact X-ray source. The PXR radiation presents a directional, polarized, and partially coherent X-ray source. Its polarization and spatial shape can be designed and shaped as shown in FIG. 3A [3]. For instance, the PXR beam can have either a radial polarization with a circular shape peak or a linear polarization with two lobes shape, depending on the emission angle. In addition, the PXR emission has a narrow energy linewidth of <1%, which makes it suitable for phase-imaging applications. The PXR emission propagates at a large angle relative to the electron trajectory, which eliminates the need for a strong magnetic field to separate the electrons from the X-rays and minimizes the bremsstrahlung background radiation. PXR energy does not depend on the incident electron energy, its radiation angle can be as large as 180 degrees, and it has no theoretical limits for the incident particle energy, meaning that this radiation mechanism exists at any beam energy [3]. PXR has additional advantages over other X-ray radiators based on free-electron sources. Hard-X-ray generation from transition radiation and synchrotron radiators requires much higher electron-beam energies than those required for PXR. For example, to produce 10 keV X-ray photons, synchrotron radiators require 3 GeV beams, while transition radiation requires 300 MeV. PXR, on the other hand, occurs even at energies below 10 MeV. The low electron energy makes the PXR source considerably more compact and less expensive than synchrotron sources. In addition, the PXR source' yield is the highest among the electron-driven X-ray sources and is greater up to four orders of magnitude than other X-ray sources, such as bremsstrahlung, transition radiation, and coherent bremsstrahlung.

Similar to the X-ray diffraction theory, the theoretical framework of PXR can be divided into the kinematical theory and the dynamical theory. The PXR dynamical theory, as developed by Baryshevsky and Feranchuk, Garibyan and Yang, and A. Caticha, considers all the PXR multiple scattering effects, including refraction, extinction, and interference effects, which alter the shape and width of the PXR peaks.

On the other hand, the kinematical theory, which is a more simplified model, ignores these effects, as made in the description of Ter-Mikaelian and Nitta, and was recently rederived for heterostructures [3]. The kinematical theory is derived from the classical electrodynamics framework and is valid for thin materials below the extinction length (Lₑₓₜ˜1 μm). However, the kinematical model has been validated experimentally with an excellent agreement for thick materials above the extinction length [4]; therefore, it will be used throughout the description.

The PXR photon distribution for a single electron in the kinematical model is given by:

$$\frac{d {N}_{PXR}}{d {θ}_{x} d {θ}_{y}} = \frac{α}{4 π} \frac{{ω}_{B}}{c {sin}^{2} {θ}_{B}} {f}_{geo} {χ}_{g}^{2} {e}^{- 2 W} N ( {θ}_{x} , {θ}_{y} ) , \qquad ( 2 )$$

where α is the fine-structure constant, ω_{B} is the emitted PXR photon energy, c is the speed of light, θ_{B} is the Bragg angle, e^{-2W} is the Debye-Waller factor, χ_{g} is the Fourier expansion of the electric susceptibility, N(θₓ,θ_{y}) is the PXR angular dependence, and f_{geo} is the geometrical factor.

The PXR angular dependence is given by:

$$N ( {θ}_{x} , {θ}_{y} ) = \frac{{θ}_{x}^{2} {cos}^{2} ( 2 {θ}_{B} ) + {θ}_{y}^{2}}{{( {θ}_{x}^{2} + {θ}_{y}^{2} + {θ}_{ph}^{2} )}^{2}} , \qquad ( 3 )$$

where θₓ is the angle in the diffraction plane, By is the angle perpendicular to θₓ in the diffraction plane and

$${θ}_{ph}^{2} = \frac{1}{{γ}_{e}^{2}} + {( \frac{{ω}_{p}}{ω} )}^{2} ,$$

where ωₚ is the plasma frequency of the material.

For the purposes of this disclosure, the inventors utilize the regime 1/γₑ²>>(ωₚ/ω)², i.e., θₚₕ≈γₑ⁻¹. The Fourier expansion of the electric susceptibility χ_{g} describes the diffraction efficiency, and is directly connected to the scattering factor of the crystal:

$${χ}_{g}^{2} = \frac{{λ}^{4} {r}_{e}^{2}}{{π}^{2} {V}_{c}^{2}} {S}_{hkl}^{2} [ {( {F}_{0} ( g ) + {f}_{1} - Z )}^{2} + {f}_{2}^{2} ] , \qquad ( 4 )$$

where λ is the emitted PXR wavelength, rₑ is the electron radius, V_{c} is the volume of the crystal unit cell, Sₕₖₗ is the structure factor, Z is the atomic number and F₀(g), f₁, f₂ are the atomic form factors.

The term F₀(g) describes the momentum transfer efficiency of the beam, i.e., for lower-emission angles Ω, the yield will be higher (PXR scattering factor and momentum transfer dependence on the PXR yield are described further below in section 2.4). The geometrical factor f_{geo} captures the PXR photons' self-absorption phenomenon and is limited by the crystal absorption length. Generally, the geometrical factor f_{geo} and the electric susceptibility χ_{g} compete, i.e., higher Z materials are more efficient in producing PXR but have shorter attenuation lengths compared with lower Z materials. This trade-off, as well as advanced PXR schemes that overcome the geometrical factor limitation, will be treated further below.

FIG. 3A describes the spatial shape of the PXR emission for different emission angles, and FIG. 3B presents the PXR yield for various materials, in particular tungsten (W), Molybdenum (Mo), Copper (Cu), Silicon (Si), and highly oriented pyrolytic graphite (HOPG). The calculation assumptions are: the electron source energy is 60 MeV, the crystal thickness is optimized to the absorption length of each of the materials for each PXR energy, and the detector's angular aperture is optimized. The largest d-spacing dₕₖₗ of each of the materials is presented. For smaller d-spacing, the yield decreases due to the momentum transfer. Generally, lighter materials have a higher PXR yield. In particular, Graphite exhibits the highest yield, due to a long absorption length.

The first experimental realization of PXR occurred in 1985. V. G. Baryshevsky et al. used a 900 MeV electron beam from the Tomsk synchrotron to produce a 6.96 keV PXR from a diamond crystal. Since then, numerous studies have been conducted to characterize PXR from different materials: silicon (Si), germanium (Ge), molybdenum (Mo), HOPG, diamond, tungsten (W), copper (Cu) [5], aluminum (Al), lithium fluoride (LiF) [4], and gallium arsenide (GaAs). Moreover, PXR was studied not only on monocrystalline but also over other structures, i.e., tungsten powders, van-der-Waals (vdW) materials [6], and polycrystalline. While the first experiments were performed in synchrotron facilities with electron beam energies of hundreds of MeV, later ones used linear accelerators with electron energies of tens of MeV. This progress paved the way for using PXR machines in a laboratory-scale facility. In addition, a few experiments explored the interference between PXR and coherent bremsstrahlung (CBS) mechanisms from moderately relativistic electrons. However, their yield and brightness were significantly lower compared with relativistic electrons.

In the last two decades, the PXR source mechanism has been demonstrated also for imaging applications. Two groups have shown the PXR feasibility as a compact and tunable source for imaging—the first group is from Rensselaer Polytechnic Institute (RPI), which was active during the years 2002-2009 [4][5], and the second group is from LEBRA, Nihon University which was active during the years 2004-2019 [7][8].

Table 1 presented below summarizes the PXR source parameters for the two experimental setups. In these experiments, images of computer chips and animals (fishes, mice, eye-pig) were taken. Moreover, phase-contrast imaging and 3D tomography were demonstrated. These results suggested that PXR has spatial coherence and is a suitable X-ray source for imaging. Despite the significant progress made in these experiments, they were still limited due to a requirement for a long exposure time (˜tens of seconds) due to insufficient flux levels.

TABLE 1

| | | Y. Hayakawa | | B. Sones et al. [4] | |
|---|---|---|---|---|---|
| | Parameter | et al. [7] | | [5] | |
| General | Year | 2004-2019 | | 2002-2009 | |
| | Facility | LEBRA, | | Rensselaer | |
| | | Nihon University | | Polytechnic Institute | |
| Electron | Energy | 100 | MeV | 56 | MeV |
| Source | Energy spread | ≤1% | | ≤1% | |
| | Electron Pulse Duration | 4-5 | μs | <5000 | ns |
| | Pulse Beam Current | 120-135 | mA | <400 | mA |
| | Repetition Rate | 2-5 | Hz | 3 | Hz |
| | Average Beam Current | 1-5 | μA | 6 | μA |
| | Normalized Emittance | ~15π mm mrad | | Not known | |
| | Electron beam size on target | 0.5-2 | mm | ~1 | cm |
| | (diameter) | | | | |
| Target | Materials | Silicon | | Lithium fluoride | |
| Crystalline | | | | (LiF) | |
| | Thickness | 200 | μm | 500 | μm |
| | Geometry | Bragg\Laue | | LiF (200) | |
| | Bragg Angle | 6°-30° | | 15° | |
| X-Ray Photon | Photon Energy | Si (111) - 4-20 keV | | 6-35 | KeV |
| | | Si (220) - 6.5-34 keV | | | |
| | Total X-Ray Photon Rate | ~10⁷ | | ~10⁶ | |
| | (photon/s) | | | | |
| Target | Range from PXR source | ~10[m] | | ~1[m] | |
| Sample | Beam diameter on target | ~100 | mm² | ~3 | mm² |

| | | |
|---|---|---|
| Total Photon X-Ray flux | ~10³ | ~10³ |
| (photon/mm²/s) | | |

In the following the inventors describe the novel findings of the present disclosure related to the optimization of heat dissipation of the PXR source.

Intuitively, the PXR source brightness will increase when transmitting as many electrons as possible through the PXR crystal with the smallest possible spot size. However, when a high average current impacts the PXR crystal, the total energy deposited in the crystal can be quite large. This process may lead to significant heating of the crystal. The heating causes a thermal vibration of the crystal lattice, which decreases, in turn, the PXR yield. Therefore, to achieve the highest possible PXR flux, the inventors optimize the heat load on the PXR crystal.

In the following, the PXR crystal temperature is estimated as a function of the electron source current, repetition rate, and spot size. Then, the inventors find an optimized upper limit to the current density that can pass through the target. It is assumed that the electron source is a pulsed source, with a pulse duration τₚᵤₗₛₑ much shorter than the heat dissipation process time.

Relativistic electrons lose a small fraction of their kinetic energy when passing through the PXR crystal. The energy loss goes partially into radiation emission (i.e., bremsstrahlung) and partially into heat. To estimate the energy loss of the electron that transfers into heat, the inventors calculate the inelastic collision stopping power. This power describes the average energy loss per unit length due to Coulomb collisions. The Bethe-Bloch formula describes the mean electron energy loss due to this process:

$$- 〈 \frac{{dE}_{e}}{dx} 〉 = 4 π NZ ( \frac{{z}^{2} {e}^{4}}{{mv}_{e}^{2}} ) [ ln ( \frac{2 {γ}_{e}^{2} {mv}_{e}^{2} {T}_{max}}{{( ℏ 〈 ω 〉 )}^{2}} ) - {β}^{2} - \frac{δ ( βγ )}{2} ] , \qquad ( 5 )$$

where Z is the material atomic number, N is the material density, vₑ=βc is the electron velocity, γₑ is the Lorentz factor, m is the electron rest mass, ℏ [symbol] ω [symbol] is the mean excitation potential, Tₘₐₓ is the maximum energy transfer in a single collision, and S is Fermi's density correction. The typical values of the mean energy loss are ˜2 (MeV cm²/g). From Eq. (5) it follows that the electron energy loss increases linearly with the atomic number Z, meaning that a higher heat load transfers to heavier materials.

The heat from a single accelerator pulse is deposited in a volume determined by the electron beam spot size and the thickness of the PXR crystal. Assuming the cooling is negligible during the pulse, the temperature load AT in this volume can be expressed by:

$$Δ T = \frac{〈 {dE}_{e} ∖ dx 〉}{{C}_{p} ρ} \frac{{Q}_{pulse}}{A} , \qquad ( 6 )$$

where [symbol] dEₑ\dx [symbol] is the average electron energy loss per unit length given by Bethe-Bloch formula, ρ is the PXR material mass density, Cₚ the PXR material specific heat capacity, Qₚᵤₗₛₑ the total charge per second, and A is the electron beam spot area. The temperature load depends not only on the number of electrons that impact the crystalline (Qₚᵤₗₛₑ) but also on the active beam area (A). As the electron beam is more concentrated, the heat load is higher.

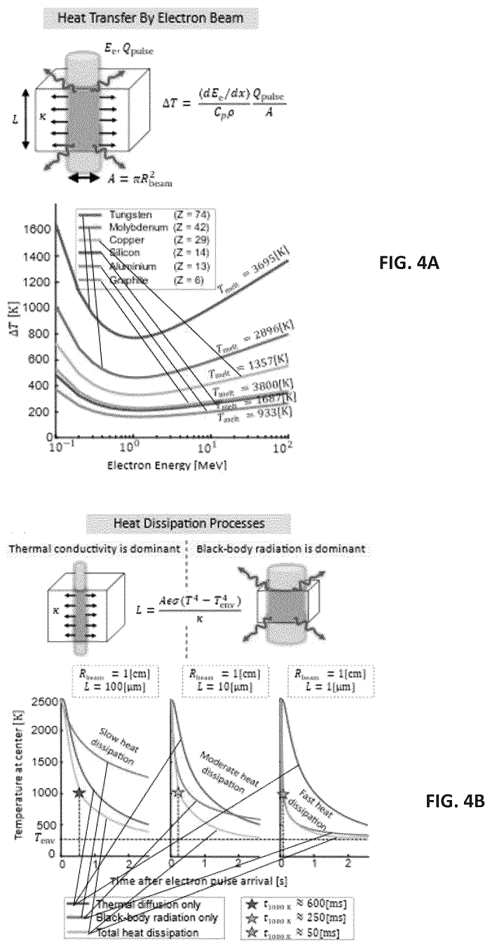

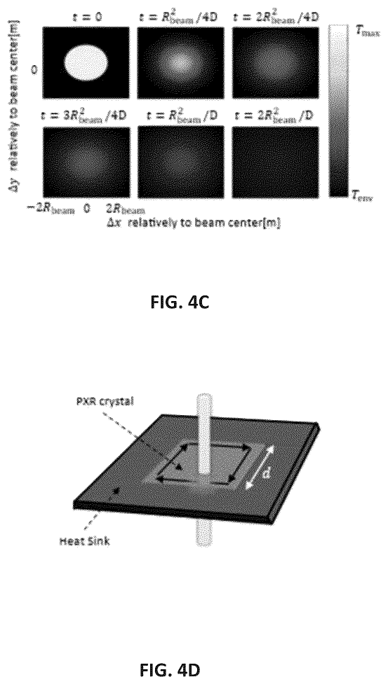

FIG. 4A shows the temperature load, ΔT, for different materials (W, Mo, Cu, Si, Al, HOPG) as a function of the incident electron energy, for an electron beam with a pulse charge of Qₚᵤₗₛₑ=700 nC and beam dimensions of A=1 mm². When examining the temperature dependence on the incident electron energy, electrons with low energy suffer from higher energy loss. On the other hand, for incident electron energies above ˜1 MeV, the energy loss increases logarithmically with the electron energy, i.e., the temperature load is relatively slow. When examining the PXR target material, tungsten exhibits the highest temperature load due to high electron energy loss, yet its melting temperature is higher relative to the other materials examined. Graphite shows the best heat load due to low temperature load and high melting temperature.

During the time between the accelerator pulses, the heat is both thermally conducted in the direction of the edge of the crystalline and partially dissipated by the black-body radiation through the crystalline surfaces as shown in FIG. 4B. The temperature profile in the crystalline T(r,t) can be derived from the heat equation:

$$ρ {C}_{p} \frac{\partial T}{\partial t} - κ {∇}^{2} T = {P}_{source} - {P}_{sink} - \frac{ϵ σ}{L} ( {T}^{4} - {T}_{env}^{4} ) , \qquad ( 7 )$$

where κ is the heat conductivity, P_{source} is the power per unit volume deposited in the crystalline by the electron beam, Pₛᵢₙₖ is the power per unit volume which is cooled at the edge of the crystalline. The last term in Eq. (7) represents the black-body radiation, where ϵ is the material emissivity,

$$σ = 5.67 \times 1 {0}^{- 8} [ \frac{w}{{m}^{2} {K}^{4}} ]$$

is Stefan-Boltzmann constant, L is the material thickness, and Tₑₙᵥ is the environment temperature. For the time between the electron pulses, P_{source}=0. The heat diffusion equation has two extreme behaviors—the first is when thermal conduction is the dominant heat dissipation process, and the second is when the black-body radiation is dominant. The material thickness (L) and the electron beam active area (A) control the dominant regime. Intuitively, when the material is thin, and the electron beam dimension is large enough, the black-body radiation will be the dominant heat dissipation mechanism, since the active radiation area will be larger than the heat conduction volume between the crystal surfaces. The characteristic length which governs the two regimes is defined by:

$${L}_{HD} = \frac{A ϵ σ ( {T}^{4} - {T}_{env}^{4} )}{κ} , \qquad ( 8 )$$

when L<<L_{HD}, the black-body radiation is being the dominant heat dissipation mechanism, whereas for L>>L_{HD}, the thermal conduction acts as the dominant one.

FIG. 4B shows the heat dissipation process for the different regimes.

In the following a tungsten PXR crystal is taken as an example and the temperature profile is examined as a function of the crystal thickness under the following assumptions: the initial temperature is T=2500K, and the electron beam active area is A=1 cm². When the material thickness is L=100 μm, thermal conduction is the dominant regime, and the dissipation process is relatively slow. On the other hand, when the material thickness is L=1 μm, the black-body radiation is the dominant mechanism, and the heat dissipation process is much faster. For the rest of the description, it will be assumed that thermal conductivity is the dominant regime as it sets a stricter limit on the possible electron beam current which impacts the target crystal. This assumption holds in most of the experimental cases (L>>L_{HD}). However, when working in the black-body radiation regime, i.e., thin materials, the possible electron beam current can get up to an order of magnitude higher relative to the case of only thermal conductance. This factor is especially advantageous for materials whose absorption length is in the order of ˜μm with a high melting temperature, such as tungsten, which could absorb higher electron beam currents.

FIG. 4C shows the spatial temperature profile after the electron pulse transition through the PXR crystal. Immediately after the electron pulse ends, the temperature in the active beam area A=πR_{beam}² is maximal and is given by the temperature load (Eq. (6)). In this stage, the thermal diffusion process starts. The heat diffusion speed is characterized by the thermal diffusion coefficient D [symbol] κ/ρCₚ. The typical thermal diffusion coefficients of the examined materials in the present disclosure are 0.5-1 [cm²/s] as shown in Table 2 below. The characteristic diffusion time is defined by τ_{D} [symbol] R_{beam}²/4D as the time elapsed from the end of the electron pulse until the temperature in the center of the beam drops to Tₘₐₓ(1−e⁻¹). The heat diffusion process timescale depends on the beam area τ_{D}∝R_{beam}², i.e., as the beam area is larger, the dissipation time is longer. This implies that if a greater pulse charge goes through the PXR crystal by increasing the beam area, the dissipation process will take longer, proportionally to the beam area.

TABLE 2

| | | Optimal | Maximal | Maximal |
|---|---|---|---|---|
| | Diffusion | repetition | pulse | average |
| | coefficient | rate | charge | current |
| Material | [cm² s⁻¹] | [Hz] | [μC] | [mA] |
| Graphite | 0.93 | 372 | 10 | 3.77 |
| Aluminum | 0.987 | 395 | 3.14 | 1.25 |
| Silicon | 0.92 | 365 | 4.4 | 1.61 |
| Copper | 1.163 | 465 | 2.12 | 0.99 |
| Molybdenum | 0.537 | 214 | 3.1 | 0.66 |
| Tungsten | 0.695 | 278 | 2.2 | 0.62 |

So far, the inventors have treated the general case of heat dissipation in a crystal but did not analyze the influence of the temperature load on the PXR yield. To treat the last factor, the inventors consider the crystal atoms' vibration by the Debye-Waller factor. The vibrations are due to two distinct phenomena. The first is purely quantum mechanical in origin and arises from the uncertainty principle. These vibrations are independent of temperature and occur even at absolute zero temperature. For this reason, they are known as zero-point fluctuations. At finite temperatures, elastic waves (or phonons) are thermally excited in the crystal, thereby increasing the amplitude of the vibrations. Those thermal vibrations cause PXR phase loss between the lattice dipoles, leading to a decrease in the PXR yield. This effect depends on the material-specific Debye temperature, T_{D}, the material temperature, T, and the d-spacing of the diffraction plane of interest, dₕₖₗ. The first quantity of interest is the mean square amplitude of the thermal vibration of the crystal, u²(T). This quantity is given by:

$${u}^{2} ( T ) = \frac{3 {ℏ}^{2}}{4 {Mk}_{B} {T}_{D}} [ 1 + 4 {( \frac{T}{{T}_{D}} )}^{2} {\int }_{0}^{{T}_{D} / T} \frac{γ}{{e}^{y} - 1} dy ] , \qquad ( 9 )$$

where M is the material mass, and k_{B} is the Boltzmann constant. The Debye-Waller term is calculated from u²(T) and the reciprocal lattice vector τ=2π/dₕₖₗ using the relationship e^{-2W}=exp(−τ²u²(T)).

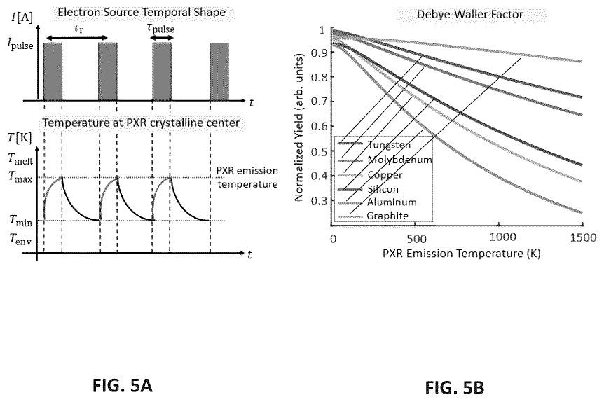

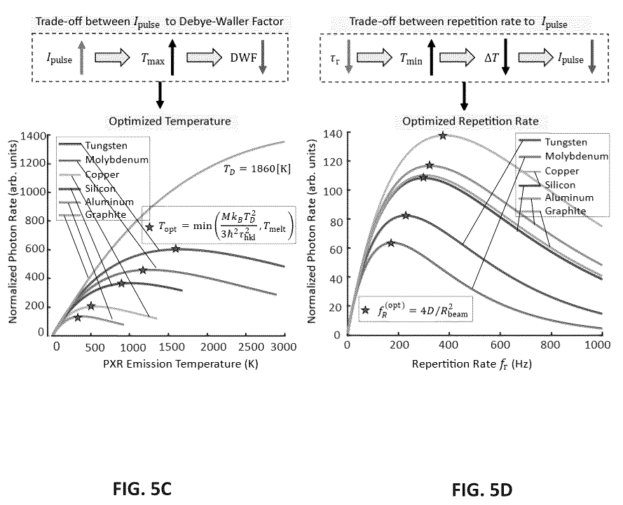

FIG. 5B shows the impact of the Debye-Waller factor on the PXR yield. As the temperature increases, the PXR yield drops exponentially, meaning that there is a trade-off between the electron beam current strength to the Debye-Waller factor impact on the PXR yield. A higher electron beam current is desired, yet it increases the PXR crystal temperature, which causes, in turn, a decrease in the PXR yield. Due to this phenomenon, the target temperature is optimized for a maximal PXR flux. FIG. 5A describes the electron current scheme—an electron pulse with duration τₚᵤₗₛₑ and an average electron current of Iₚᵤₗₛₑ transfers through the target crystal with a repetition rate of f_{R}=1/τ_{R}. It is assumed that the pulse duration is much shorter than the thermal diffusion characteristic time τₚᵤₗₛₑ<<τ_{D}. During the electron pulse, the crystal temperature increases by ΔT=Tₘₐₓ−τₘᵢₙ (Eq. (6)). After the electron pulse ends, the temperature drops exponentially, while it is assumed at this point that only thermal conductivity takes place in the heat dissipation process.

The inventors aim to optimize the values of the electron beam dimensions R_{beam}, the repetition rate f_{R}, and the pulse charge Qₚᵤₗₛₑ as a function of the target material type and the dimensions. The optimized values are given by (optimization of the electron source current and repetition rate is described further below in section 1.6):

$${T}_{opt} = min ( \frac{{Mk}_{B} {T}_{D}^{2} {d}_{hkl}^{2}}{12 {π}^{2} {ℏ}^{2}} , {T}_{melt} ) , \qquad ( 10 )$$

$${f}_{R} = 4 D / {R}_{beam}^{2} ,$$

and the optimal electron source current is given by:

$${I}_{opt} = \frac{4 π exp ( - 1 ) {κT}_{opt}}{〈 {dE}_{e} ∖ dx 〉} \qquad ( 11 )$$

This result has surprising outcomes. First, the optimal maximal temperature is lower than the melting temperature and depends on dₕₖₗ². As the inter-lattice distance decreases, the optimal temperature drops. Intuitively, the thermal vibrations are more severe for lower inter-lattice distances dₕₖₗ, as the relative phase shift is inversely proportional to the inter-lattice distance. Second, the optimal current (Iₒₚₜ=Qₚᵤₗₛₑf_{R}) does not depend on the beam area since the optimal repetition rate is f_{R}∝1/R_{beam}² and the optimal pulse charge is Qₚᵤₗₛₑ∝R_{beam}². In other words, as the beam spot size increases (meaning a lower heat load density), the heat dissipation typical timescale increases by the same factor, reducing the possible electron source repetition rate.

FIGS. 5C and 5D show the PXR flux dependence on the pulse charge and the repetition rate, respectively. Table 2 presented above summarizes the optimal repetition rate, charge pulse, and average current for Graphite, Al, Si, Cu, Mo, and W for an electron beam source with radius of 1 mm. Overall, the optimized electron source current is in the range of ˜500-3000 μA. The optimal electron beam charge per pulse for this beam dimension is between 2 μC-10 μC, depending on the material and the Bragg plane. The pulse charge density is similar to the values used in previous experiments. On the other hand, the repetition rate values are between 200-400 Hz, which are about two orders of magnitude higher than those used in previous experiments (Table 1). The requirements of the electron source can be met by storage rings or linear accelerators based on a thermionic RF gun.

X-ray tube machines experience similar heating challenges as the PXR machine. The solution used in these machines is based on a rotating anode. This method increases the effective heat dissipation area since the electron beam interacts with different positions of the target material. The PXR heat dissipation solution can use a similar approach (FIG. 5D). The main difference between the machines is that the target material for the PXR source is modified by translation and not by rotation since a rotational change of the PXR crystal alters the X-ray emission direction. An additional crucial difference between the X-ray tube and the PXR source is that precision alignment is unnecessary with the X-ray tube but is critical for the PXR machine. The alignment process can be similar to the double crystal monochromator scheme used in synchrotron facilities, where large perfect crystals are available. These wafers can be translated much like a rotating anode so that the electron beam is concentrated near the outer edge of the wafer. This scheme can increase the PXR flux by an additional two orders of magnitude and relax the electron source requirements. Also, possible artifacts (such as blurring) of a moving crystal target can be taken into consideration to optimize the PXR flux.

Finally, the heat conduction outside the PXR crystal is to be considered. In the temperature dynamics derivation, it was assumed that the surface of the PXR crystal is held at the environment temperature. When the thermal wave arrives at the surface of the PXR crystal, it either radiates by black-body radiation or is thermally conducted to an assembled material. The second option has better heat dissipation from the PXR crystal.

Thus, a high-conductance material is stuck to the PXR crystal edges to act as a heat sink (FIG. 4D). For example, a rotating X-ray tube anode uses molybdenum for this purpose. The heat sink is assembled close to the electron beam impact position since the temperature profile extends by Dir between the electron source pulses, where D is the diffusion coefficient. Therefore, the distance between the electron beam and the heat sink is crucial for increasing the repetition rate of the source. This limits the maximal electron source brightness that can traverse through the PXR crystal. Using a lower electron beam diameter implies that the heat sink is located at a distance approximately equal to the diameter of the electron beam, which is experimentally challenging for a small electron spot diameter.

Thus, the inventors have shown that the energy loss of a focused electron beam, which is deposited in a small volume, limits the PXR flux. In particular, the lattice vibrations cause phase mismatch between the atoms, which decreases the constructive interference between the dipoles. The inventors examined the thermal conduction and the black-body radiation heat dissipation processes and found the regimes where each heat dissipation process is dominant. For example, PXR experiments that use high melting temperature materials with short attenuation lengths, such as tungsten, can be designed to increase the possible electron flux. Further, the inventors have optimized the electron charge pulse and the repetition rate as a function of the Debye-Waller factor and found the maximal current values to be 500 uA-3 mA, which are two orders of magnitude higher than those used in previous experiments. Further increase of the average electron source current can be obtained by using a moving PXR crystalline, which increases the volume in which the heat is deposited.

In the following, novel techniques of the present disclosure are described enabling to overcome the self-absorption by enhanced PXR schemes.

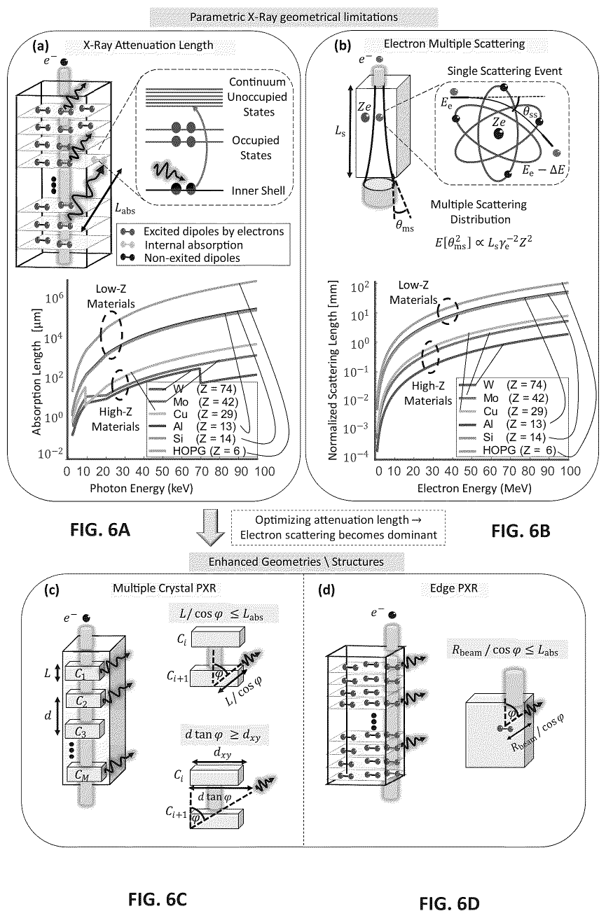

The PXR yield is governed by several factors, including the crystal scattering factor χ_{g} (or equivalently the diffraction efficiency), the emitted PXR photon characteristics (i.e., the emission angle θ_{B} and energy ω_{B}), and the geometrical factor f_{geo} (Eq. (2)). FIG. 6A shows schematically the X-ray attenuation length within the crystal. For a thick PXR crystal, the emitted PXR photons are self-absorbed within the crystal, thus limiting the contribution of all crystal layers to the PXR intensity. This phenomenon is captured by the geometrical factor and sets an upper bound on the PXR yield. This limitation is especially significant for high-Z materials with shorter absorption lengths. Two different PXR schemes are considered to handle this limitation by reducing the effective escape path of the emitted PXR photons, achieving a significant increase in the PXR yield.

A general X-ray beam attenuates during an interaction with a thick target material. The attenuation is caused due to several physical mechanisms, but mainly due to photoelectric absorption, Compton scattering, and elastic scattering. The same phenomenon occurs for the emitted PXR photons within the crystalline. For the materials examined in the present disclosure and for PXR energies below 70 keV, the photoelectric absorption is the most significant attenuation factor. The geometrical term f_{geo} in Eq. (2) captures this effect. First, the amount of PXR photons produced per unit length as the electron traverses the crystal is constant. Therefore, the PXR crystal will produce more photons as the crystal thickens. However, the X-ray photons attenuate as they leave the crystal. PXR photons that must traverse through the entire crystal will contribute significantly less than PXR photons produced at the surface of the crystal. Hence, the material absorption length limits the PXR yield.

FIG. 6A shows the absorption length for different materials and different X-ray energies. Generally, the absorption length is shorter for heavier materials or lower X-ray energies. This limits the standard PXR scheme—on the one hand, higher Z materials have higher diffraction efficiency; on the other hand, they have shorter attenuation lengths relative to lower Z materials. In other words, the geometrical factor f_{geo} and the Fourier expansion of the electric susceptibility χ_{g} compete. The geometrical factor is proportional to f_{geo}∝L_{abs}∝ω³/Z⁴, whereas the scattering factor is proportional to χ_{g}²∝Z²/ω⁴, which leads to the PXR yield dependence of N_{PXR}∝f_{geo}χ_{g}²1/Z². Therefore, in the regular PXR geometry, to produce more PXR photons, lighter material is preferable.

However, even if the self-absorption limitation is overcome, the PXR intensity cannot increase linearly with the material thickness without further restrictions. In this case, the main limiting factor becomes the electron beam scattering shown schematically in FIG. 6B. When an electron traverses through the PXR crystal, it slightly deviates from its initial trajectory due to the electrostatic forces applied by the material atoms. This scattering process has a random walk profile, for which the likelihood and the degree of an electron scattering is a probability function of the crystal thickness and the mean free path. In particular, the scattering angle is modeled with Gaussian probability with zero mean scattering and standard deviation given by:

$${σ}_{{θ}_{ms}} = \frac{13.6 MeV}{{E}_{e}} \sqrt{\frac{L}{{X}_{0}}} ( 1 + 0.038 ln ( \frac{L}{{X}_{0}} ) ) , \qquad ( 12 )$$

where Eₑ is the electron energy, L is the material thickness and X₀ is the radiation length (radiation length here is assumed to be the mean length into the material at which the energy of the electron is reduced by factor 1/e due to scattering).

The scattering length standard deviation for different materials and electron energies is also shown in FIG. 6B. The electrons' multiple scattering causes a broadening of the PXR angular shape, which, in turn, decreases the PXR brightness. To evaluate the impact of the broadening, the inventors use the Potylitsyn method. The Gaussian distribution of the electron scattering is convolved with the angular shape of PXR (Eq. (3)). The optimal material thickness is derived to be Lₒₚₜ≈0.1X₀, under the assumption that no self-absorption exists (electron beam scattering is described further below in section 2.5). Above this crystal thickness, the PXR flux gain becomes negligible and degenerates the source brightness. This typical thickness is much longer than the absorption length, especially for lower PXR energies. Therefore, PXR schemes that overcome the self-absorption limitation gain considerably in those spectrum ranges.

To cope with the PXR self-absorption limitation, the inventors propose two schemes: the first scheme is a stacked multiple crystals structure shown in FIG. 6C, and the second is an edge PXR structure shown in FIG. 6D. To overcome the PXR self-absorption in the first scheme, two conditions are fulfilled: the thickness of each crystal is thinner than the absorption length; and distance between the crystals is large enough such that the escape path of the emitted photon does not go through the adjacent crystal. These conditions are summarized as follows:

$$L / cos φ \leq {L}_{abs} \qquad ( 13 )$$

$$d / tan φ \leq {d}_{xy} ,$$

where L is the crystal thickness, φ=Ω is the emission angle of the photon relatively to the incident electron, d is the distance between the crystals and d_{xy} is the transverse plane (i.e., perpendicular to d) length of the crystal. To exemplify this structure, the inventors consider a tungsten crystal with PXR energy of ˜15 keV from the Bragg plane (110) and an electron spot size of ˜10 μm. This X-ray energy corresponds to an absorption length of ˜4 μm. The PXR photon emission angle is Ω=2θ_{B}=21.2° relative to the electron beam. Therefore, a material thickness of ˜4.3 μm is preferably used, and the distance between the crystalline layers is ˜26 μm. On the other hand, the radiation length of tungsten is X₀=3.5 mm. Thus, under the optimal PXR crystal thickness Lₒₚₜ≈0.1X₀, almost two orders of magnitude in yield can be gained.

The “edge PXR” structure, which is also called “grazing PXR” or extremely asymmetric diffraction (EAD) PXR, is based upon transmission of the electron beam within the crystal, parallel to the crystal edge surface. In this structure, the electron spot size is to be shorter than the absorption length for the emitted PXR photon escape at a shorter distance than the absorption length. The condition that this structure preferably satisfies is:

$$2 {R}_{beam} / cos φ \leq {L}_{abs} \qquad ( 14 )$$

where R_{beam} is the beam spot radius. This structure has been examined experimentally, where a PXR yield gain by a factor of 5 was reported [9]. Except for the yield gain, this geometry produces a different PXR spatial shape. An electron that penetrates the target material excites the material dipoles symmetrically, causing the dipole fields to cancel each other at the resonant point defined by the Bragg condition [3]. Therefore, the regular PXR geometry produces either a double lobe or a donut shape (FIG. 3A) with a hole in the center. On the other hand, the edge PXR scheme breaks this symmetry since the angle between the incident electron and the dipoles is distributed only in half of the plane. Thus, the edge PXR geometry produces a beam with a peak intensity exactly in the resonant point [3].

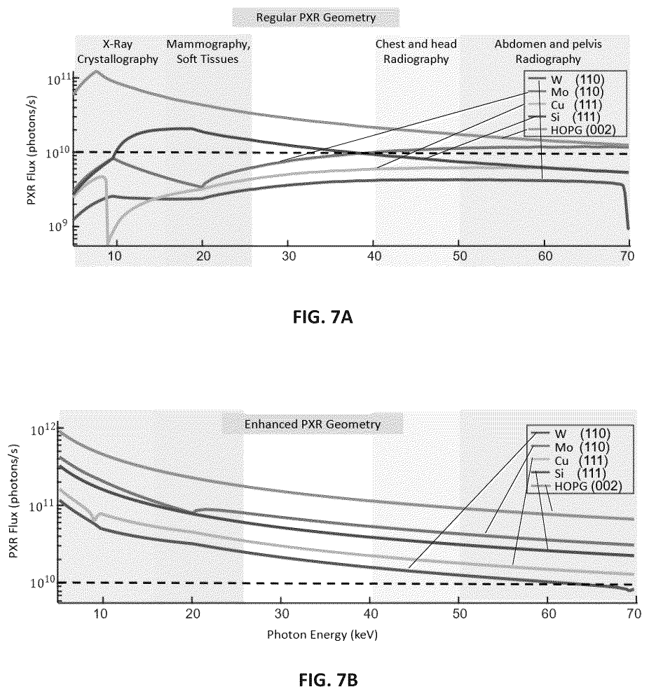

FIGS. 7A and 7B show the PXR photon rate comparison between a standard PXR scheme and enhanced PXR schemes for different PXR materials. The electron source currents used for the derivation are based on Table 2. The X-ray spectrum is divided into the target applications, i.e., X-ray crystallography (<15 keV), mammography (10-25 keV), chest and head radiography (40-50 keV), and abdomen and pelvis radiography (50-70 keV). The dashed line represents the photon rate necessary for in-vivo imaging.

The target's angular aperture used for flux derivation is the PXR beam divergence (θₚₕ˜γₑ⁻¹). The enhanced PXR schemes gain up to two orders of magnitude of flux relative to a regular PXR structure. The gain is considerable for lower X-ray energies due to the higher self-attenuation in this region. For higher X-ray energies, the flux decreases due to lower diffraction efficiency. Due to the optimization, the PXR flux levels are adequate for practical applications. In particular, Graphite has sufficient flux levels even without the PXR geometry scheme optimization, but only with the electron source current optimization.

Using the proposed PXR schemes of the present disclosure meets several challenges. In the multiple PXR crystals scheme, the final image might have a blurring artifact due to the many beams' emissions from each sub-crystal. Image processing techniques can reduce this artifact. Moreover, the multiple crystals' alignment relative to the electron beam is to be the same, which may be experimentally challenging. In the edge PXR scheme, precise alignment between the electron beam and the PXR crystal edge can be used. For materials with a short absorption length, the electron beam spot size is to be smaller than the absorption length, which reduces the number of available electron sources that meet this requirement. Despite the PXR source flux growth, the PXR source signal-to-noise ratio remains the same between the standard and the enhanced schemes since both PXR and bremsstrahlung increase linearly with the material thickness. Despite all these challenges, the enhanced geometrical structures can gain up to two orders of magnitude in flux, which makes them prospective for commercial applications.

In the following, the technique of the present disclosure for optimization of the signal to noise ratio (SNR) is described in detail.

In addition to the source flux, the PXR source signal-to-noise ratio (SNR) is optimized, as it is important for the X-ray image quality. PXR is a quasi-monochromatic source, yet it competes with broadband radiation sources, i.e., bremsstrahlung and transition radiation. If the background radiation emitted from these sources is intense, it can produce a noisy image, even if the PXR flux is high. The inventors optimize the PXR experimental parameters and use a filtration mechanism for eliminating the noise floor to maximize the PXR source SNR.

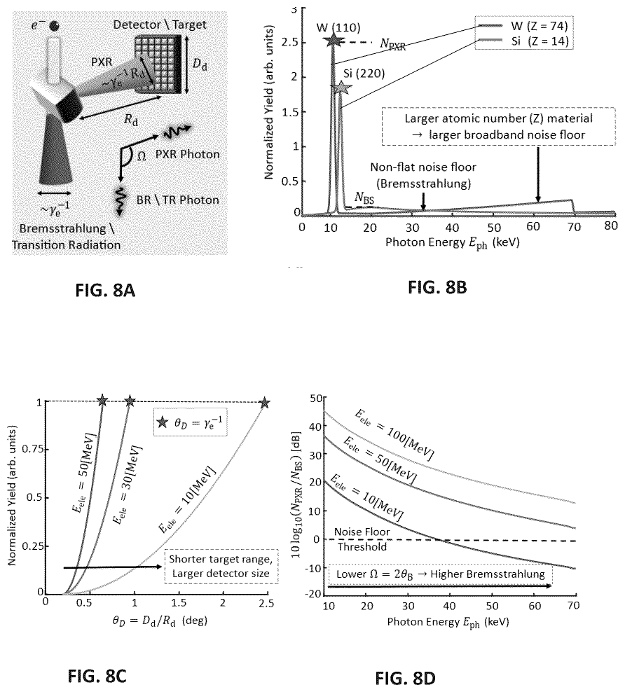

First, the inventors examine the bremsstrahlung and transition radiation impact on the PXR source. Bremsstrahlung is produced by a decelerating charged particle deflected from the target material nuclei by the Coulomb potential, whereas transition radiation is emitted when a charged particle passes through an interface between two different media. These two mechanisms emit in the forward direction within a narrow cone of γₑ⁻¹, parallel to the electron trajectory, as opposed to the PXR large emission angle Ω>>γₑ⁻¹ as shown in FIG. 8A. The target location is within the spatially narrow cone of the PXR emission. As the PXR emission angle Ω increases, the bremsstrahlung and transition radiation intensities become weaker in the target plane. Therefore, the ratio between the PXR intensity to the bremsstrahlung and transition radiation intensities increases. In other words, larger PXR emission angles Ω imply higher PXR source SNR. Under the examined regime, where ω>>ωₚ and Eₑ≤100 MeV, the bremsstrahlung radiation is much more intense than the transition radiation; thus, transition radiation is neglected from the analysis. The bremsstrahlung yield for a single electron is given by:

$$\frac{{dN}_{BS} ( ω )}{d θ} = \frac{8}{π} α {r}_{e}^{2} Z ( Z + 1 ) {n}_{a} ln ( 183 {Z}^{- \frac{1}{3}} ) \{ \frac{Δω L ( ω )}{ω} {γ}_{e}^{2} \frac{( 1 + {γ}_{e}^{4} {θ}^{4} )}{{( 1 + {γ}_{e}^{2} {θ}^{2} )}^{4}} \} , \qquad ( 15 )$$

where α is the fine-structure constant, rₑ is the electron radius, Z is the atomic number, nₐ is the material's atoms density, θ it the angle relatively to the electron trajectory, Δω is the bin width in the detector, L is the effective target thickness defined as the minimum between the physical thickness and absorption length L_{abs}. Due to the broadband spectrum of the bremsstrahlung radiation, it is modeled as the PXR source noise floor. FIG. 8B describes the typical PXR source spectrum for high-Z materials (i.e., tungsten) and low-Z materials (i.e., silicon). The characteristic radiation and higher Miller indices (hkl) energies were omitted from the spectrum for clarity. The PXR peaks are observed in the X-ray energies given by Eq. (1), with a linewidth dependence on the Lorentz factor γₑ and the emission angle (PXR energy linewidth is described further below in section 2.6). In addition to the PXR peak, a broadband non-flat noise floor produced from bremsstrahlung is observed. The noise floor shape and intensity depend on the material's atomic number. From Eq. (15), the noise floor spectrum depends on ∝Z²L(ω)/ω. For high-Z materials, the noise floor in the upper X-ray spectrum is more intense due to the Z² dependence. However, in the lower X-ray spectrum, the noise floor is suppressed due to the bremsstrahlung self-absorption in the crystalline (L(ω) is shorter for heavier materials). Indeed, for Si, the noise floor is higher at the lower X-ray energies, whereas for W, the noise floor is higher at the higher X-ray energies. Therefore, in order to reduce the noise floor, a crystalline thickness can be in the order of the material absorption length of the desired PXR energy.

Next, the inventors consider the field-of-view (FOV) of the PXR source, aimed at determining the optimal detector size (D_{d}) and PXR source to target range (R_{d}), as a function of the incident electron energy. Under the assumption γₑ⁻²>>(ωₚ/ω)², where ωₚ is the plasma frequency, the PXR divergence angle is θₚₕ≈γₑ⁻¹. The inventors define the dimensionless parameter θ_{d} [symbol] D_{d}/R_{d}, which represents the target angular aperture.

FIG. 8C shows the normalized PXR yield as a function of the target angular aperture. The optimal target angular aperture is equal to the PXR beam divergence (θ_{d}˜γₑ⁻¹). In the case the angular aperture is much smaller than the PXR beam divergence (θ_{d}<<γₑ⁻¹), most of the PXR photons scatter outside the detector, yielding a low flux on the target. On the other hand, when the angular aperture is larger than the PXR beam divergence (θ_{d}>>γₑ⁻¹), most of the PXR photons hit the detector in a small portion of its area, causing a large amount of bremsstrahlung noise to be collected. This result implies that a PXR beam with a relatively high divergence (˜10 mrad for Eₑ=50 MeV) has an advantage in imaging since a large field of view is available at a small source-to-target distance, especially when compared with synchrotron X-rays. For example, for a PXR source with an electron beam energy Eₑ=50 MeV and a target size 5 cm², the necessary distance between the PXR crystal to the target is ˜2 [m].

The PXR signal to noise ratio is defined as follows:

$$S N R ( ω , θ ) {=}^{Δ} 10 {log}_{10} ( \frac{{N}_{PXR} ( ω , θ )}{{N}_{BS} ( ω , θ )} ) , \qquad ( 16 )$$

where N_{PXR}(ω,θ) and N_{BS}(ω,θ)) are the number of PXR and bremsstrahlung photons, respectively, emitted in a solid angle [θ−θₚₕ,θ+θₚₕ] with X-ray energy [ω−ω_{D},ω+Δω_{D}], where Δω_{D} is the detector's energy bin width. The SNR definition used here is the ratio between the number of PXR photons to bremsstrahlung photons within the same energy bin, and not relative to the entire bremsstrahlung noise spectrum, as described below.

FIG. 8D shows the PXR source SNR as a function of the X-ray emission energy for different electron beam energies. For a given material and a Bragg plane, as the PXR emission energy increases, the PXR source SNR decreases due to the lower emission angle (Eq. (1)). In other words, the PXR emission becomes closer to the bremsstrahlung forward direction emission, and more bremsstrahlung photons will hit the detector. Increasing electron energies can overcome this challenge. In this case, the detector's angular aperture becomes smaller (θ_{d}˜γₑ⁻¹), and the bremsstrahlung radiation is confined into a smaller cone, i.e., a smaller amount of bremsstrahlung radiation is collected in the detector. This result implies that lower electron beam energies are appropriate when the desired application requires photons energy of ˜15-25 keV. However, for higher X-ray energy, the electron energy is to be increased to preserve high values of SNR.

Another approach to increase the SNR is to use higher orders of the Miller indices (or equivalently lower dₕₖₗ). In this case, for a given PXR energy, the emission angle is higher; thus, the bremsstrahlung radiation will be less intense. However, this approach produces lower PXR flux since the PXR yield decreases for higher Miller indices.

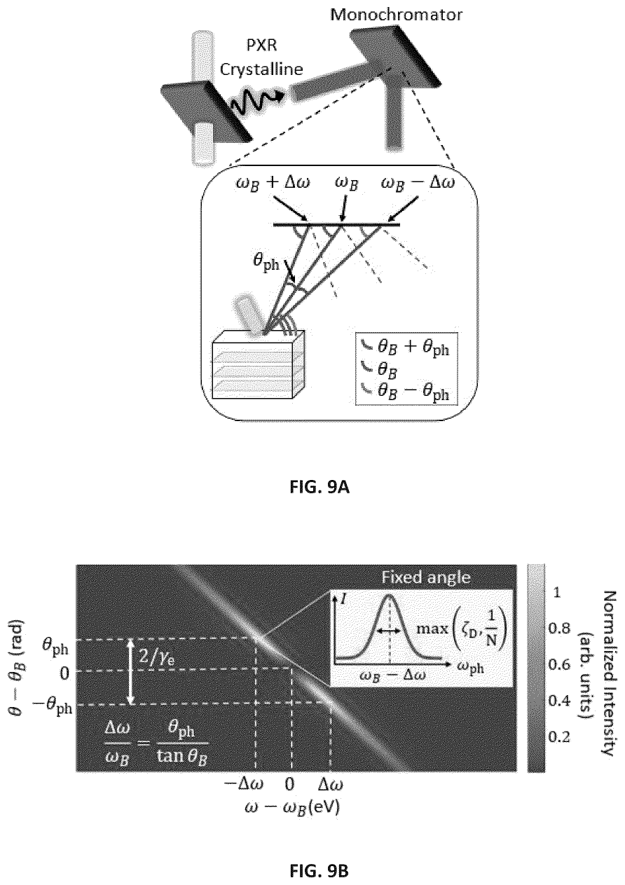

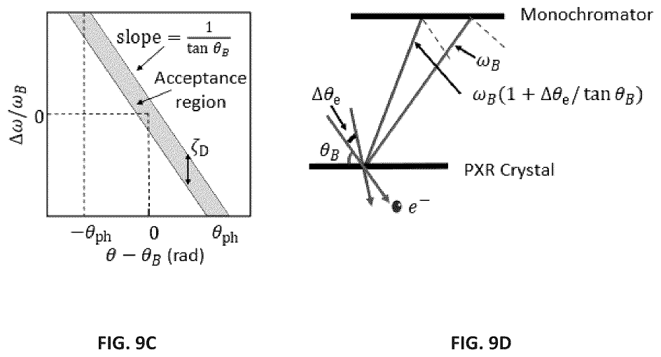

Despite the noise floor reduction thanks to the optimization of the experimental parameters, the noise is still prominent, especially for the higher X-ray energies. Therefore, additional noise floor suppression and filtration are needed. A bandpass filter should be employed on the PXR beam with a passband energy range of [ω_{B}−δω, ω_{B}+δω], where ω_{B} and δω are the emitted PXR energy and linewidth, respectively. FIG. 9A describes the scheme for implementing the bandpass filter by an additional crystal monochromator. The arrangement between the PXR crystal to the monochromator is equivalent to the non-dispersive arrangement of two monochromators as used in synchrotron facilities. However, in the PXR scheme, the PXR crystal source, which produces the PXR beam, replaces the first monochromator. This method has been used in previous PXR experiments, yet for a different reason: it preserves the exit location of the PXR beam under the PXR crystal rotations. During the PXR energy tuning process, the PXR crystal is rotated to adjust to the desired PXR energy.

According to the technique of the present disclosure, in order to allow the PXR beam to exit in the same direction as the incident electron beam, the crystal monochromator is tuned to the same Bragg angle and Bragg plane as the PXR crystal. This approach has a significant advantage in the realization of a PXR system since the exit location of the PXR beam remains unchanged under the PXR energy tuning, without the necessity to rotate the whole PXR system or the target sample.

Here the monochromator is examined as a bandpass device for filtration of the PXR source noise. Generally, the rocking curve of a monochromator is very narrow, as described by the DuMond diagram shown in FIG. 9C. The DuMond diagram describes the transfer function and acceptance region of the monochromator as a function of the incident X-ray energy (ω_{B}) and the angle relative to the Bragg plane (θ_{B}). An incoming X-ray beam that satisfies the Bragg condition will be reflected from the monochromator at the same angle as the incident beam angle θ_{B}. However, an incident beam that is slightly off the Bragg condition will be attenuated by the monochromator. The relation between the energy linewidth and the angular width of the monochromator's transfer function when the Bragg condition holds is Δω/ω_{B}=θₚₕ/tan θ_{B}, where Δω and Δθ are the energy and angle deviation relative to the Bragg energy and Bragg angle, respectively. The angular width of the rocking curve is given by w_{D}=ζ_{D} tan θ_{B} (FIG. 9C), where ζ_{D} is the Darwin width:

$${ζ}_{D} = \frac{δ ω}{ω} = \frac{4}{π} {d}_{hkl}^{2} {r}_{e} \vert {S}_{hkl} \vert / {v}_{c} , \qquad ( 17 )$$

where rₑ is the electron radius, Sₕₖₗ is the structure factor of the unit cell and v, is its volume. In the X-ray dynamical theory, the Darwin width defines the accepted energy width of a monochromator for a fixed X-ray incident angle. Typical values of Darwin width are ˜10⁻⁴ and angular FWHM of ˜tens μrad. These values are considerably smaller than the PXR energy linewidth and the angular width. Due to its narrow linewidth, the diffracted intensity of a polychromatic X-ray beam from a monochromator can drop up to four orders of magnitude, which limits the flux considerably. However, the PXR spatial dispersion comes to the rescue at this point. The PXR spatial dispersion for a single electron source is described in FIGS. 9A and 9B. The PXR beam impacts the monochromator at a center angle θ_{B} and a beam divergence of θₚₕ=1/γₑ. Due to the spatial dispersion, the center frequency of the PXR beam is ω_{B} and the frequencies which correspond to the incident angles θ_{B}+θₚₕ, θ_{B}−θₚₕ are ω_{B}+Δω, ω_{B}−Δω, respectively. In addition, the PXR energy linewidth for a fixed emission angle is given by

$$\frac{δω}{ω} = max ( {ζ}_{D} , \frac{1}{N} ) ,$$

where N is the number of layers the electron passes through and ζ_{D} is the Darwin width (PXR spatial dispersion is described further below in section 2.2). The case ζ_{D}>1/N corresponds to the X-ray dynamical theory and ζ_{D}<1/N corresponds to the X-ray kinematical theory. If the same parameters are used for the PXR and the monochromator crystals, i.e., the same material, Brag geometry, Bragg plane and Bragg angle, the monochromator's transfer function and the PXR spatial dispersion would consolidate. Therefore, the PXR beam signal will pass the monochromator without significant attenuation, whereas the noise floor will attenuate. This unique property of the PXR spatial dispersion is advantageous for designing an X-ray source since the PXR source noise can be filtered without attenuating the main PXR beam.

An additional advantage of the non-dispersive arrangement of the PXR crystal and the monochromator is that the symmetric Bragg arrangement preserves the angular divergence shown schematically in FIG. 9D. In particular, the incident electron beam divergence and the X-ray beam emitted from the monochromator will be parallel. Due to the beam divergence, the incident electron deviates from the central ray by an angle Δθₑ. The PXR beam produced from this electron will be reflected by an angle θ_{B}+Δθₑ relative to the Bragg plane with an X-ray energy of

$${ω}_{B} ( 1 + \frac{{Δθ}_{e}}{tan {θ}_{B}} ) .$$

If the second crystal has the same geometrical arrangement as the PXR crystal, the PXR beam will be reflected from the second crystal in parallel to the incident electron trajectory. Therefore, the double crystal arrangement preserves the angular divergence.

In the following, the inventors propose a compact realization for the PXR machine and discuss several applications use cases. For proper operation of the PXR system, several experimental parameters should be considered: the electron source quality, the PXR crystal material and geometry, radiation safety aspects, the machine calibration process, the diagnostic system, and the machine dimensions.

Turning back to FIG. 1, the exemplary PXR machine/system is shown. The electron source, based on a thermionic RF gun and an electron acceleration structure, produces the relativistic electron beam. Two Q-magnets focus the electron beam, one at the PXR crystal and the second before the electron beam dump. A double crystal scheme, based on a combination between a PXR crystal and a monochromator, produces a filtered PXR beam with a fixed exit location. The optical transition radiation (OTR) subsystem monitors the electron beam crossing with the PXR crystal. A deceleration structure and a beam dump component are used for the electron beam disposal. The PXR beam exits the machine through a collimator and an exit window. A power supply, RF modulator, a Klystron, and a control system feed the PXR machine. The estimated dimension of the proposed PXR machine is ˜3×3 m², similarly to other tunable and compact X-ray machines, such as the inverse Compton scattering X-ray source [10].

According to the present disclosure, the PXR crystal geometry can be based either on a regular or an advanced structure (FIGS. 6A to 6D). The PXR crystal has an assembled heat sink to dissipate the heat from its edges (FIG. 4D).

Several parameters affect the PXR beam quality, mainly the electron beam source quality, the PXR crystal material, and the experimental geometry. The electron source quality is determined by the electron source energy and spread, the beam spot size, and the beam divergence. Since the PXR energy does not depend on the incident electron energy but only on the Bragg plane and Bragg angle (Eq. (1)), the electron source energy spread has a negligible impact on the PXR energy linewidth, i.e., it can be up to several percent. On the other hand, the electron beam divergence and spot size significantly affect the PXR energy linewidth.

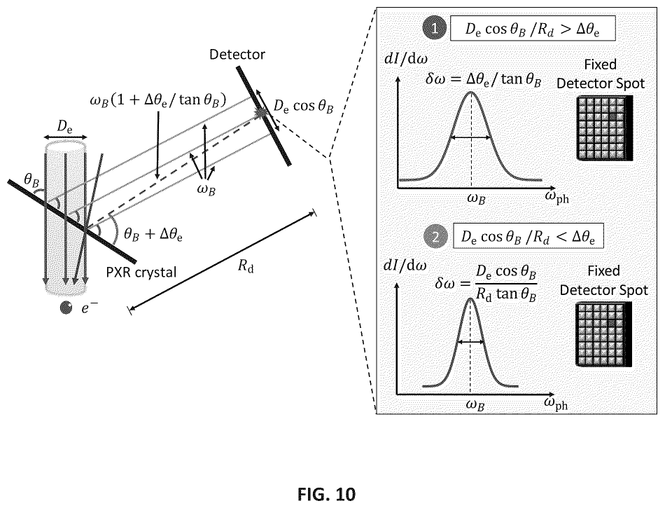

FIG. 10 describes this influence. A collimated electron beam impacts the PXR crystal with an angle θ_{B} relative to its surface (for simplicity, it is assumed here that the crystal surface and the Bragg plane coincide. The PXR material's dipoles that radiate into a fixed point in the detector's plane arrive from a confined region in the PXR crystal, defined by the electron beam area and the electron beam divergence. When the electron beam divergence (Δθₑ) is larger than the electron beam spot size (Dₑ) divided by the range to the detector (R_{d}), all the dipoles within the electron beam spot radiate into a fixed point in the detector's plane. In this case, the electron beam divergence broadens the PXR spatial shape to a larger angular aperture than the electron beam area divided by the distance to the detector. On the other hand, when the divergence is small compared with the electron beam spot, only a portion of the dipoles within the beam spot contributes. Therefore, from geometrical considerations, the PXR energy linewidth is derived in a fixed detector spot to be (see also section 2.6 presented below):

$$\frac{δω}{{ω}_{B}} = \frac{min \{ {Δθ}_{e} , \frac{{D}_{e} cos {θ}_{e}}{{R}_{d}} \}}{tan {θ}_{B}} , \qquad ( 18 )$$

This result suggests that a smaller electron beam spot size is advantageous for the PXR energy linewidth. However, lowering the electron beam spot size has a limit. By the preservation law of Liouville, reducing the electron beam spot size would increase the beam divergence. Larger beam divergence would cause spatial broadening of the PXR beam, which decreases the PXR brightness. Therefore, to avoid PXR beam broadening effects, the electron beam divergence is to be smaller than the typical PXR spatial angular divergence, defined by the inverse of the Lorentz factor, i.e., Δθₑ<γₑ⁻¹. In addition, Eq. (18) suggests that the electron beam spot size does not exceed

$${D}_{e} < \frac{{R}_{d} {Δθ}_{e}}{cos {θ}_{B}} < \frac{{R}_{d} {γ}_{e}^{- 1}}{cos {θ}_{B}} .$$

For example, if a target is located ˜2 m from the PXR crystal and the electron beam divergence is θₑ=1 mrad, then the electron beam spot size is Dₑ<2 mm. These requirements on the electron source quality are achievable by a thermionic RF gun. In contrast, the Synchrotron facility and the inverse Compton scattering (ICS) machine require high brightness electron sources, which are achievable only by photo-injection schemes. Although photo-injection electron sources have high brightness, they are not appropriate for the PXR machine, due to the PXR crystal thermal load from the dense electron beam. This plays an advantage for the PXR machine since it simplifies its operational parameters.

The material thickness and the crystal mosaicity are additional parameters affecting the PXR energy linewidth. Mosaicism is the degree of perfection of the lattice translation throughout the crystal. Macroscopic crystals are often imperfect and composed of small perfect blocks with a distribution of orientations around some average value. The crystal is then said to be mosaic, as it is composed of a mosaic of small blocks. Since each mosaic block emits a PXR beam with a slightly different orientation and angle, the total PXR beam is spatially broadened, which also causes a PXR energy linewidth broadening. Typically, the mosaic blocks may have orientations distributed over an angular range between 0.01° and 0.1°. Graphite (HOPG), which has a high PXR yield, suffers from high mosaicity with an angular range of 0.4°. This high mosaicity value limits the achievable monochromatism of the PXR beam from HOPG material. In contrast, the other materials examined in present disclosure (Tungsten, Molybdenum, Copper, and Silicon) have much lower mosaicity values; thus, these materials are preferred. The impact of the crystal mosaicity, crystal thickness, and the electron beam spot size are analyzed below.

An important practical aspect of the PXR machine is the calibration process and the diagnostic system. The PXR machine calibration process is sensitive mainly due to two alignment processes: the first between the incident electron beam and the PXR crystal and the second between the PXR beam to the monochromator. The first alignment is governed by the diffraction condition of the PXR mechanism, and the second one is due to the monochromator transfer function, which is extremely sensitive to rotations, as described in FIG. 9C. Due to the sensitive alignment requirements, the PXR machine is to support an automated calibration process.

The proposed calibration process is based on two serial steps: the first is the calibration of the PXR crystal with the electron beam, and the second is the calibration of the monochromator. During the first calibration, the machine can monitor the electron beam position and cross with the PXR crystal. Several mechanisms can accomplish this: optical transition radiation (OTR) screen, YAG, wire scanner screen, and Cherenkov radiation.

Here the inventors propose to use OTR, as it plays a central role in beam diagnostics in linear accelerators. Its linear intensity growth as a function of the beam current is a great advantage compared with fluorescent screens that are subject to saturation. In addition, previous PXR experiments have used OTR for this purpose. Transition radiation emits in a wide photon frequency range, including visible light, i.e., enabling the display of the electron beam's position on the target crystal using a visible light detector. The light is most easily observed in the backward geometry to avoid detection along the electron path and the forward bremsstrahlung radiation. During this calibration stage, the PXR crystal and the mirror are placed at 45° and 90° degrees, respectively, relative to the electron beam. A shielded CCD camera captures the reflected OTR signal from the mirror. The control system analyzes the incoming OTR signal and adjusts the electron beam using the Q-magnet and the PXR crystal displacement until the beam position is located correctly on the target. In the second calibration process, the monochromator is aligned by a goniometer relative to the PXR crystal. This calibration process is used extensively in Synchrotron facilities where double crystal monochromator schemes filter and adjust the X-ray beam.

When considering high electron energies facilities, radiation safety is a central challenge to cope with due to the production of neutrons during the electron beam dump. The typical electron source energy required for a PXR source exceeds the neutron production threshold; thus, the PXR machine is configured with a large and thick radiation shield to protect the machine's operators and users. Neutron production occurs when an electron or bremsstrahlung beam above a threshold energy (Eth) traverses through a material.

To produce a neutron, the absorbed photon's energy must be greater than the binding energy of the neutron to the nucleus. The binding energies vary from 10 to 19 MeV for light nuclei (Z<40) and from 4 to 6 MeV for heavy nuclei (Z>40). In the PXR scheme, the primary process for neutron production by the incoming electron beam is the absorption of the bremsstrahlung photons produced by the electrons. The direct production of neutrons by electrons is two orders of magnitude smaller than neutron production by the Bremsstrahlung photons. Since high-Z materials, such as tungsten, have lower thresholds, neutron production is greater and occurs with lower photon energies than materials with lower atomic numbers, such as copper and steel. The neutron production cross-section for a given nucleus depends on the energy of the photon absorbed. This probability starts at zero and then follows a broad resonance-shaped curve. For given electron energy, the neutron yield will depend on the shape of the neutron cross-section and the shape of the bremsstrahlung spectrum generated by the electrons. Thus, mathematically, the yield of photoneutrons is proportional to the convolution of (γ,n) cross-section and the bremsstrahlung spectrum. Since the bremsstrahlung spectrum decreases with photon energy, the yield of photoneutrons increases rapidly with electron beam energies up to ˜25 MeV and more slowly until ˜35 MeV. Above 35 MeV, the neutron yield is almost constant with the beam energy. Several options can be employed to reduce the shielding requirements. The first option, which was proposed for ICS sources, is based on a deceleration structure before the electron beam dump. It was stated that by using this technique, the radiation shielding requirements could fit the ICS source into a sea container. This option is presented in FIG. 1 and has been proposed previously also for a PXR source machine. Another option is to use an electron beam energy below the neutron production threshold. Since the PXR emission energy does not depend on the incident electron energy, the PXR machine scheme remains mainly the same. In this case, the PXR beam divergence would increase, yet it can be favorable for imaging applications due to the larger field of view.

ICS and characteristic radiation produced from an X-ray tube are two physical mechanisms that serve as laboratory scale, quasi-monochromatic X-ray sources. In the following, the inventors compare PXR to these two X-ray source mechanisms, where the metrics used for comparison are the flux, brightness, and practical application suitability. The compared parameters are the energy tunability, the machine dimensions, the radiation safety requirements, the operational simplicity, the noise floor filtering techniques, and the requirements on the active components (i.e., the electron beam and laser sources) of each one of the machines. Table 3 presented below summarizes this comparison.

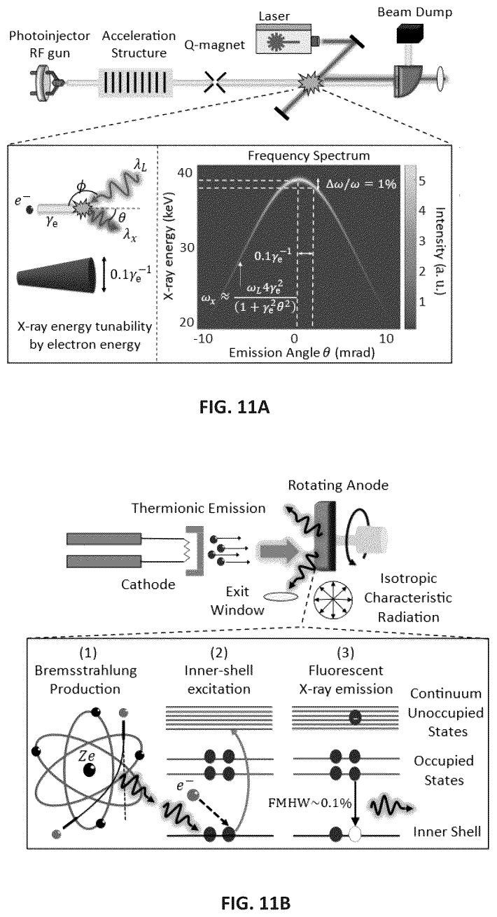

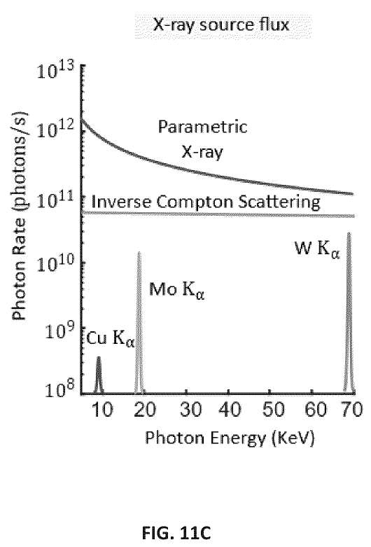

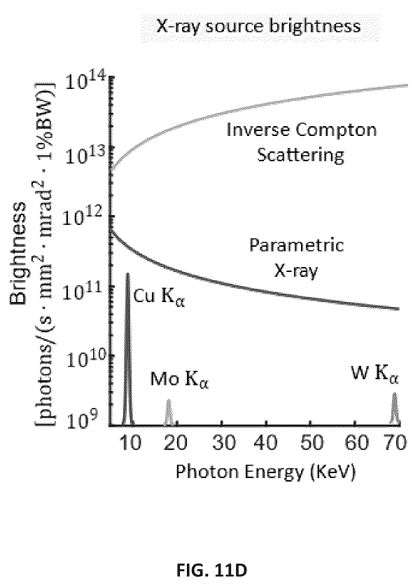

ICS is the up-conversion process of a low-energy laser photon to a high-energy X-ray photon by scattering from a relativistic electron. FIG. 11A shows the interaction scheme with a near head-on collision between the laser and electron beams. The scattered X-rays emerge in the same direction as the electrons. The physical mechanism of ICS is nearly identical to spontaneous synchrotron emission in a static magnetic undulator as used at traditional synchrotron facilities. However, due to the much shorter micro-meter laser wavelength, relatively to the centimeter-period undulator wavelength, the required electron energies to produce hard X-ray photons is orders lower than in the large synchrotrons. The up-conversion ratio for low laser intensity and on-axis emission from a head-on collision is given by:

$${λ}_{x} = {λ}_{L} ( 1 + {γ}_{e}^{2} {θ}^{2} ) / 4 {γ}_{e}^{2} , \qquad ( 19 )$$

where θ is the X-ray photon emission angle relative to the electron beam direction, λ_{L} is the laser wavelength and λₓ is the emitted X-ray wavelength. The total ICS flux over all angles and frequencies is determined by the cross-section between the electron beam and the laser photons and is given by:

$${N}_{x} = \frac{{N}_{e} {N}_{L} {σ}_{T}}{2 π ( {σ}_{L}^{2} + {σ}_{e}^{2} )} , \qquad ( 20 )$$

where σ_{T} is the Thomson cross section, Nₑ is the total number of electrons, N_{L} is the total number of photons in the laser beam, and σ_{L} and σₑ are the beam spot size at the interaction point of the laser and electron beam, respectively. The up-conversion ratio (Eq. (19)) implies that all photons emitted within a narrow cone of ˜0.1γₑ⁻¹ have an energy linewidth of 1%.

FIG. 11A shows the ICS parabolic spatial dispersion. Similar to the PXR emission, the ICS source flux is concentrated within a narrow emission cone. However, as opposed to the PXR spatial dispersion, the ICS spatial dispersion does not consolidate well with the crystal monochromator transfer function. Therefore, without appropriate treatment, the ICS beam would be significantly attenuated by the monochromator. To cope with this challenge, a KB (Kirkpatrick-Baez) mirror combined with a double crystal monochromator scheme was proposed to focus and filter the beam. In this case, the ICS source flux reduces by 60%.

An additional challenge in the ICS source scheme implementation is the requirements of the electron beam and the laser sources. For a scattering process such as ICS, the highest flux is produced by creating a dense target. High density is achieved by squeezing the electron and laser beams. Therefore, the laser pulse and the electron beam are to be focused on a small waist in a short time, i.e., the electron beam has a small emittance compared with the PXR source. Moreover, since the up-conversion ratio is directly proportional to the laser photon energy and the electron beam energy (Eq. (19)), the ICS source energy linewidth is determined mainly by the laser linewidth and the electron energy spread. Accordingly, the ICS source must have a low laser linewidth and a low electron beam energy spread for producing a low linewidth X-ray beam. An additional unique operational challenge of the ICS machine relates to the active laser system synchronization, i.e., the seed laser, the ICS laser, and the photo-cathode laser need to be synchronized.

Due to its simplicity, characteristic radiation produced from an X-ray tube is the most widespread emission mechanism when a monoenergetic X-ray beam in a laboratory-scale facility is necessary. This emission occurs when an electron is accelerated from a hot cathode and impacts a target anode (FIG. 11B). If the incident electron kinetic energy is greater than the characteristic X-ray energy, it knocks out the electron from the inner shell and produces a vacancy. The ionization process can occur either by a direct impact of the incident electron or by a bremsstrahlung photon, produced by the electron's deflection and deceleration due to the Columb interaction with the anode's material nuclei. Typically, the inner-shell ionization cross-section by a direct impact of the incident electron is two orders higher than the bremsstrahlung inner-shell ionization cross-section (characteristic radiation yield is described below in section 3). Following ionization, an electron from an outer shell fills the vacancy in the ionized inner shell. In this process, the energy between the two bound states is emitted either in a radiative way with a characteristic X-ray photon (i.e., a fluorescence process) or by a non-radiative process. In the non-radiative process, another bound electron is emitted from the atom, a process known as Auger electron emission. The fluorescence yield describes the probability of fluorescence emission as a function of the material's atomic number. The fluorescence yield increases for higher Z materials; thus, high-Z materials produce more intense characteristic lines due to higher photoionization cross-section and higher fluorescence yield. A detailed analysis of the characteristic X-ray radiation production is described in section 3 presented below.

Characteristic radiation is the simplest operational machine among the three machines since it requires a low electron energy beam (<100 keV) without the necessity for any complicated calibration processes. Moreover, its dimensions are the smallest (<0.5 m), and the required safety shielding is the least strict due to the low electron acceleration energies (<100 keV). However, one of the main disadvantages of the characteristic radiation source is the lack of energy tunability. The inner shell energies of the target material anode define the emitted X-ray energies. Therefore, the X-ray application defines the anode's material as a function of the desired X-ray energy. For example, copper (˜8 keV), molybdenum (˜20 keV), and tungsten (˜69 keV) are used for X-ray crystallography, mammography, and CT and dental imaging, respectively. This limitation restricts the use of characteristic radiation for many applications, such as K-edge absorption. An additional disadvantage of the characteristic radiation is its limited brightness. Although the characteristic linewidth is narrow ˜0.1% and has a high photon rate, the emission is isotropic, which limits its brightness significantly. In addition, the thermal power load on the anode limits the X-ray flux. In conventional solid anode technology, the surface temperature of the anode must be below the melting point to avoid damage.

Thus, the anode's material properties (i.e., the melting point and thermal conductivity) restrict the possible electron source current. In order to cope with the thermal load, an X-ray source based on a liquid-jet anode can be used. Since the target material is already molten in this type of anode, the requirement to maintain the target below the melting point is not essential. Moreover, a new fresh liquid is regenerated to the anode periodically; thus, the interaction between the electron beam and the anode may be destructive. The typical current densities achievable by the liquid-jet anode are two orders of magnitude higher than in a standard X-ray tube and an order of magnitude greater than a rotating-anode X-ray tube. This scheme enables much higher electron current densities and higher characteristic radiation flux.

TABLE 3

| | | Inverse Compton | |
|---|---|---|---|
| | Characteristic X-ray | Scattering | Parametric X-ray |
| Energy | Limited by K-shell | Changing the electron source | Crystal rotation, |
| tunability | energies | energy or the laser | changing the PXR material |
| | | wavelength | |
| Machine | ~0.5 m² | ~3 × 3 m² | ~3 × 3 m² |
| dimensions | | | |
| Neutron | No requirements | Neutron shielding, an | Neutron shielding, an electron |
| radiation safety | | electron beam deceleration | beam deceleration structure. |
| | | structure | Possibly to use electron |
| | | | energies below the neutron |
| | | | production threshold |
| Bremsstrahlung | Double crystal | Focusing system by KB | A crystal monochromator |
| filtering | monochromator | mirror, followed by double | |
| | | crystal monochromators | |
| Operational | Simple | Requires synchronized laser | Requires calibration between |
| simplicity | | system, high-brightness | the electron beam and the |
| | | electron source | PXR crystal rotation |

FIGS. 11C and 11D compare the flux and brightness between the PXR, ICS, and characteristic X-ray sources. Table 4 presented below summarizes the experimental parameters used for producing the graphs. 1) The PXR beam is produced either from a diamond or a HOPG crystal with an optimized geometrical structure. The electron beam spot radius is 1 mm, and the average electron beam current is 1 mA. The assumption is that the electron source current is optimized, as found above, without using a moving crystal technique. 2) Three characteristic lines are examined, from Tungsten, Molybdenum, and copper, where a rotating anode produces the first two lines, and a liquid-jet anode produces the last. For the case of a rotating anode target, an electron current density of 100 mA/mm² is assumed with a beam spot size of 1 mm² and an electron current of 100 mA. For the case of a liquid-jet anode, an electron beam size of 10 um is assumed and an average current of 1 mA. 3) The ICS source is built from a photo-injection electron source with a beam spot size of 2 μm and an average electron current of 1 uA. The laser source has a repetition rate of 100 KHz, a beam waist of 5 μm, and a pulse energy of 10 mJ [10].

For the flux derivation, the inventors assume the target angular aperture is θ_{D}˜γₑ⁻¹˜10 mrad. In addition, it is assumed that no filtering is employed on the bremsstrahlung background radiation. The last assumption implies that an additional factor of ˜60% of the ICS machine flux is wasted on the filtering scheme. The PXR source flux is the highest, particularly in the X-ray spectrum of up to 40 keV, i.e., it may serve as a prospective imaging technique for applications in this spectrum range, such as mammography. However, the PXR flux decreases for higher X-ray energies due to lower diffraction yield, in contrast to the ICS source flux, which is constant over all X-ray energies. The ICS flux limitation is due to the relatively low electron source current and the low Thomson cross-section between the electron beam to the laser. The characteristic lines produced from a rotating anode have a high flux due to the usage of high electron source currents. However, the X-ray flux emitted from the liquid-jet anode is much lower since the electron source average current is significantly lower. When comparing the X-ray sources' brightness, both ICS and liquid-jet X-ray tube machines gain a significant advantage. Both sources use a high-brightness electron source, in contrast to PXR, for which thermal effects on the target crystal limit its flux. The ICS brightness increases with the X-ray energy since the ICS beam divergence is proportional to the inverse of the Lorentz factor gamma, i.e., for higher electron energies, the ICS beam divergence decreases accordingly. The typical electron current densities for the PXR machine are more than an order of magnitude lower than the current densities used in the rotating anode X-ray tube (Table 2 above).

A moving PXR crystal scheme can overcome this limitation as was shown above. This scheme would increase the PXR flux and brightness in an order of magnitude. In addition, for imaging applications, a large field-of-view is advantageous; thus, the flux is a more significant metric relative to the brightness.

TABLE 4

| | | Characteristic | | Characteristic | | Characteristic | | Inverse | | | |
|---|---|---|---|---|---|---|---|---|---|---|---|
| | | Line | | Line | | Line | | Compton | | Parametric | |
| | Parameter | W Kₐ | | Mo Kₐ | | Cu Kₐ | | Scattering | | X-ray | |
| Material | Target | Tungsten | | Molybdenum | | Copper | | — | | HOPG\ | |
| | Material | Rotating anode | | Rotating anode | | Liquid-jet | | | | Diamond | |
| Electron | Electron | 100 | keV | 100 | keV | 100 | keV | 8-50 | MeV | 50 | MeV |
| source | energy | | | | | | | | | | |
| | Average | 100 | mA | 100 | mA | 1 | mA | 1 | uA | 1 | mA |
| | electron | | | | | | | | | | |
| | current | | | | | | | | | | |
| | Electron | 1 | mm | 1 | mm | 10 | um | 2 | um | 200 | um |
| | beam spot | | | | | | | | | | |
| | size | | | | | | | | | | |
| | Average | 100 | | 100 | | 10000 | | 250 | | 25 | |
| | current | | | | | | | | | | |
| | density | | | | | | | | | | |
| | (mA/mm²) | | | | | | | | | | |
| Laser | Wavelength | — | | — | | — | | 1030 | nm | — | |
| source | Pulse energy | — | | — | | — | | 10 | mJ | — | |
| | Beam waist | — | | — | | — | | 5 | um | — | |
| | Repetition | — | | — | | — | | 100 | KHz | — | |
| | rate | | | | | | | | | | |

PXR is a prospective source of quasi-coherent hard X-rays obtainable at a relatively low-energy electron accelerator. It was demonstrated in practical applications, such as phase-contrast imaging using differential-enhanced imaging (DEI), X-ray absorption fine structure (XAFS), X-ray fluorescence (XRF), and computed tomography (CT). It can potentially serve biomedical imaging with a quasi-monochromatic and directional beam, thus reducing radiation dose while improving contrast. PXR has several advantages compared with other compact X-ray sources. Its energy tunability is achieved using crystal rotation, a mechanism that gives much flexibility in choosing the required X-ray energy. Its relatively large field of view allows a short distance between the PXR source to the target, thus permitting a more compact imaging environment. Due to the similarity between PXR spatial dispersion and the monochromator transfer function, it allows excellent filtration using a crystal monochromator. Its flux is comparable with the inverse Compton scattering X-ray source. Moreover, a PXR source can be used with electron energies below the neutron production threshold, thus enabling much fewer shielding requirements. All of these enable PXR usage for practical applications.

In the following, the principles of the technique of the present disclosure are described in more detail, including derivation of the equation used in the description above.

### 1. Parametric X-Ray Heat Dynamics

1.1 Specifically, the inventors develop the dependence of the PXR emission on the heat dynamics of the electron beam on the PXR crystal and find an optimized limit of the electron source current on the PXR intensity. The analysis is started with the heat equation:

$$ρ {C}_{p} \frac{\partial T}{\partial t} - κ {∇}^{2} T = {P}_{source} - {P}_{sink} - \frac{ε σ}{d} ( {T}^{4} - {T}_{0}^{4} ) \qquad ( 221 )$$

where κ is the thermal conductivity, p is the material density, C, is the heat capacity, P_{source} is the power per unit volume deposited in the crystalline by the electron beam, Pₛᵢₙₖ is the power per unit volume which is cooled at the edge of the crystalline. The last term in Eq. (21) represents the black-body radiation, where E is the material emissivity,

$$σ = 5. 67 \times 1 {0}^{- 8} [ \frac{W}{{m}^{2} {K}^{4}} ]$$

is Stefan-Boltzmann constant, and T₀ is the environment temperature. The partial differential equation (Eq. (21)) describes the input power deposited into the material (P_{source}) and the thermal load due to the input power (ρCₚ∂T/∂t). Moreover, it describes heat dissipation due to thermal conductivity (K∇²T) and black-body radiation

$$( \frac{ϵσ}{d} ( {T}^{4} - {T}_{0}^{4} ) ) .$$

This equation can be solved numerically for the general case. The inventors solve the equation analytically for the case where one of the heat dissipation processes is dominant.

The units of the heat dynamics parameters are presented in Table 5, whereas the values for different materials are presented in Table 6.

Further below the inventors present the following derivations: (i) the temperature load of the target PXR crystal due to a single electron pulse shot; (ii) the conditions under which each one of the heat dissipation processes is dominant, i.e., black-body radiation versus thermal conductivity); (iii) the inventors solve the PXR material heat equation for the case that thermal conductivity and black-body radiation are the dominant heat dissipation process, respectively; and (iv) the optimized electron source repetition rate and pulse charge for both cases while considering the thermal effect on the PXR yield (the Debye-Waller factor).

TABLE 5

| # | Parameter | Symbol | Units |
|---|---|---|---|
| 1 | Mass density | ρ | Kg/m³ |
| 2 | Heat capacity | Cₚ | J K⁻¹ Kg⁻¹ |
| 3 | Temperature | T | K |
| 4 | Thermal conductivity | κ | W m⁻¹ K⁻¹ |
| 5 | Emissivity | ϵ | — |
| 6 | Stefan-Boltzmann constant | σ | $\frac{W}{{m}^{2} {K}^{4}}$ |
| 7 | Pulse charge | Qₚᵤₗₛₑ | C |
| 8 | Pulse duration | τₚ | s |
| 9 | Pulse beam size | A | m² |
| 10 | Material thickness | d | m |
| 11 | Electron energy loss per unit distance | [symbol] dE /dx [symbol] | MeV/m |

TABLE 6

| | | | Thermal | Melting | Debye |
|---|---|---|---|---|---|
| | Density | Heat capacity | conductivity | temperature | Temperature |
| Material | (g/cm³) | (J K⁻¹ Kg⁻¹) | (W cm⁻¹ K⁻¹) | (K) | (K) |
| Graphite | 2.267 | 710 | 1.50 | 3800 | 1860 |
| Aluminum | 2.7 | 890 | 2.37 | 933 | 390 |
| Silicon | 2.329 | 700 | 1.49 | 1687 | 512 |
| Copper | 8.960 | 385 | 4.01 | 1357 | 310 |
| Molybdenum | 10.280 | 250 | 1.38 | 2896 | 377 |
| Tungsten | 19.250 | 130 | 1.74 | 3695 | 312 |

1.2 Crystal Temperature Rise from a Single Shot

In the following, the crystal temperature rise from a single shot is calculated. First, it is assumed that a single short electron pulse with a charge Qₚᵤₗₛₑ passes through the PXR crystal. The mean electron energy loss (of a single electron) which passes through the crystal is given by the Bethe formula:

$$- 〈 \frac{d {E}_{e}}{dx} 〉 = 4 π NZ ( \frac{{z}^{2} {e}^{4}}{m {v}_{e}^{2}} ) [ ln ( \frac{2 {γ}_{e}^{2} m {v}_{e}^{2} {T}_{max}}{{( ℏ 〈 ω 〉 )}^{2}} ) - {β}^{2} - \frac{δ ( β γ )}{2} ] , \qquad ( 222 )$$

where Z is the material atomic number, N is the material density, vₑ=βc is the electron velocity, γₑ is the Lorentz factor, m is the electron rest mass, ℏ [symbol] ω [symbol] is the mean excitation potential, Tₘₐₓ is the maximum energy transfer in a single collision, and δ is Fermi's density correction. The mean electron energy loss for different materials can be found in Table 6. Therefore, the total energy deposited per unit volume is:

$$\frac{dE}{dV} = 〈 \frac{d {E}_{e}}{dx} 〉 \frac{{Q}_{pulse}}{A} , \qquad ( 223 )$$

where the electron beam area is A. Under the assumption that the thermal diffusion and the black-body radiation timescales are much longer than the electron beam pulse duration, one can treat only the ρCₚ∂T/∂t and P_{source} terms in Eq. (21). For material with heat capacity C, and mass density p, the temperature load is given by (combining Eq. (21) and Eq. (23)):

$$Δ T = \frac{〈 d {E}_{e} ∖ dx 〉}{{C}_{p} ρ} \frac{{Q}_{pulse}}{A} , \qquad ( 224 )$$

A simple dimension analysis would give the same result. This result implies that material with a higher mean energy loss will have higher temperature load. On the one hand, the mean energy loss is proportional to the atomic number,

$$〈 \frac{{dE}_{e}}{dx} 〉 ∝ Z ,$$

i.e., heavier materials will have a higher temperature rise. On the other hand, heavier materials also have higher melting temperatures. The aim in the following description is to find the optimized heat load and repetition rate for the different materials examined.

### 1.3 Heat Dissipation Regimes

Solving Eq. (21) analytically for the general case where thermal conductivity and the black-body radiation are both treated is not feasible. In this case, a numerical simulation simulates the heat dynamics as described above. However, for the case when only one of the heat dissipation processes is dominant (i.e., when either only the thermal conductivity or the black-body radiation exists), the heat equation has an analytic solution. From Eq. (21), the thermal conductivity is the dominant regime when the following condition holds:

$$κ {∇}^{2} T ≫ \frac{ϵσ}{d} ( {T}^{4} - {T}_{0}^{4} ) , \qquad ( 225 )$$

As will be seen later, the maximal current achievable for the two cases is given by:

$${I}_{thermal} = \frac{4 π exp ( - 1 ) κ {T}_{max}}{〈 {dE}_{e} \backslash dx 〉} , {I}_{blackbody} = \frac{ϵσ {AT}_{max}^{4}}{d 〈 {dE}_{e} \backslash dx 〉}$$

Therefore, the condition for which the thermal conductivity is the dominant is given by:

$$\frac{4 π exp ( - 1 ) κ {T}_{max}}{〈 {dE}_{e} \backslash dx 〉} ≫ \frac{ϵσ {AT}_{max}^{4}}{d 〈 {dE}_{e} \backslash dx 〉} \to d ≫ \frac{ϵσ {AT}_{max}^{3}}{4 κ} , \qquad ( 226 )$$

These results can be interpreted as follows—for a thin material with a large beam area, the black-body radiation will be the dominant heat dissipation mechanism as the large surface area will radiate considerably more than the thermal conductance within the volume deposited by the electron beam. In most of the experimental cases, thermal conductivity is the dominant regime; thus, mainly this case was treated in the description above.

### 1.4 Thermal Conductivity Dominant Regime

In the following, the inventors develop the analytic expression for the case in which the thermal conductivity process is dominant. In this case, Eq. (21) reduces to:

$$ρ {C}_{p} \frac{\partial T}{\partial t} - κ {∇}^{2} T = {P}_{source} \qquad ( 227 )$$

It is assumed that the electron source is a pulsed source with a pulse duration much shorter than the typical timescale of thermal diffusion. The inventors examine the heat dynamics after the pulse arrival end; thus, the P_{source} term can be removed from Eq. (27) and the initial temperature can be set to be Tₘₐₓ, derived by Eq. (24). The inventors examine two cases for the spatial shape of the electron beam—the first is a circular beam, while the second (a more simplified analytic expression) is a square beam. The one-dimensional fundamental solution for the heat equation is given by:

$$Φ ( x , t ) = \frac{1}{\sqrt{4 π Dt}} {e}^{- {x}^{2} / 4 Dt} , \qquad ( 228 )$$

where the thermal diffusivity is denoted by D [symbol] κ/ρCₚ. The n-variable fundamental solution is the product of the fundamental solution of each variable:

$$Φ ( r , t ) = \frac{1}{{( 4 π Dt )}^{n / 2}} {e}^{- {‖ r ‖}^{2} / 4 Dt} , \qquad ( 229 )$$

Due to the electron beam spatial symmetry and the assumption of constant electron beam energy loss along the whole interaction length (Eq. (22)), the problem is two-dimensional (n=2), defined by the plane parallel to the electron trajectory. The initial thermal load spatial shape is denoted by g(r), induced by the incident electron beam shape. Thus, the temperature dynamics are the convolution product of the input thermal load and the fundamental solution:

$$T ( r , t ) = {\int }_{- ∞}^{∞} Φ ( r - {r}^{′} , t ) g ( {r}^{′} ) {dr}^{′} , \qquad ( 30 )$$

### 1.4.1 Square Electron Beam

Here the inventors assume that the electron beam has a square shape, i.e., the initial conditions for this case are:

$$g ( r ) = T ( r , 0 ) = \{ \begin{matrix}{T}_{max} & \vert x \vert , \vert y \vert \leq {R}_{beam} \\ 0 & otherwise\end{matrix} , \qquad ( 31 )$$

And the boundary condition:

T(δr,t)=0

Plugging this into Eq. (30), gives:

$$T ( r , t ) = \frac{1}{4 π Dt} {\int }_{- ∞}^{∞} {\int }_{- ∞}^{∞} {dx}^{′} {dy}^{′} {e}^{- \frac{[ {( x - {x}^{′} )}^{2} + {( y - {y}^{′} )}^{2} ]}{4 Dt}} g ( {x}^{′} , {y}^{′} ) = \frac{{T}_{max}}{4 π Dt} {\int }_{- {R}_{beam}}^{{R}_{beam}} {\int }_{- {R}_{beam}}^{{R}_{beam}} {dx}^{′} {dy}^{′} {e}^{- \frac{[ {( x - {x}^{′} )}^{2} + {( y - {y}^{′} )}^{2} ]}{4 Dt}}$$

The integrals are given by:

$$\frac{1}{\sqrt{4 π Dt}} {\int }_{- {R}_{beam}}^{{R}_{beam}} {dx}^{′} {e}^{- \frac{{( x - {x}^{′} )}^{2}}{4 Dt}} = \frac{1}{2} [ erf ( \frac{{R}_{beam} + x}{\sqrt{4 π Dt}} ) - erf ( \frac{- {R}_{beam} + x}{\sqrt{4 π Dt}} ) ]$$

where erf is the error function defined by

$$erf ( x ) = \frac{2}{\sqrt{π}} {\int }_{0}^{x} {e}^{- {t}^{2}} dt .$$

Therefore, the following heat dynamics expression is obtained:

$$T ( r , t ) = \frac{{T}_{max}}{4} [ erf ( \frac{{R}_{beam} + x}{\sqrt{4 Dt}} ) - erf ( \frac{- {R}_{beam} + x}{\sqrt{4 Dt}} ) ] \times [ erf ( \frac{{R}_{beam} + y}{\sqrt{4 Dt}} ) - erf ( \frac{- {R}_{beam} + y}{\sqrt{4 Dt}} ) ] , \qquad ( 32 )$$

As expected, the maximal value of the temperate T(r,t) is in the center of the beam (r=0) and given by:

$${T}_{sq} ( 0 , t ) = {T}_{max} {erf}^{2} ( \frac{{R}_{beam}}{\sqrt{4 Dt}} ) , \qquad ( 33 )$$

It should be noted that the typical timescale of the thermal conductivity is:

$${τ}_{T D} = {R}_{beam}^{2} / 4 D , \qquad ( 34 )$$

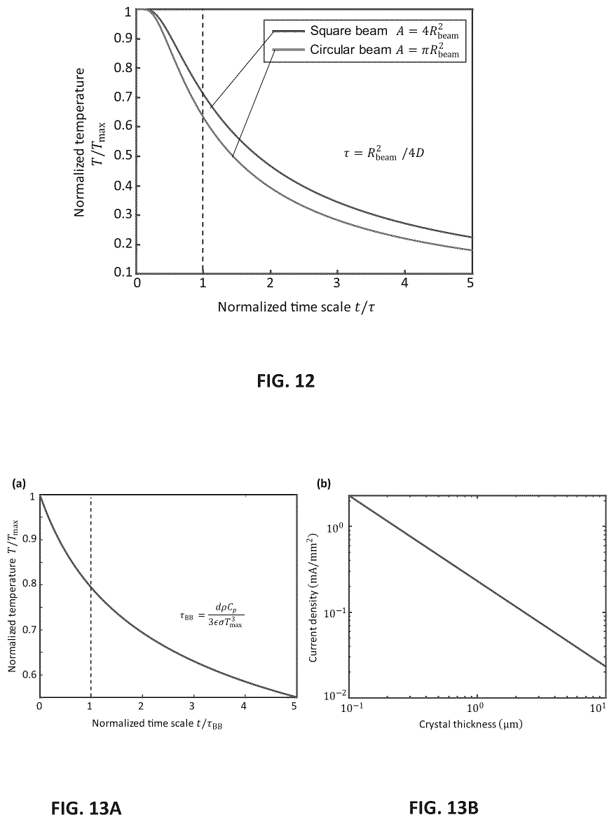

In other words, for a larger electron beam area, a longer time is needed to dissipate the thermal load on the crystal. FIG. 12 compares the temperature at the center of the beam, for a fixed diffusion coefficient D, between an incident square beam to a circular beam with the same parameters.

### 1.4.2 Circular Electron Beam

In the following, the case of a circular electron beam is considered, for which the initial input heat transfer is given by:

$$g ( r ) = \{ \begin{matrix}{T}_{max} & r \leq {R}_{beam} \\ 0 & r > {R}_{beam}\end{matrix} , \{ \begin{matrix}{T}_{max} r \leq {R}_{beam} \\ 0 r > {R}_{beam}\end{matrix} , \qquad ( 35 )$$

Plugging Eq. (33) into Eq. (29), gives:

$$T ( r , t ) = \frac{1}{4 π Dt} {\int }_{- ∞}^{∞} {\int }_{- ∞}^{∞} {dx}^{′} {dy}^{′} {e}^{- \frac{[ {( x - {x}^{′} )}^{2} + {( y - {y}^{′} )}^{2} ]}{4 Dt}} g ( {x}^{′} , {y}^{′} ) = \frac{1}{4 π Dt} {\int }_{{x′}^{2} + {y′}^{2} \leq {R}_{beam}^{2}}^{} {dx}^{′} {dy}^{′} {e}^{- \frac{[ {( x - {x}^{′} )}^{2} + {( y - {y}^{′} )}^{2} ]}{4 Dt}} = \frac{1}{4 π Dt} {\int }_{0}^{{R}_{beam}} {\int }_{0}^{2 π} s ds d {θ}^{′} {e}^{- ( {s}^{2} - 2 sx} cos ( {θ}^{′} ) - 2 sy sin ( {θ}^{′} ) + {x}^{2} + {y}^{2} ) / 4 Dt =$$

Where in the last step polar variables change of the integral variables was performed:

$${x}^{′} = s cos {θ}^{′} , {y}^{′} = s sin {θ}^{′} , \qquad ( 36 )$$

Additional variables change is performed for the position variables of the temperature function:

$$x = r cos θ , y = r sin θ , \qquad ( 37 )$$

Substituting Eq. (36), it is derived:

$$\frac{1}{4 π D t} {\int }_{0}^{{R}_{beam}} {\int }_{0}^{2 π} s ds d {θ}^{′} {e}^{- ( {s}^{2} - 2 sr cos ( θ - {θ}^{′} ) + {r}^{2} ) / 4 D t} = \frac{{e}^{- {r}^{2} / 4 α t}}{2 Dt} {\int }_{0}^{{R}_{beam}} s {e}^{- {s}^{2} / 4 Dt} {I}_{0} ( \frac{2 sr}{4 Dt} ) ds$$

where I₀ is the modified Bessel function of the first kind. Therefore, the inventors get the following expression for temperature dynamics in the PXR material:

$$T ( r , t ) = \frac{{e}^{- {r}^{2} / 4 α t}}{2 Dt} {\int }_{0}^{{R}_{beam}} s {e}^{- {s}^{2} / 4 Dt} {I}_{0} ( \frac{2 sr}{4 Dt} ) ds , \qquad ( 38 )$$

For sanity check, one should note the symmetry over the polar angle θ, as expected. The maximal value of T(r,t) is received for r=0:

$${T}_{circ} ( 0 , t ) = {T}_{max} [ 1 - exp ( - {R}_{beam}^{2} / 4 Dt ) ] , \qquad ( 39 )$$

### 1.5 Black-Body Radiation Dominant Regime

In the following, the inventors examine the case of heat dissipation process dominated by black-body radiation. For this case, Eq. (21) is reduced to:

$$ρ {C}_{p} \frac{\partial T}{\partial t} = {P}_{source} - \frac{ϵσ}{d} ( {T}^{4} - {T}_{0}^{4} ) \qquad ( 40 )$$

The case of interest is T⁴>>T₀₄, and the temperature profile after the electron pulse arrival (P_{source}∝δ(t)), therefore the equation can be reduced and solved analytically:

$$\int \frac{d T}{{T}^{4}} = - \frac{ϵσ}{d ρ {C}_{p}} t \to \frac{1}{3 {T}_{max}^{3}} - \frac{1}{3 {T}^{3}} = - \frac{ϵσ}{d ρ {C}_{p}} t \qquad ( 41 )$$

$$T ( t ) = {{T}_{max} ( 1 + \frac{3 ϵσ {T}_{max}^{3}}{d ρ {C}_{p}} t )}^{- 1 / 3}$$

Reference is made to FIGS. 13A and 13B. FIG. 13A shows the temperature profile for the black body-radiation regime. FIG. 13B shows the maximal current density achievable for black-body radiation regime as a function of the crystal thickness.

The typical timescale of the black-body radiation regime is:

$${τ}_{BB} = \frac{d ρ {C}_{p}}{3 ϵσ {T}_{max}^{3}} \qquad ( 42 )$$

Comparing this value to typical timescale of the thermal conductivity regime (Eq. (34)):

$$\frac{d ρ {C}_{p}}{3 ϵσ {T}_{max}^{3}} = \frac{{R}_{beam}^{2}}{4 D} \to d = \frac{3 ϵσ {T}_{max}^{3} {R}_{beam}^{2}}{4 κ}$$

$$Therefore ,$$

$$for d >> \frac{3 ϵσ {T}_{max}^{3} {R}_{beam}^{2}}{4 κ} ,$$

the thermal conductivity timescale is shorter than the black-body radiation regime, i.e., the thermal conductivity process is more dominant than the black-body radiation for this case.

If the repetition rate of the source is optimized for the black-body radiation dominance regime, one gets:

$${I}_{PXR} ∝ {Q}_{pulse} {f}_{r} ∝ Δ T {f}_{r} = \frac{( {T}_{max} - T ( {τ}_{r} ) )}{{τ}_{r}} = {T}_{max} ( \frac{1 - {( 1 + \frac{3 ϵσ {T}_{max}^{3}}{d ρ {C}_{p}} {τ}_{r} )}^{- \frac{1}{3}}}{{τ}_{r}} )$$

The maximal value for this case is for τᵣ→0, i.e., a CW source. In particular, in the steady state, when the incoming heat load is equal to the heat dissipated by the black-body radiation, the current is given by:

$$\begin{matrix}I = \frac{d Q}{dt} = \frac{d Q}{dt} = \frac{{AT}_{max} {C}_{p} ρ}{〈 {dE}_{e} ∖ dx 〉} {lim}_{t \to 0} ( \frac{1 - {( 1 + \frac{3 ϵσ {T}_{max}^{3}}{d ρ {C}_{p}} t )}^{- \frac{1}{3}}}{t} ) \\ = \frac{{AT}_{max} {C}_{p} ρ}{〈 {dE}_{e} ∖ dx 〉} [ \frac{1}{3} \frac{3 ϵσ {T}_{max}^{3}}{d ρ {C}_{p}} ] \\ = \frac{ϵσ {AT}_{max}^{4}}{〈 d 〈 {dE}_{e} ∖ dx 〉}\end{matrix}$$

Therefore, the inventors get the maximal current possible for the case the black-body radiation is the dominant heat-dissipation process to be:

$$I = \frac{ϵσ {AT}_{max}^{4}}{d 〈 {dE}_{e} ∖ dx 〉} \qquad ( 43 )$$

It should be noted that the same result can be derived directly from the steady-state solution of equation (20):

$${P}_{source} = \frac{ϵσ}{d} ( {T}^{4} - {T}_{0}^{4} ) \qquad ( 44 )$$

Following the relation

$${P}_{source} = \frac{〈 {dE}_{e} ∖ dx 〉 I}{A} ,$$

one gets the same results as in equation (43).

### 1.6 Optimizing the Electron Source Current and Repetition Rate

After finding the optimized electron source current for the case of the black-body radiation dominant regime, the optimized electron pulse charge and repetition rate for the thermal conductivity dominance regime were found. Putting together the terms that depend on the heat dynamics in the PXR emission (Eq. (43)), the inventors show that the PXR intensity is proportional to:

$${I}_{PXR}^{( total )} ∝ {Q}_{pulse} {f}_{r} exp ( - 2 W ) \qquad ( 45 )$$

where Qₚᵤₗₛₑfᵣ is the average electron source current and W is the Debye-Waller factor. Here, the case of a circular shaped electron beam is considered, thus plugging equation (24) and equation (39) into equation (45) gives:

$${I}_{PXR}^{( total )} ∝ Δ T {f}_{r} exp ( - 2 W ) = {T}_{max} \frac{exp ( - \frac{{R}_{beam}^{2}}{4 D {τ}_{r}} )}{{τ}_{r}} exp ( - 2 W ) \qquad ( 46 )$$

It should be noted that equation (46) consists of two sub-terms. The first is proportional to the repetition rate and the electron beam size

$$( exp ( - \frac{{R}_{beam}^{2}}{4 D {τ}_{r}} ) / {τ}_{r} ) ,$$

and the second is proportional to the temperature and pulse charge (Tₘₐₓ exp(−2W)). Therefore, each term can be optimized separately to achieve the maximal electron pulse current. It is assumed that the PXR emission occurs when the crystal thickness is maximal, which is an approximation since the emission occurs all over the temperature load period.

In the following, the inventors optimize the electron source repetition rate and the electron pulse charge as a function of the Debye-Waller term.

### 1.6.1 Optimizing Repetition Rate.

By optimizing the term proportional to the repetition rate in equation (46), the inventors find the optimal repetition rate to be

$${τ}_{r} = \frac{{R}_{beam}^{2}}{4 D} .$$

A similar result is also obtained for a square-shaped electron beam. Thus, the optimized electron beam current is:

$${I}_{TD} = {Q}_{pulse} {f}_{r} = \frac{A {C}_{p} ρ}{〈 d {E}_{e} ∖ dx 〉} Δ T {f}_{R} = \frac{A {C}_{p} ρ}{〈 d {E}_{e} ∖ dx 〉} {T}_{max} \frac{exp ( - 1 )}{\frac{{R}_{beam}^{2}}{4 D}} = \frac{4 π exp ( - 1 ) κ {T}_{max}}{〈 d {E}_{e} ∖ dx 〉} {I}_{TD} = \frac{4 π exp ( - 1 ) κ {T}_{max}}{〈 d {E}_{e} ∖ dx 〉} , \qquad ( 47 )$$

As stated above, the electron beam current for this case is significantly higher than the possible electron beam currents for the black-body radiation dominant regime for

$$d ≫ \frac{3 ϵσ {T}_{max}^{3} {R}_{beam}^{2}}{4 κ} .$$

### 1.6.2 Optimizing Electron Pulse Charge.

Also, an upper limit on the electron pulse charge is to be found. The terms which depend on the temperature (and thus also on the electron charge pulse) in Eq. (46) are T exp(−2W). Putting the explicit terms of Debye-Waller, 2W=τₕₖₗ²u²(T), where τₕₖₗ is the reciprocal lattice vector, defined by

$${τ}_{hkl} = \frac{2 π}{{d}_{hkl}} ,$$

and u²(T) is given by:

$${u}^{2} ( T ) = \frac{3 {ℏ}^{2}}{4 M {k}_{B} {T}_{D}} [ 1 + 4 {( \frac{T}{{T}_{D}} )}^{2} {{\int }^{{T}_{D} / T}}_{0} \frac{y}{{e}^{y} - 1} dy ] , \qquad ( 48 )$$

where T_{D} is Debye temperature. Arranging the term using the polylogarithmic function Li₂:

$${u}^{2} ( T ) = \frac{3 {ℏ}^{2}}{4 M {k}_{B} {T}_{D}} [ - 1 - 4 {( \frac{T}{{T}_{D}} )}^{2} {Li}_{2} ( 1 - exp ( \frac{{T}_{D}}{T} ) ) ]$$

The case of interest is T>>T_{D}, thus a first order Taylor approximation is performed:

$${Li}_{2} ( 1 - exp ( \frac{{T}_{D}}{T} ) ) \approx {Li}_{2} ( - \frac{{T}_{D}}{T} ) \approx - \frac{{T}_{D}}{T}$$

and u²(T) can be approximated by:

$${u}^{2} ( T ) = \frac{3 {ℏ}^{2}}{4 M {k}_{B} {T}_{D}} [ - 1 + 4 \frac{T}{{T}_{D}} ] , \qquad ( 49 )$$

Therefore, substituting Eq. (49) into Eq. (46), the PXR intensity is proportional to:

$${I}_{PXR} ∝ T exp ( - \frac{3 {ℏ}^{2} {τ}_{hkl}^{2}}{4 M {k}_{B} {T}_{D}} [ - 1 + 4 \frac{T}{{T}_{D}} ] ) , \qquad ( 50 )$$

The optimal temperature (for maximal I_{PXR}) is achieved for:

$${T}_{opt} = min ( \frac{M {k}_{B} {T}_{D}^{2}}{3 {ℏ}^{2} {τ}_{hkl}^{2}} , {T}_{melt} ) , \qquad ( 51 )$$

where the maximal temperature was bounded by the material's melting temperature.

### 2. Parametric X-Ray Cross-Section.

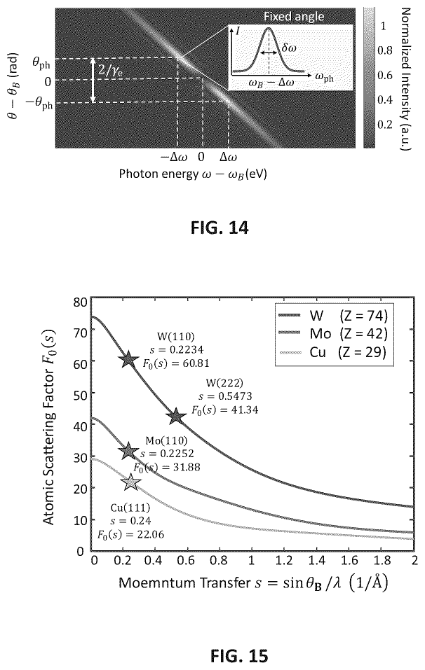

2.1 In the following, the inventors examine the different parameters which impact the PXR yield. In particular, the inventors treat the PXR spatial dispersion (FIG. 14), the geometrical factor, the scattering factor and momentum transfer, the impact of the electron beam scattering and the PXR energy linewidth broadening. First, the similarity between the derivation of the kinematical theory in the reciprocal space and the real space is shown. Then it will be seen how the dynamical theory affects the PXR cross-section. The PXR photon distribution for a single electron in the kinematical model derived in the reciprocal space is given by:

$$\frac{{dN}_{PXR}^{( reciprocal )}}{d {θ}_{x} d {θ}_{y}} = \frac{α}{4 π} \frac{{ω}_{B}}{c {sin}^{2} {θ}_{B}} {f}_{geo} {χ}_{g}^{2} {e}^{- 2 W} N ( {θ}_{x} , {θ}_{y} ) , \qquad ( 52 )$$

where α is the fine-structure constant, ω_{B} is the emitted PXR photon energy, c is the speed of light, θ_{B} is the Bragg angle, e^{-2W} is the Debye-Waller factor, χ_{g} is the Fourier expansion of the electric susceptibility, N(θₓ,θ_{y}) is the PXR angular dependence, and f_{geo} is the geometrical factor. The PXR angular dependence is given by:

$$N ( {θ}_{x} , {θ}_{y} ) = \frac{( {θ}_{x}^{2} {cos}^{2} ( 2 {θ}_{B} ) + {θ}_{y}^{2} )}{{[ ( {θ}_{x}^{2} + {θ}_{y}^{2} ) + {θ}_{ph}^{2} ]}^{2}} \qquad ( 53 )$$

where θₓ is the angle in the diffraction plane, By is the angle perpendicular to θₓ in the diffraction plane and

$${θ}_{ph}^{2} = \frac{1}{{γ}_{e}^{2}} + {( \frac{{ω}_{p}}{ω} )}^{2} ,$$

where ωₚ is the plasma frequency of the material.

On the other hand, the inventors have previously shown that the PXR cross-section can be developed using the kinematical approximation in the real space for nanomaterials, and was found to be [3]:

$$\frac{{dI}_{PXR}^{( real )}}{d {θ}_{x} d {θ}_{y} d ω} ≅ \frac{{q}^{2} {r}_{0}^{2}}{{πϵ}_{0} {β}^{2} c} ( \frac{{ρ}_{max}^{2}}{{A}_{cell}^{2}} ) {\vert f ( {ω}_{B} ) \vert}^{2} {\vert \frac{sin ( \frac{N}{2} {k}_{0} {d}_{z} ( 1 - cos {θ}_{ph} ) )}{sin ( \frac{1}{2} {k}_{0} {d}_{z} ( 1 - cos {θ}_{ph} ) )} \vert}^{2} \frac{{γ}^{2} ( {θ}_{x}^{2} {cos}^{2} ( {θ}_{ph} ) + {θ}_{y}^{2} )}{{[ {γ}^{2} ( {θ}_{x}^{2} + {θ}_{y}^{2} ) + 1 ]}^{2}} , \qquad ( 54 )$$

where q is the electron charge, r₀ is the electron radius, β=v/c, f(ω_{B}) is the atomic scattering factor in the Bragg emission energy ω_{B}, N is the number of layers of the nanocrystal, d_{z} is the inter-lattice distance in the zone axis of the vdW material, A_{cell} is the is the unit cell area (the area defined perpendicular to the zone axis),

$${k}_{0} = \frac{{ω}_{B}}{c} ,$$

θₚₕ is the angle between the incident electron beam to the emitted photon, i.e., θₚₕ=2θ_{B}, where θ_{B} is the Bragg angle, γ=(1−β)^{-1/2},

$${ρ}_{max} = \frac{γ c}{{ω}_{B}}$$

and θₓ, θ_{y} are the angular displacement relative to θₚₕ in the detector plane. For realistic applications, the detector has finite energy resolution, i.e., it collects the emitted X-ray photons within energy resolution of Δωᵣₑₛ, which is much greater than 1/N; therefore, the Dirichlet kernel can be approximated as follow:

$${{\int }_{{ω}_{B} - {Δω}_{res}}^{{ω}_{B} + {Δω}_{res}} d ω \vert \frac{sin ( \frac{N}{2} \frac{ω {d}_{z} ( 1 - cos {θ}_{ph} )}{c} )}{sin ( \frac{1}{2} \frac{ω {d}_{z} ( 1 - cos {θ}_{ph} )}{c} )} \vert}^{2} {( \frac{{d}_{z} ( 1 - cos {θ}_{ph} )}{c} )}^{- 1} π N δ ( ω - {ω}_{B} ) = \frac{π Nc}{{d}_{z} ( 1 - cos {θ}_{ph} )} δ ( ω - {ω}_{B} ) = \frac{π Lc}{2 {d}_{z}^{2} {sin}^{2} {θ}_{B}} δ ( ω - {ω}_{B} )$$

where in the last step L=Nd_{z} was used. Plugging this approximation into Eq. (54), and using the relation between the fine-structure constant to the electric charge, the reduced plank constant and speed of light in vacuum

$$α = \frac{1}{4 {πε}_{0}} \frac{{q}^{2}}{ℏc} ,$$

one gets:

$$\frac{{dI}_{PXR}^{( real )}}{d {θ}_{x} d {θ}_{y}} =$$

$${= \frac{{q}^{2} {r}_{0}^{2}}{{πϵ}_{0} {β}^{2} c} ( \frac{{ρ}_{max}^{2}}{{A}_{cell}^{2}} ) \vert f ( {ω}_{B} ) {\vert}^{2} \vert \frac{sin ( \frac{N}{2} {k}_{0} {d}_{z} ( 1 - cos {θ}_{ph} ) )}{sin ( \frac{1}{2} {k}_{0} {d}_{z} ( 1 - cos {θ}_{ph} ) )} \vert}^{2} \frac{{γ}^{2} ( {θ}_{x}^{2} {cos}^{2} ( {θ}_{ph} ) + {θ}_{y}^{2} )}{{[ {γ}^{2} ( {θ}_{x}^{2} + {θ}_{y}^{2} ) + 1 ]}^{2}}$$

$$\approx 4 π α {ℏr}_{0}^{2} \frac{{γ}^{2} {c}^{2}}{{ω}_{B}^{2}} \frac{\vert f ( {ω}_{B} ) {\vert}^{2}}{{A}_{cell}^{2}} \frac{Lc}{{d}_{z}^{2} {sin}^{2} {θ}_{B}} \frac{{γ}^{2} ( {θ}_{x}^{2} {cos}^{2} ( {θ}_{ph} ) + {θ}_{y}^{2} )}{{[ {γ}^{2} ( {θ}_{x}^{2} + {θ}_{y}^{2} ) + 1 ]}^{2}}$$

$$= α {ℏχ}_{g}^{2} \frac{L}{c} \frac{{ω}_{B}^{2}}{4 π} \frac{1}{{sin}^{2} {θ}_{B}} \frac{( {θ}_{x}^{2} {cos}^{2} ( 2 {θ}_{B} ) + {θ}_{y}^{2} )}{{[ ( {θ}_{x}^{2} + {θ}_{y}^{2} ) + {θ}_{ph}^{2} ]}^{2}}$$

where in the last step the relation (Eq. (64)) was used:

$${χ}_{g}^{2} = \frac{{λ}^{4} {r}_{0}^{2}}{{π}^{2} {V}_{c}^{2}} \vert f ( {ω}_{B} ) {\vert}^{2} = \frac{16 {π}^{2} {c}^{4} {r}_{0}^{2}}{{ω}_{B}^{4} {V}_{c}^{2}} \vert f ( {ω}_{B} ) {\vert}^{2} = \frac{16 {π}^{2} {c}^{4} {r}_{0}^{2}}{{ω}_{B}^{4} {A}_{cell}^{2} {d}_{z}^{2}} \vert f ( {ω}_{B} ) {\vert}^{2}$$

The number of emitted X-ray photons is derived by substituting

$$\frac{d {N}_{P X R}}{d {θ}_{x} d {θ}_{y}} = \frac{{dI}_{P X R}}{d {θ}_{x} d {θ}_{y}} \frac{1}{ℏω} : \frac{d {N}_{P X R}^{( real )}}{d {θ}_{x} d {θ}_{y}} = \frac{d N}{d {θ}_{x} d {θ}_{y}} = \frac{α}{4 π} \frac{{ω}_{B}}{c {sin}^{2} {θ}_{B}} L {χ}_{g}^{2} N ( {θ}_{x} , {θ}_{y} ) , \qquad ( 55 )$$

Hence, the real space and reciprocal space give similar results. Two main differences exist between the two derivations—the geometrical factor and the Debye-Waller term. The geometrical factor accounts for the inner absorption of the emitted PXR photon within the material, and the Debye-Waller factor accounts for the target material temperature dependence on the PXR yield.

The PXR cross-section derivation above neglects these two terms as the target material used in those experiments was a nanocrystal. In this case, the geometrical factor equals the material thickness, as the PXR emitted photons' self-absorption is negligible for thin materials. Second, the temperature load in those experiments was insignificant since low electron currents were used [6].

For the general case of a thick PXR crystal and high electron beam currents, the PXR cross-section expression includes both Debye-Waller and the geometrical factors. The impact of the Debye-Waller term on the yield was treated above, and further below the inventors treat the geometrical factor. Additionally, for thick material, the extinction phenomenon is to be considered, similar to the dynamical diffraction theory of X-ray and is treated in the following.

TABLE 7

| | | | Unit | Absorption | Radiation | Plasma |
|---|---|---|---|---|---|---|
| | Atomic | | cell | Length at | Length | Frequency ωₚ |
| | number | Lattice | dimensions | 30 KeV | X₀ | (rad/s) × |
| | Z | Type | [Å] | L_{abs} [mm] | [mm] | 10¹⁶ |
| Graphite | 6 | Hexagonal | d₀ = 2.461 | 80.7 | 164 | 4.66 |
| | | | c = 6.708 | | | |
| Aluminum | 13 | FCC | 4.04 | 4.33 | 89.9 | 4.7 |
| Silicon | 14 | FCC | 5.43 | 3.77 | 94.8 | 4.74 |
| Copper | 29 | FCC | 3.61 | 0.11 | 14.7 | 7.68 |
| Molybdenum | 42 | BCC | 3.14 | 0.036 | 9.8 | 9 |
| Tungsten | 74 | BCC | 3.165 | 0.024 | 3.5 | 12.69 |

### 2.2 PXR Spatial Dispersion

In the following, the inventors derive the PXR spatial dispersion term as part of the kinematical theory. Then it is examined how this term changes when considering dynamical theory effects, i.e., extinction and self-reflection. In a previous work by the inventors, the following spatial dispersion relation for hexagonal lattice structure was found [3](FIG. 3A):

$$Δ ω = {ω}_{R} [ \frac{sin ( {θ}_{p h} )}{1 / β - cos ( {θ}_{p h} )} \frac{1}{γ} ] , \qquad ( 56 )$$

$$δω = \frac{2 π c}{{d}_{z} N ( \frac{1}{β} - cos {θ}_{p h} )} , \qquad ( 57 )$$

Substituting θₚₕ^{20B} and β≈1:

$$\frac{Δω}{{ω}_{B}} = \frac{{θ}_{p h}}{tan {θ}_{B}} , \qquad ( 58 )$$

$$\frac{δω}{{ω}_{B}} = \frac{1}{N} , \qquad ( 59 )$$

where the inventors used the relation between the inter-lattice distance dₕₖₗ and d_{z} for hexagonal lattice to be dₕₖₗ d_{z} sin θ_{B}. This result is similar to the kinematical theory of X-ray theory. However, for material thicker than the extinction length (−1 μm), effects such as extinction and self-reflection of the emitted PXR beam are to be considered. The X-ray dynamical theory considers these effects. In this case, the emitted PXR linewidth δω has a minimum value defined by Darwin width ζ_{D} as described above. Therefore, the PXR spatial dispersion is similar to the spatial dispersion transfer function of a crystal monochromator with the same parameters (i.e., material, Bragg plane and angle). Thus, the crystal monochromator acts as an ideal band-pass filter for the PXR beam. This plays a significant advantage of PXR over other X-ray compact and tunable sources.

### 2.3 PXR Geometrical Factor

The PXR geometrical factor in Eq. (52) captures the emitted PXR photon self-absorption within the crystal. Similar to the attenuation of an incoming X-ray plane wave in a medium, the attenuation is exponential and defined by the attenuation coefficient μ:

$$I ( L ) = {I}_{0} exp ( - μ L ) \qquad ( 60 )$$

where I₀ is the incoming X-ray wave intensity and L is the material thickness. The absorption coefficient μ is related to the absorption cross-section as follows:

$$\frac{μ}{ρ} = \frac{{N}_{A}}{{m}_{a}} {σ}_{a} , \qquad ( 61 )$$

where p is the mass density, N_{A} is Avogadro's number, mₐ is the molar mass and σₐ is the absorption cross-section. A common approximation for the absorption cross-section in X-ray energies above 25 keV and Z<47 is given by:

$${σ}_{a} = 0.02 [ barn ] {( \frac{{k}_{0}}{k} )}^{3} {Z}^{4} , \qquad ( 62 )$$

where Z is the atomic number and k₀ is a constant value for each material. Plugging Eq. (62) into Eq. (61), gives the typical absorption length dependence L_{abs}∝ω³/Z⁴. The same phenomenon occurs for the PXR emission, i.e., the emitted PXR photon is self-absorbed in the PXR crystalline in its escape path. This effect is captured by the geometrical factor:

$${f}_{g e o} = {L}_{a b s} \vert \frac{\hat{n} \cdot \hat{Ω}}{\hat{n} \cdot \hat{v}} \vert ( 1 - {e}^{- L / ( {L}_{a b s} \vert \hat{n} \cdot \hat{Ω} \vert )} ) , \qquad ( 63 )$$

where L_{abs} is the absorption length of the material (as discussed above), h is the normal to the crystal surface through which the electron beam traverses, \hat{Ω} is the emission direction of the emitted PXR photon, D is direction of the electron beam and L is the crystal thickness.

Two competitive mechanisms govern the PXR yield as a function of the atomic number Z (Eq. (52)). On the one hand, materials with higher atomic numbers have higher scattering factor χ_{g}²∝Z² (i.e., higher diffraction yield). On the other hand, it comes at the expense of shorter absorption length which drops as L_{abs}∝1/Z⁴. Therefore, the PXR yield dependence on the atomic number is 1/Z². This is the main reason for choosing lighter materials for PXR applications. Above, the inventors discussed two ways to overcome this limitation—first by using multiple PXR crystal schemes and second by an edge PXR scheme. Table 7 presented above shows the absorption length for 30 keV photon energy.

### 2.4 PXR Scattering Factor

In the following, the PXR scattering factor and the momentum transfer dependence on the PXR yield are considered. The Fourier expansion of the electric susceptibility χ_{g} (Eq. (52)) describes the diffraction efficiency, and it is directly connected to the scattering factor of the crystal:

$${χ}_{g}^{2} = \frac{{λ}^{4} {r}_{e}^{2}}{{π}^{2} {V}_{c}^{2}} {S}_{hkl}^{2} [ {( {F}_{0} ( g ) + {f}_{1} - Z )}^{2} + {f}_{2}^{2} ] , \qquad ( 64 )$$

where λ is the emitted PXR wavelength, rₑ is the electron radius, V_{c} is the volume of the crystal unit cell, Sₕₖₗ is the structure factor, Z is the atomic number and F₀(g), f₁, f₂ are the atomic form factors. The term F₀(g) describes the momentum transfer efficiency of the beam. The term can be described analytically by the following expression:

$${F}_{0} ( s ) = {\sum }_{i = 1}^{4} {a}_{i} exp ( - {b}_{i} {s}^{2} ) + c , \qquad ( 65 )$$

$$Where$$

$$s = \frac{sin {θ}_{B}}{λ} = \frac{1}{2 {d}_{hkl}}$$

and aᵢ, bᵢ, c are the Cromer-Mann coefficients. The coefficients for several materials (Tungsten, Molybdenum, Copper, Silicon, Aluminum and Graphite) are shown in Table 8 presented below. The momentum transfer efficiency function is plotted in FIG. 15.

The dependence on

$$exp ( - {b}_{i} {s}^{2} ) ∝ exp ( - {{b}_{i} ( \frac{sin {θ}_{B}}{λ} )}^{2} )$$

implies that the yield will decrease for higher PXR energies and larger PXR emission angles Ω. In other words, for lower inter-lattice distance dₕₖₗ, the momentum efficiency reduces. This term limits the production of the PXR at high energies. The Bragg angle should be reduced to cope with this challenge. However, reducing the Bragg angle is challenging since the PXR emission will be closer to the bremsstrahlung and transition radiation emission in the forward direction as was mentioned above.

TABLE 8

| | a₁ | a₂ | a₃ | a₄ | c | b₁ | b₂ | b₃ | b₄ |
|---|---|---|---|---|---|---|---|---|---|
| Graphite | 2.310000 | 1.020000 | 1.588600 | 0.8650000 | 0.2156000 | 20.84390 | 10.20750 | 0.5687000 | 51.65120 |
| Aluminum | 6.420200 | 1.900200 | 1.593600 | 1.964600 | 1.115100 | 3.038700 | 0.7426000 | 31.54720 | 85.08860 |
| Silicon | 6.291500 | 3.035300 | 1.989100 | 1.541000 | 1.140700 | 2.438600 | 32.33370 | 0.6785000 | 81.69370 |
| Copper | 13.33800 | 7.167600 | 5.615800 | 1.673500 | 1.191000 | 3.582800 | 0.2470000 | 11.39660 | 64.81260 |
| Molybdenum | 3.702500 | 17.23560 | 12.88760 | 3.742900 | 4.387500 | 0.2772000 | 1.095800 | 11.00400 | 61.65840 |
| Tungsten | 29.08180 | 15.43000 | 14.43270 | 5.119820 | 9.887500 | 1.720290 | 9.225900 | 0.3217030 | 57.05600 |

The atomic form factors f₁, f₂ are the dispersion corrections and describe the energy dependence as a function of the X-ray energy. These corrections describe the behavior due to the bound inner-shell electrons; thus, they do not depend on the wavevector g but only on the X-ray energy. There is a direct connection between the atomic factor f₂ and the absorption-cross section:

$${σ}_{a} = 2 {r}_{e} λ {f}_{2} , \qquad ( 66 )$$

### 2.5 Electron Beam Scattering

As already mentioned above, by overcoming the self-absorption of the emitted PXR photon, the electron beam scattering becomes the dominant phenomenon. When an electron traverses through the PXR crystal, it slightly deviates from its initial trajectory due to the electrostatic forces applied by the material atoms. This scattering process can be treated as a random walk, for which the likelihood and the degree of an electron scattering is a probability function of the crystal thickness and the mean free path. In particular, the scattering angle is modeled with Gaussian probability with zero mean scattering and standard deviation given by:

$${σ}_{{θ}_{ms}} = \frac{13.6 MeV}{{E}_{e}} \sqrt{\frac{L}{{X}_{0}}} ( 1 + 0.038 ln ( \frac{L}{{X}_{0}} ) ) , \qquad ( 67 )$$

where Eₑ is the electron energy, L is the material thickness and X₀ is the radiation length. To take this factor into account on the PXR yield, the inventors use the Potylitsyn method. Using this method, the PXR spatial shape (Eq. (53)) is convolved with a Gaussian kernel which takes into account the electron scattering. The Gaussian kernel is given by:

$$G ( {θ}_{x} , {θ}_{y} ) = \frac{1}{2 {πσ}_{θ}^{2}} exp \{ - \frac{( {ϕ}_{x}^{2} + {ϕ}_{y}^{2} )}{2 {σ}_{{θ}_{ms}}^{2}} \} , \qquad ( 68 )$$

and the total spatial shape will be given by the convolution of the two terms:

$$\tilde{N} ( {θ}_{x} , {θ}_{y} ) = N * G ( {θ}_{x} , {θ}_{y} ) = \frac{1}{2 {πσ}_{{θ}_{ms}}^{2}} {{∯}^{∞}}_{- ∞} d {ϕ}_{x} d {ϕ}_{y} N ( {θ}_{x} - {ϕ}_{x} , {θ}_{y} - {ϕ}_{y} ) exp \{ - \frac{( {ϕ}_{x}^{2} + {ϕ}_{y}^{2} )}{2 {σ}_{{θ}_{ms}}^{2}} \} , \qquad ( 69 )$$

Intuitively, the number of emitted photons will increase as the interaction length is longer. However, due to the electron beam scattering and consequently the PXR angular broadening, the number of emitted photons that hit the detector within the angular aperture will be limited. In addition, the background radiation of Bremsstrahlung increases as the interaction length is longer. Therefore, the inventors define the optimal interaction length as the crystal length for which the number of emitted PXR photons that hit the detector would be ˜exp(−1) from the total number of emitted PXR photons. It is assumed that the detector's angular aperture is 4/γₑ, and the following quantities are denoted accordingly:

$${q}^{( ideal )} = {{∯}^{4 / {γ}_{e}}}_{- 4 / {γ}_{e}} d {θ}_{x} d {θ}_{y} N ( {θ}_{x} , {θ}_{y} ) , {q}^{( ms )} = {{∯}^{4 / {γ}_{e}}}_{- 4 / {γ}_{e}} d {θ}_{x} d {θ}_{y} \tilde{N} ( {θ}_{x} , {θ}_{y} ) , \qquad ( 70 )$$

where q^{(ideal)} is the total number of photons which hit the detector within the defined angular aperture when the electron's beam multiple scattering is neglected and q^{(ms)} is the same for the case the electron multiple scattering is taken into account. One should note that q^{(ms)} is a function of the crystal thickness, as Ñ(θₓ,θ_{y}) depends on σ_{θ}_{ₘₛ}, which in turn depends on L.

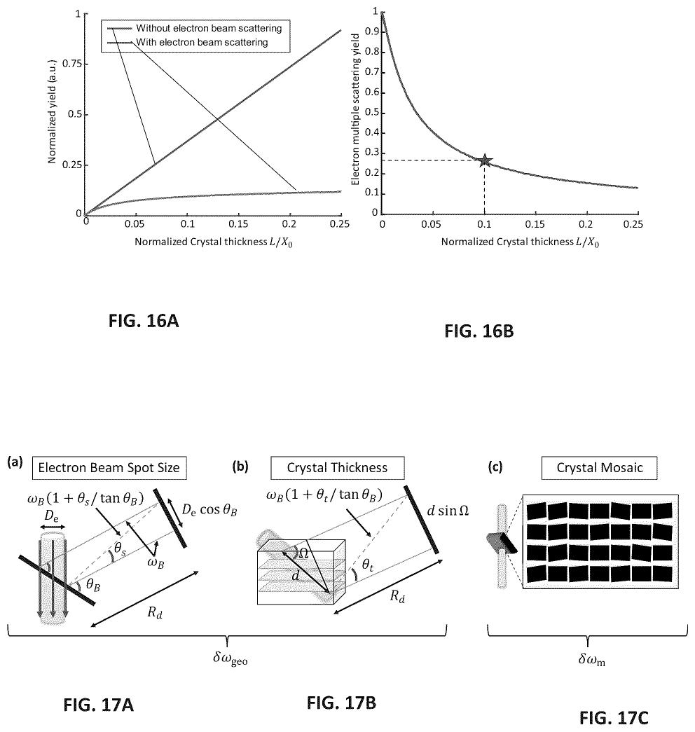

FIG. 16A compares Lq^{(ideal)} and Lq^{(ms)} for different crystal thicknesses. When the electron scattering is neglected, q^{(ideal)} is constant, and the total PXR yield increases linearly with the interaction length. On the other hand, when the electron scattering is considered, the PXR yield increases sub-linearly with the interaction length. From this observation, the inventors conclude that the brightness of the PXR source decreases as the interaction length increases. On the one hand, the intensity (and flux) increases sub-linearly as the interaction length increases. FIG. 16B shows the ratio between q^{(ideal)} and q^{(ms)}. The point which the ratio drops to ˜exp⁽⁻¹⁾ is marked. This point is received for L≈0.1X₀. This value is typically up to two orders of magnitude higher than the absorption length (see Table 7 above for comparison).

### 2.6 PXR Energy Linewidth

In the following, the physical aspects which affect the PXR energy linewidth and can cause a linewidth broadening are considered. The inventors then state the experimental conditions which minimize the emitted energy linewidth. The PXR energy width can be broadened by several physical parameters of the experimental conditions. These parameters can be divided into two categories—geometrical aspects and crystal mosaicity, which account for the degree of perfection of the lattice translation throughout the crystal. Under the category of geometrical aspects, the parameters to be considered are the electron beam spot diameter Dₑ, the crystal thickness d, the distance from the crystal to the detector R_{d}, and the detector collimation width D_{d}. An additional aspect is the electron multiple scattering in the crystal, which the inventors considered previously.

FIGS. 17A and 17B show the effect of the electron beam spot size and material thickness of the PXR energy broadening. When looking at a fixed spot on the detector's plane, several source points from the PXR crystal contribute to the spectrum at the detector's plane. The main beam has an emission angle of θ_{B}, yet the other beams have small deviation angles from θ_{B} (i.e., θₜ and θₛ). The other point sources have slightly different emission energies due to the different emission angles. This deviation is given by

$$\frac{δ {ω}_{geo}}{{ω}_{B}} = \frac{δ {θ}_{geo}}{tan {θ}_{B}}$$

(similarly to equation (58)), causing an energy linewidth broadening. In general, the geometrical effect causes angular broadening that is given by:

$$δ {θ}_{geo} = \frac{( {D}_{d} + {D}_{e} cos {θ}_{B} + d sin 2 {θ}_{B} )}{{R}_{d}} , \qquad ( 71 )$$

where the first term describes the impact of the detector's size, the second term describes the impact of the electron beam size, and the third term describes the material thickness. If the relation from equation (58) is used, then the following term which describes the energy linewidth broadening due to geometrical effects is obtained:

$$\frac{δ {ω}_{geo}}{{ω}_{B}} = \frac{δ {θ}_{geo}}{tan {θ}_{B}} = \frac{( {D}_{d} + {D}_{e} cos {θ}_{B} + d sin 2 {θ}_{B} )}{{R}_{d} tan {θ}_{B}} , \qquad ( 72 )$$

In order to minimize the energy linewidth, the inventors demand δθ_{geo}≤γₑ⁻¹. The first term D_{d}/R_{d} is optimal for ˜γₑ⁻¹, as was derived above. The other two terms are to be much smaller than γₑ⁻¹. For example, for typical experimental parameters with γₑ=100, Dₑ=1 [mm], d=10 [μm] and R_{d}=2 [m], the second and third terms are smaller than γₑ⁻¹.

In addition to the geometrical effect, crystal mosaicity is an additional factor that impacts the energy linewidth. When developing the kinematical PXR theory above, the inventors assumed a single and idealized ‘small’ perfect crystal, with all the diffracting planes in the exact registry. Real macroscopic crystals on the other hand are often imperfect and composed of small perfect blocks with a distribution of orientations around some average value. The crystal is then said to be mosaic, as it is composed of a mosaic of small blocks as shown in FIG. 17C. Typically, the mosaic blocks may have orientations distributed over an angular range of between 0.010 and 0.10. The total energy linewidth broadening is given by:

$$\frac{δ ω}{{ω}_{B}} = \frac{\sqrt{{( δ {θ}_{geo} )}^{2} + {α}^{2}}}{tan {θ}_{B}} , \qquad ( 73 )$$

Here it should be noted that Graphite, which has an excellent PXR yield, has also a high mosaicity with angular range of 0.4°, which causes to an energy linewidth broadening of a few percentages.

### 3. Characteristic Radiation Yield

In the following, the inventors estimate the number of emitted characteristic X-ray radiation photons from an X-ray tube. The characteristic X-ray emission occurs after an inner-shell ionization, followed by the atom's fluorescence. The inner-shell ionization process can occur in two ways: 1) the incident electron directly impacts an inner shell electron; and 2) Bremsstrahlung photons produced by the incident electron ionize the inner-shell electrons. The inventors estimated the number of emitted characteristic X-rays in each one of the cases and found that the inner-shell ionization cross-section by the electron impact is two orders of magnitude higher than the Bremsstrahlung ionization cross-section.

3.1 Characteristic Radiation Emission from Direct Electron Impact

The inner-shell ionization cross-section from direct electron impact was developed both as part of the classical and semi-classical models and with quantum approximation treatment using distorted-wave Born approximation. Moreover, extensive datasets were formed for the ionization of the K shell and L and M subshell of all elements from hydrogen to einsteinium (Z=1 to Z=99). Following the ionization, one of two processes can occur: fluorescence emission or an Auger effect. Therefore, the total number of emitted characteristic X-ray for the case of direct impact by single incident electron is defined by the product of the ionization cross-section and the probability for fluorescence emission, as follows:

$${N}_{chr}^{( t )} = {σ}_{K} {n}_{a} L ( {ω}_{c} ) {Y}_{f} ( Z ) , \qquad ( 74 )$$

where σ_{K} is the cross-section for inner-shell ionization by a direct electron impact for the K line, Y_{f}(Z) is the fluorescence yield, nₐ is the density of the material atoms and L(ω_{c}⁻) is the effective interaction length between the incident electron to the material. Typical values for the ionization cross-section of the K-shell σ_{K} are ˜10⁻²² cm² for a 100 keV incident electron beam (Table 9 presented below). The fluorescence yield Y_{f}(Z), which describes the probability for fluorescence emissions, can be approximated by:

$${Y}_{f} ( Z ) = \frac{{Z}^{4}}{{Z}^{4} + a} , \qquad ( 75 )$$

where a=1.12×10⁶. Experimental values for the fluorescence yield can be found in online databases. The fluorescence yield is higher for heavier materials (i.e., higher atomic number); thus, X-ray tubes usually use high atomic number materials. Table 9 shows the characteristic line emission for different materials, derived from Eq. (74). One should note that Eq. (74) captures the total number of characteristic X-ray photons emitted in all directions. However, the characteristic radiation is isotropic; thus, the inventors look at the flux within the 1 mrad² angular aperture. The number of characteristic X-ray photons collected by a detector with angular aperture B_{D} and electron source current I is given by:

$${N}_{chr} = {N}_{chr}^{( t )} {θ}_{D}^{2} \frac{I}{e} , \qquad ( 76 )$$

Table 9 shows the flux and brightness from two types of sources—based on a rotating-anode jet (molybdenum and tungsten) and a liquid-jet anode (copper and gallium). The two types of sources have different purposes—the liquid-jet anode is optimized for the X-ray source brightness, whereas the rotating anode is optimized for the X-ray source flux. The liquid-jet anode source uses a high-brightness electron source but with a relatively small current, i.e., an electron source current of 2 mA with a beam spot size of 10 um. On the other hand, the rotating-anode source is based on a high electron source current with lower brightness, i.e., an electron source current of 100 mA and beam spot size of 1 mm. Therefore, the rotating-anode source has a higher flux relative to the liquid-jet anode, yet its brightness is lower. These results fit well with the experimental data of characteristic radiation.

TABLE 9

| Material | K-edge energy (keV) | L(ω_{c}⁻) (μm) | Fluorescence yield Y_{f} (Z) | $( \frac{\begin{matrix}{σ}_{K} \\ barns\end{matrix}}{atom} )$ | $( \frac{\begin{matrix}{σ}_{c} \\ barns\end{matrix}}{atom} )$ | ${n}_{a} ( \frac{1}{{Å}^{3}} )$ | $( \frac{Characteristic line flux photons}{s m {rad}^{2} 0.1 \% BW} )$ | $( \frac{\begin{matrix}Characteristic line \\ brightness photons\end{matrix}}{s m {m}^{2} m {rad}^{2} 0.1 \% BW} )$ |
|---|---|---|---|---|---|---|---|---|
| Copper | 8.979 | 3 | 0.45 | 300 | 29578 | 0.085 | 3.4 × 10⁶ | 6 × 10¹⁰ |
| (Liquid-jet | | | | | | | | |
| anode) | | | | | | | | |
| Gallium | 10.36 | 6.6 | 0.52 | 300 | | 0.045 | 4.6 × 10⁶ | 4.6 × 10¹⁰ |
| (Liquid-jet | | | | | | | | |
| anode) | | | | | | | | |
| Molybdenum | 19.99 | 7.7 | 0.758 | 100 | 12664 | 0.064 | 1.9 × 10⁸ | 1.9 × 10⁸ |
| (Rotating- | | | | | | | | |
| anode) | | | | | | | | |
| Tungsten | 69.52 | 20.7 | 0.953 | 50 | 3205 | 0.063 | 3.1 × 10⁸ | 3.1 × 10⁸ |
| (Rotating- | | | | | | | | |
| anode) | | | | | | | | |

3.2 Characteristic Radiation Emission from Bremsstrahlung

The second mechanism for characteristic X-ray production is due to bremsstrahlung photons created by the impacting electron. This ionization mechanism consists of three steps that define its yield: bremsstrahlung photon production, an inner-shell excitation, and an X-ray fluorescence emission. First, when the incident electron goes through the anode, it is deflected due to the Coulomb interaction with the anode's material nuclei. The electron's deflection and deceleration produce bremsstrahlung radiation within the material (n_{BS}(ω)). The emitted bremsstrahlung photon has a probability of exciting an inner-shell atom in the anode material, a quantity given by the photo-ionization cross-section σₚₕ(ω). Due to the inner-shell excitation, two following processes can occur, i.e., emission of either an Auger electron or a fluorescence X-ray. The fluorescence yield Y_{f}(Z) describes the probability of an X-ray photon emission due to the inner-shell excitation. This process can be summarized as follow:

$${N}_{chr , c}^{( t )} = [ {\int }_{{ω}_{c}}^{{E}_{e}} d ω {n}_{BS} ( ω ) {σ}_{ph} ( ω ) ] {Y}_{f} ( Z ) {n}_{a} L ( {ω}_{c}^{-} ) , \qquad ( 77 )$$

where n_{BS}(ω) is the number of Bremsstrahlung photons with energy ω, σₚₕ(ω) is the photo-ionization cross-section, Y_{f}(Z) is the fluorescence yield, nₐ is the density of the material atom and L(ω_{c}⁻) is the effective interaction length of the emitted characteristic X-ray with the material. The integral limitation is between the characteristic X-ray energy (low limit) and the electron source energy (upper limit). The number of emitted Bremsstrahlung photons per energy unit is given by:

$${n}_{BS} ( ω ) = \frac{8}{π} α {r}_{e}^{2} Z ( Z + 1 ) {n}_{a} \frac{L ( ω )}{ω} ln ( 183 {Z}^{- \frac{1}{3}} ) , \qquad ( 78 )$$

where α is the fine-structure constant, rₑ is the electron radius, Z is the atomic number, nₐ is the material's atoms density and L(ω) is the effective interaction length between the incident electron to the material. The photo-ionization cross section can be approximated by equation (42), i.e.,

$${σ}_{ph} ( ω ) \approx {{σ}_{c} ( \frac{{ω}_{c}}{ω} )}^{3}$$

where ω_{c} is the characteristic X-ray energy and σ_{c} is the photo-ionization cross-section in energy ω_{c}⁺.

It should be noted that the effective interaction length L(ω_{c}⁻) depends on the characteristic photon energy below the K-edge transition. The effective interaction length is the minimal length between the absorption length, the electron stopping power, and the actual material thickness. In most experimental realizations involving an electron energy beam of ˜100 keV, the absorption length is the limiting factor for the interaction length (stopping power length of ˜20-40 μm for ˜100 keV electron beam energy versus absorption length below 10 μm). Plugging Eqs. (62) and (78) into equation (77) gives:

$${N}_{chr , c}^{( t )} \approx [ \frac{8}{π} α {r}_{e}^{2} {n}_{a}^{2} Z ( Z + 1 ) ln ( 183 {Z}^{- \frac{1}{3}} ) ] {L}^{2} \frac{1}{3} {σ}_{c} {Y}_{f} ( Z ) , \qquad ( 79 )$$

This is the total number of photons emitted from a single electron. The characteristic radiation emission is isotropic. Therefore, when looking on a detector with aperture angle of θ_{D}, the number of detected photons for an electron source beam with average current I will be:

$${N}_{chr , c} = [ \frac{8}{3 π} α {r}_{e}^{2} {n}_{a}^{2} Z ( Z + 1 ) ln ( 183 {Z}^{- \frac{1}{3}} ) ] {L}^{2} {σ}_{c} {Y}_{f} ( Z ) {θ}_{D}^{2} \frac{I}{e} , \qquad ( 80 )$$

Typically, the characteristic X-ray production due to the bremsstrahlung radiation is two orders lower than the direct impact of the incident electron, i.e., N_{chr,c}<<N_{chr}. In the following, the Inverse Compton Scattering in high gain FEL regime is described.

The electromagnetic radiation emitted by ultra-relativistic electrons in magnetic fields (i.e., synchrotron radiation) has become a standard diagnostic tool in many research fields, both basic and applied research in the chemical, materials, biotechnology, and pharmaceutical industries. High intensities at short wavelengths down to the X-ray regime allow researchers to probe the structure of a wide range of samples with a resolution down to the level of atoms and molecules. The radiation generated by bunched electron beams has a temporal duration on the scale of nanoseconds and below, allowing for observation of processes taking place on such time scales. The third-generation light sources are electron storage rings augmented with insertion devices (wiggler and undulator magnets) in which magnetic fields of alternating polarity induce intense radiation pulses.

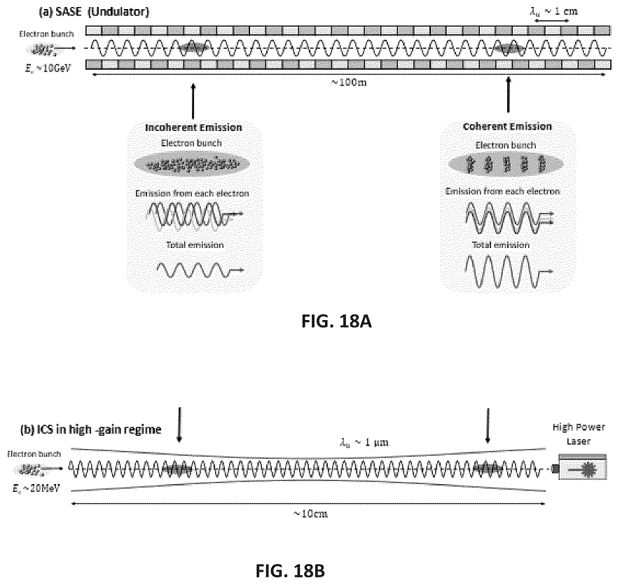

Recent engineering advances in accelerator and undulator magnet technology allowed the construction of free electron lasers (FELs) based on self-amplified spontaneous emission (SASE). These are often called fourth-generation light sources. For many experiments, the relevant figure of merit is the brilliance or spectral brightness of the radiation beam. SASE FELs achieve a peak brilliance that exceeds third-generation synchrotron radiation sources by several orders of magnitude. In FEL, the emitted radiation is further amplified as the radiation re-interacts with the electron bunch such that the electrons emit coherently, thus allowing an exponential increase in overall radiation intensity (See FIG. 18A).

The FEL mechanism can be split into two categories: the low-gain FEL and the high-gain FEL. In the low-gain FEL, the electron beam passes many times in the gain medium, where the gain in each pass is small. However, after many passes, the X-ray wave power increases exponentially. In contrast, in the high-gain regime, the electron beam passes only once in a long-gain medium, where the electrons are micro-bunched with the periodicity of the emission wavelength, generating a collective emission (originates from the electrons' coherence). This phenomenon is unique to the high-gain FEL facility and does not occur in other X-ray sources, thus generating high-brightness X-ray pulses.

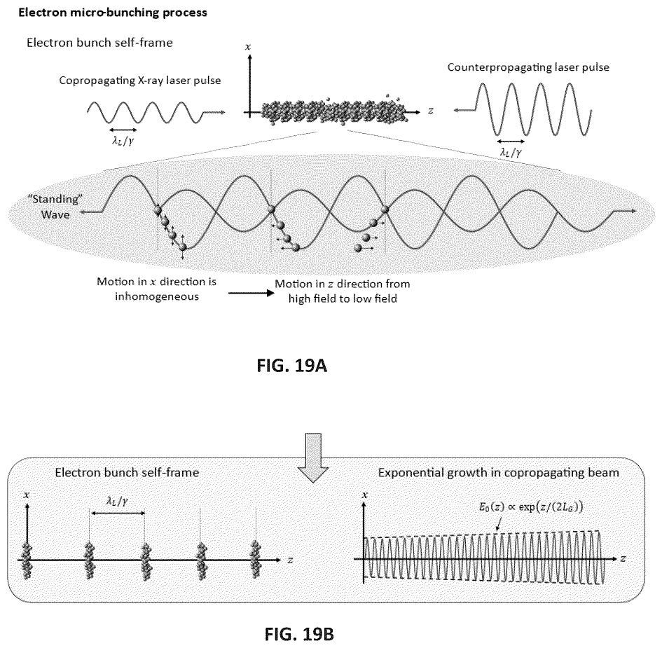

Compared with undulator radiation, the essential advantage of high-gain FEL radiation is its higher intensity due to the electrons' coherent emission. The radiation intensity grows quadratically with the number of electrons I_{N}=Nₑ²I₁. If it were possible to concentrate all electrons of a bunch into a region much smaller than the X-ray wavelength, then all the Nₑ electrons would radiate like a “point macroparticle” with charge Q=−Nₑ. However, the concentration of electrons into such a small volume is unfeasible. This obstacle is handled by electron microbunching, i.e., when the radiation becomes sufficiently strong that the transverse electric field of the radiation beam interacts with the transverse electron current created by the sinusoidal undulation motion, causing some electrons to gain and others to lose energy to the X-ray field via the ponderomotive force. The result is a modulation of the longitudinal velocity, leading to a concentration of the electrons in slices shorter than the X-ray wavelength. Electrons within a micro-bunch radiate as a single particle with a high charge. The resulting strong radiation field enhances the microbunching even further and leads to an exponential growth of the radiation power (See FIGS. 18A, 18B and FIGS. 19A, 19B for illustration).

The FEL facilities enable considerable scientific improvements, yet their size and cost limit their widespread use and accessibility. In this disclosure, the inventors aim to reduce the size of the high-gain free electron laser scheme by shrinking the FEL gain length. This reduction is possible by shrinking the undulation period from a centimeter to a micrometer period while, in parallel, increasing the external EM fields acting on the free electrons. The external EM forces can be based either on the interaction of the free electrons with the electric forces of matter (i.e., Graphene metamaterials\plasmons or periodic ferromagnets) or on the interaction with an external, short-wavelength, EM field. Due to the electric breakdown in a vacuum, which is limited by a few GV/m, it is unfeasible to supply high enough electric fields based on the free electrons' interaction with matter. Therefore, the inventors apply an external EM field based on light, i.e., an inverse Compton scattering scheme.

FIGS. 18A and 18B show the general scheme for a coherent ICS in a high-gain regime. The scheme is analogous to the high-gain FEL in (SASE) mode, where the centimeter period undulator is replaced with the micrometer optical wavelength of the counter-propagating laser. FIG. 18A shows an energetic electron beam entering the undulator and emitting an incoherent X-ray beam in the direction of the electron beam motion (“co-propagating” X-ray beam).

Due to the interaction of electrons with the X-ray wave, the electrons either gain energy from the X-ray wave (i.e., particle accelerator mode) or lose energy to the X-ray wave (see more details in FIGS. 19A and 19B). This process results in a modulation of the longitudinal velocity, which eventually leads to a concentration of electrons in slices much shorter than the X-ray wavelength. The micro-bunching process yields coherent emission of the electrons, which increases the flux quadratically in the number of electrons∝Nₑ². FIG. 18B shows the analogous phenomenon to the high-gain FEL using an inverse Compton scattering scheme. The centimeter period undulator is replaced by a micro-meter wavelength high-power laser which generates the undulation of the electron beam. Similar to the high-gain FEL, the electrons' undulation creates a co-propagating X-ray wave. This wave interacts with the electron beam, yielding a modulation of the electron beam such that the electrons are bunched into bunch lengths much shorter than the X-ray wavelength, separated by the X-ray wavelength.

The main advantages of the coherent ICS scheme are that it provides a much shorter interaction length between the electron pulse and the laser beam (tens of centimeters instead of hundreds of meters) while exploiting lower electron beam energies (tens of MeV for coherent ICS compared with >10 GeV in FEL), allowing the potential generation of bright X-ray beams in a compact facility.

The electron beam source and the counter-propagating laser beam quality have a crucial impact on the creation of the micro-bunching process. The electron beam source preferably should have high brightness, i.e., high charge, low energy spread, and low emittance. The current state-of-the-art electron source's quality is adequate for coherent ICS generation in the soft X-ray spectrum, yet it is insufficient for generating hard X-rays. Fortunately, the quantum mechanical theoretical bound of the electron source brightness permits the existence of a coherent ICS source also in this spectrum range. The inventors show below the connection between the electron source brightness and the X-ray beam energy. In addition, the laser beam preferably should have low linewidth and high intensity. As will be shown below, some of the requirements for the electron source and the laser beam are interchangeable (for example, the laser intensity and the electron source energy spread).

FIGS. 19A and 19B describe the micro-bunching process. FIG. 19A describes schematically the scheme composed of the electron beam, the counter-propagating micrometer laser pulse, and the co-propagating X-ray laser pulse. When looking at the electrons' self-frame, both the counter-propagating and the co-propagating X-ray beam have wavelengths of λ₁/2γ due to the Doppler shift. Their sum can be thought of as a combination of a “standing” wave and additional planner wave. As the sum of the waves creates an inhomogeneous electric field (i.e., the “standing” wave depends on the coordinate z over a whole period), the electrons' oscillations in the axis depend on the location of the electrons in the wavelength period. The electrons' x-axis oscillations create oscillations also in the z direction due to the magnetic field applied on the electron beam. This phenomenon is similar to the pondermotive force. This results in the electron modulating toward the regions where the electric field is minimal, generating bunches with the periodicity of the emission wavelength. FIG. 19B shows the micro-bunching process which creates bunches separated by a distance of λ₁/2γ (in the self-frame). The micro-bunching process creates exponential growth in the X-ray co-propagating electric field which scales as ∝exp (z/(2L_{g0})) where L_{g0} is the FEL length. The steps may be summarized as: 1) The counter-propagating laser beam applies forces on the electron beam in the x-axis, generating undulation motion of the electrons; 2) The electrons' oscillations generate an X-ray beam, propagating in the z direction, with a linear polarization (the electric field is in the x-axis); 3) The X-ray beam applies an additional force on the electron bunch pulse. The combination of the X-ray and the laser waves creates a “standing” wave. 4) The electron motion in the x-axis creates forces also in the z-direction (due to the magnetic field applied on the electron beam). Since the electrons' undulation oscillations strength depends on z, electrons will modulate toward the regions with lower electric fields (the ponderomotive force).

The inventors have found that the quantum-mechanical bound of the electron source brightness permits the existence of coherent ICS sources in the high-gain regime. This is described in detail below.

In particular, the inventors have shown the following novel theoretical bounds and conditions: 1) the conditions for ICS micro-bunching in a high-gain FEL regime; 2) the theoretical bound on the power and brightness of this source, with respect to the theoretical bounds on the electron sources; and 3) the interchange conditions between the laser requirements and the electron source requirements.

Moreover, the inventors have shown the experimental feasibility of coherent ICS sources in the Extreme UV (EUV) and soft X-ray spectrum using state-of-the-art electron sources and laser beams. Due to the challenging scaling to the hard X-ray spectrum, the inventors present also the low-gain ICS source (i.e., an ICS oscillator). This source has better scaling for higher X-ray energies and is better suited for a high-brightness hard X-ray source.

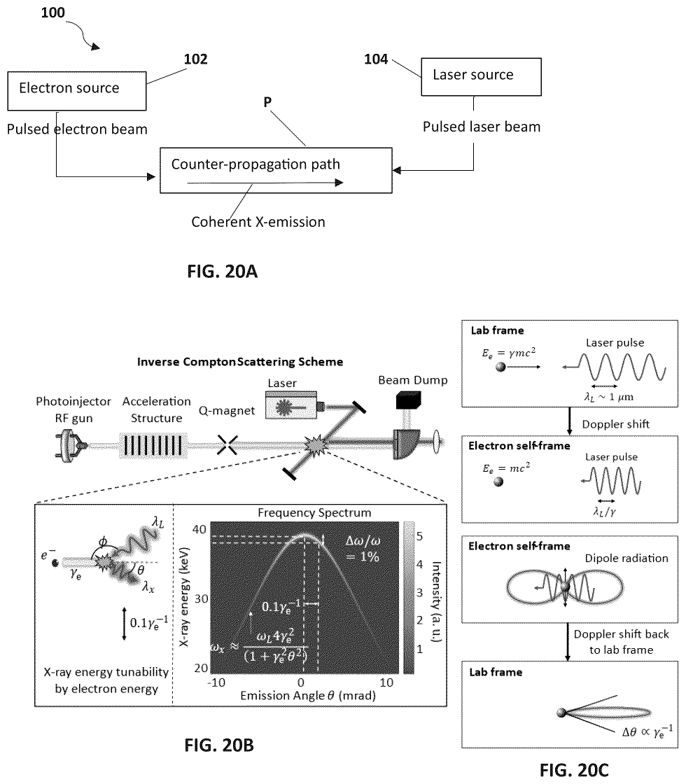

FIG. 20A schematically illustrates an X-ray generator 100 configured and operable according to the present disclosure. The X-ray generator includes an electron source 102 configured and operable to produce a pulsed electron beam propagating along a propagation path P, and a laser source 104 configured and operable to produce a pulsed laser beam propagating along the path P in a counter-propagation direction with respect to the electron beam. This results in generation of X-ray wave caused by undulation motion of the electrons. Interaction between the X-ray wave and the electron beam along an interaction length provides electron micro-bunching with periodicity of an X-ray wavelength and generation of collective coherent X-ray emission of X-rays by micro-bunched electrons. These X-rays substantially co-propagate with the electron beam.

Incoherent ICS scheme is presented in the following.

Inverse Compton Scattering is the up-conversion process of a low-energy laser photon to a high-energy X-ray photon by scattering from a relativistic electron. FIGS. 20B and 20C show the interaction scheme with a near head-on collision between the laser and electron beams. The scattered X-rays emerge in the same direction as the electrons. The physical mechanism of ICS is nearly identical to spontaneous synchrotron emission in a static magnetic undulator as used in traditional synchrotron facilities. However, due to the much shorter micro-meter laser wavelength, relative to the centimeter-period undulator wavelength, the required electron energies to produce hard X-ray photons are orders of magnitude lower than in the large synchrotrons. The up-conversion ratio for low laser intensity and on-axis emission from a head-on collision is given by [10]:

$${λ}_{x} = {λ}_{L} ( 1 + {γ}_{e}^{2} {θ}^{2} ) / 4 {γ}_{e}^{2} , \qquad ( 81 )$$

where θ is the X-ray photon emission angle relative to the electron beam direction, λ_{L} is the laser wavelength and λₓ is the emitted X-ray wavelength. The total ICS flux over all angles and frequencies is determined by the cross-section between the electron beam and the laser photons and is given by:

$${N}_{x} = \frac{{N}_{e} {N}_{L} {σ}_{T}}{2 π ( {σ}_{L}^{2} + {σ}_{e}^{2} )} , \qquad ( 82 )$$

where σ_{T} is the Thomson cross section, Nₑ is the total number of electrons, N_{L} is the total number of photons in the laser beam, and σ_{L} and σₑ are the beam spot size at the interaction point of the laser and electron beam, respectively. The up-conversion ratio (Eq. (81)) implies that all photons emitted within a narrow cone of ˜0.1γₑ⁻¹ have an energy linewidth of 1%. FIG. 20B shows the ICS parabolic spatial dispersion. Similar to the PXR emission, the ICS source flux is concentrated within a narrow emission cone.

The FEL mechanism enables much higher X-ray beam brightness due to the electron micro-bunching and their coherent emission. For micro-bunching to occur, the co-propagating X-ray beam energy linewidth should be below the so-called Pierce parameter (or the FEL parameter). In the following, the inventors review the spatial dispersion of the ICS scheme and derive the requirements for the electron beam and the laser beam for successful micro-bunching. To obtain some intuition, the spatial dispersion emission of the ICS process is examined:

$${λ}_{x} ( θ ) = \frac{{λ}_{u}}{2 {γ}_{e}^{2} ( 1 - β cos ϕ )} ( 1 + {( {γ}_{e} θ )}^{2} + \frac{{K}^{2}}{2} ) , \qquad ( 83 )$$

where λᵤ is the undulator periodicity (i.e., half of the ICS laser wavelength), γₑ is the Lorentz factor of the electron, β is the electron velocity, θ is the emission angle relative to the electron trajectory, ϕ is the angle between the electron and the laser photon (ϕ=π for heads-on collision). K is the undulator parameter, given by:

$$K = \frac{e {B}_{0} {λ}_{u}}{2 π {m}_{e} c} = \frac{e {E}_{0} {λ}_{u}}{2 π {m}_{e} {c}^{2}} , \qquad ( 84 )$$

where E₀, B₀ are the electric and magnetic fields of the laser, respectively, mₑ is the electron mass and c is the speed of light. Typical values in ICS schemes are λᵤ˜1 μm, electron beam energy of 6-40 MeV and the undulator parameter is K<0.1 (in the non-linear regime of ICS\undulator emission).

A crucial parameter for the electron micro-bunching is the X-ray emission energy spread, as specified by Eq. (83). In particular, the electron source energy spread and emittance, as well as the laser beam intensity fluctuations, determine the energy spread of the emitted X-ray. The broadening of these parameters is derived directly from Eq. (83):

$${( \frac{Δ {λ}_{x}}{{λ}_{x}} )}_{energy spread} = 2 \frac{Δ {γ}_{e}}{{γ}_{e}} , \qquad ( 85 )$$

$${( \frac{Δ {λ}_{x}}{{λ}_{x}} )}_{laser fluctuations} = \frac{{K}^{2} \frac{Δ K}{K}}{1 + \frac{{K}^{2}}{2}} , \qquad ( 86 )$$

$${( \frac{Δ {λ}_{x}}{{λ}_{x}} )}_{emittance} = {γ}_{e}^{2} {θ}^{2} = \frac{{ϵ}_{xn}^{2}}{{σ}_{x}^{2}} , \qquad ( 87 )$$

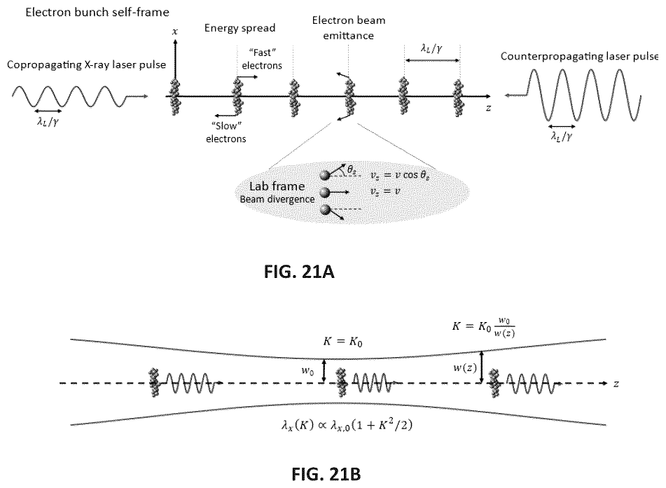

To fulfill the conditions for micro-bunching, the sum of the above three terms which describe the X-ray beam linewidth, is to be below the Pierce parameter. FIGS. 21A and 21B demonstrate these artifacts.

The first term (Eq. (85) and FIG. 21A) describes the X-ray linewidth spread due to the electron source energy spread. The energy spread in state-of-the-art undulator FEL electron sources is about 10⁻³-10⁻⁴, and an order of magnitude below for UEM electron sources (10⁻⁴-10⁻⁵) [11]. This term will be further discussed below.

As described in FIG. 21A, the electron beam energy spread causes a portion of the electron to “escape” from the modulation and the micro-bunching process, thus decreasing the emission coherence between the electrons. If the energy spread is high such that it causes the electron to move a portion of the wavelength period within the micro-bunching period, then this electron will not be modulated into a micro-bunching. Thus, the energy spread of the electron beam should be smaller than the Pierce parameter to not affect the micro-bunching process. The electron beam emittance is an additional factor that affects the energy spread of the electron beam. Due to the beam divergence, the velocity in the z direction changes, causing a similar phenomenon as the beam energy spread. Therefore, the beam divergence should also be smaller than the Pierce parameter.

The second term (Eq. (86)) describes the energy spread due to the laser beam fluctuations. The laser beam fluctuation originates from two phenomena—the first is the laser source intensity fluctuation over time, and the second is the laser electric field strength change due to the beam divergence. Usually, the first type of fluctuation is about

$$\frac{Δ K}{K} << 1 \% ,$$

whereas the second term of the laser beam broadening is defined through the Rayleigh length, which is to be longer than the interaction length to make only a small effect on the X-ray broadening. This term is discussed in detail further below. As described in FIG. 21B, the laser fluctuation causes a linewidth spread of the X-ray wave. Due to the dependence of the emitted X-ray wavelength in K∝E₀, an important design criterion is that the electric field strength is to remain constant during the micro-bunching process. The main contribution to the laser fluctuation comes from the laser beam divergence, which decreases the electric field strength acting on the electron beam. Therefore, a large laser beam spot size is desired since it would increase the laser beam Rayleigh length.

The third term is the electron beam emittance (Eq. (87) and FIG. 21A). This term is due to electron beam divergence, which increases the effective electron energy spread. This term is usually the most limiting factor, and low emittance electron sources are necessary to fulfill this condition.

Before detailing the exact FEL parameters and requirements, the inventors summarize here the main preferred conditions of the electron source and the laser for an effective micro-bunching.

The counter-propagating laser beam preferably satisfies at least some of the following conditions:
The electric field strength is in the range of a few ˜hundreds of GV/m.

This requirement is necessary since the undulator parameter (K) has to be large enough for effective interaction with the electron beam.
The laser pulse length is as long as a few tens (˜20) FEL gain length periods for the electron micro-bunching. Typically, it is a few hundred picoseconds.
The laser linewidth is smaller than the Pierce parameter. Similarly, the coherence length is longer than the interaction length. This requirement suggests that the laser has a lower linewidth than the X-ray beam linewidth. The assumption is that the laser system is optimized for the transform-limited pulse duration. Therefore, to accomplish the laser linewidth requirements, the laser pulse duration is long enough (the linewidth is inversely proportional to the pulse length).
The laser spot size is much larger than the electron beam spot size for a uniform electric field strength acting on the electrons in the transverse plane. Typically, the beam spot size should be a few ˜hundred micrometers.
The laser Rayleigh length is larger than the FEL gain length. This is necessary since the laser intensity is to be constant along all the interaction point.
The laser intensity fluctuations after stabilization are to be low (smaller than 0.5%) since the emission wavelength depends on the laser intensity. Therefore, to fulfill the condition for the X-ray laser linewidth (Pierce parameter), the laser fluctuations are to be small enough.
The laser beam divergence is smaller than the electron beam divergence.

Typical parameters that are required for the electron source include:
Electron energy spread is smaller than the Pierce parameter. Typical values of ≤10⁻⁵ (Eq. (85))
Normalized beam emittance impacts both the electron energy spread and limits the minimal X-ray wavelength in the coherent regime. Typical values of <2 nm-rad (Eq. (87)) are preferred.
Beam spot size is a few μm (1-2 μm) in the interaction point to increase the cross-section and the electron beam charge density.
Electron pulse density is at least

$$\sim {10}^{21} - 1 {0}^{22} \frac{1}{{m}^{3}}$$

for effective generation of the X-ray wave and thus for the micro-bunching.
   The exact conditions for the electron source will be discussed in the following sections.

In the following, the high-gain regime requirements are discussed. Specifically, the FEL parameters and the FEL requirements for electron micro-bunching are reviewed. It can be shown that the FEL equations are similar between a magnetic undulator and a coherent ICS scheme. Therefore, the FEL parameters are adopted and the conditions that need to be satisfied are used also for the coherent ICS scheme. In addition to the FEL requirements, additional ones for the coherent ICS will be discussed further below.

The main difference in the requirements between the undulator FEL and the coherent ICS is due to the much shorter undulation period (centimeter versus micrometer), the lower electron beam energy (tens MeV versus >10 GeV), and the lower electron beam emittance, which together put strict requirements for the micro-bunching process. In addition, the conditions on the laser beam are challenging. In the present discussion, however, these conditions are not analyzed, as it is assumed that the laser beam is “ideal”. In other words, the laser beam is uniform along all the interaction length, it has high enough power, negligible divergence and linewidth, and its spot size is much larger than the electron beam spot size.

As described above, the electron micro-bunching process involves the electron beam, the counter-propagating laser beam, and the co-propagating X-ray beam. The process involves first the creation of the X-ray wave due to the undulation motion of the electrons. Then, the interaction between the generated X-ray wave with the electron beam modulates the electron velocities due to the ponderomotive force, resulting in an electron micro-bunching with the periodicity of the X-ray wavelength (FIGS. 19A and 19B). For describing the micro-bunching process, one needs to consider the motion of each electron using the relativistic Newtonian equations of motion, together with the Maxwell equations for the X-ray beam generation and amplification. These equations are similar to those of the high-gain FEL, yet the main differences are due to the counter-propagating laser instead of the undulator and the different energy scales (tens GeV in FEL versus tens MeV in ICS). The inventors use the derivation of the high-gain FEL and specify the differences relative to the ICS. First, the problem variables are denoted as specified in Table 10.

TABLE 10

| # | Parameter | Description |
|---|---|---|
| 1 | Nₑ | The number of electrons in the pulse |
| 2 | rᵢ, pᵢ | The position and momentum of the |
| | | i-th electron (1 ≤ i ≤ Nₑ) |
| 3 | E^{(L)}, B^{(L)} | The electric and magnetic fields of the |
| | | counter-propagating beam (the ICS laser beam). |
| 4 | E^{(X)}, B^{(X)} | The electric and magnetic fields of the co- |
| | | propagating beam (the X-ray beam). |
| 5 | ρ(r) | The total charge density of the electron beam. |
| 6 | j(r, t) | The total current density of the electron beam. |

For each electron 1≤i≤Nₑ, the equations of motion are governed by the Lorentz force applied by the counter-propagating laser wave and the co-propagating X-ray wave:

$$\begin{matrix}\frac{{dp}_{i}}{dt} = \frac{d ( {γ}_{i} {mv}_{i} )}{dt} \\ = e [ ( {E}^{( L )} ( ρ , z , t ) + {v}_{i} \times {B}^{( L )} ( ρ , z , t ) ) \\ + ( {E}^{( X )} ( ρ , z , t ) + {v}_{i} \times {B}^{( X )} ( ρ , z , t ) ) ]\end{matrix} \qquad ( 88 )$$

where E^{(L)}(ρ,z,t), B^{(L)}(ρ,z,t) represent the co-propagating laser's EM field, and E^{(x)}(ρ,z,t), B^{(X)}(ρ,z,t) represent the copropagating X-ray beam. One should note that the laser's EM field is determined by the external laser beam, while the X-ray wave is generated during the process and is being dynamically changed with the propagation in the z axis. The equations of motions are accompanied by the Maxwell equations that describe the generation and amplification of the X-ray beam:

$$∇ \cdot {E}^{( X )} = \frac{ρ}{{ϵ}_{0}} \qquad ( 89 )$$

$$∇ \cdot {B}^{( X )} = 0$$

$$∇ \times {E}^{( X )} = - \frac{\partial {B}^{( X )}}{\partial t}$$

$$∇ \times {B}^{( X )} = {μ}_{0} ( j + {ϵ}_{0} \frac{\partial {E}^{( X )}}{\partial t} )$$

where in the case at hand, the density charge and current density are set by the electron bunch charge:

$$ρ ( r ) = {\sum }_{i} {q}_{i} δ ( r - {r}_{i} ) \qquad ( 90 )$$

$$j ( r , t ) = {\sum }_{i} {q}_{i} {v}_{i} ( t ) δ ( r - {r}_{i} )$$

The authors briefly describe the physical process: First, the external laser field (E^{(L)},B^{(L)}) generates forces on the electron, resulting in an undulation motion in the x-axis (pₓ) and a weaker harmonic motion in the z-axis (p_{z}) (Eq. (88)). The undulation motion creates changes in the current density jₓ, generating a radiation field (the X-ray wave (E^{(X)},B^{(X)})) with a wavelength equal to the undulation periodicity (Eq. (89d)). The generated X-ray wave creates forces on the electrons (Eq. (88), the last term). These forces modulate the electron charge density (ρ(r)) in the z-axis, such that they create an effective electric field in the z-axis E_{z} (Eq. (89a)). Therefore, the X-ray wave interaction with the electron beam creates micro-bunching, while the repulsion between the electrons opposes the process. If the X-ray wave force on the electrons is larger than the repulsion between the electrons, then micro-bunching will occur.

Eqs. (88)-(90) set a partial differential equation with 6N equations of motion for each electron. In the general case, this set of equations is not analytically solvable, and numerical tools are used to solve it. However, under the assumption of the 1D theory and the slowly varying amplitude approximation (SVA), these equations set coupled first-order differential equations. These equations can be further simplified by the assumption that the periodic density modulation remains small and derive a third-order differential equation containing only the electric field amplitude. This equation is analytically solvable and shows that the electric field increases exponentially with the FEL gain length.

In the following, the FEL parameters are detailed.

Pierce parameter: (or FEL parameter) is the most crucial parameter in the FEL mechanism. It defines the X-ray beam emission linewidth, the maximal output beam power, and the condition on the energy spread of the electron source. It is given by:

$${ρ}_{FEL} = \frac{1}{2} {( \frac{π {K}^{2} {r}_{e} {n}_{e}}{{k}_{u}^{2} {γ}_{e}^{3}} )}^{\frac{1}{3}} , \qquad ( 91 )$$

where K is the undulator parameter, rₑ is the electron radius, nₑ is the electron pulse density,

$${k}_{u} = \frac{2 π}{{λ}_{u}}$$

and γₑ is the electron energy. The electron pulse density is given by:

$${n}_{e} = \frac{{Q}_{e}}{e {τ}_{p} c π {r}_{b}^{2}} , \qquad ( 92 )$$

where Qₑ is the pulse charge, τₚ is the pulse duration, c is the speed of light, e is the electric charge, and r_{b} is the electron beam radius.

The Pierce parameter is typically in the range of ˜10⁻³-10⁻⁴ in FEL facilities (smaller values correspond to hard X-ray while larger values correspond to soft X-ray). For the coherent ICS case, the Pierce parameter is about an ˜order of magnitude smaller than an FEL undulator; therefore, the electron source is to be of an order of magnitude lower energy spread (including the energy spread due to the emittance). FIG. 22A shows the impact of the electron charge density on the Pierce parameter. The Pierce parameter increases for denser electron charges and shorter X-ray wavelengths. A higher Pierce parameter implies less strict requirements on the electron energy spread and emittance, yet at the expense of higher X-ray beam linewidth. In the coherent ICS case, the requirements on the electron source are strict; therefore, higher values of the Pierce parameter will ease the requirements. Another dependence of the Pierce parameter is on the electric field strength K^{2/3}∝E₀^{2/3}, i.e., larger values of the laser electric fields will increase the Pierce parameter. However, increasing the electric field (and consequently the laser power) will come at the expense of the laser fluctuations. This trade-off is discussed in the following.

Additional parameters which are related to the Pierce parameter are the FEL gain parameter Γ and the power gain length L_{g0}:

$$Γ = \frac{4 π {ρ}_{FEL}}{{λ}_{u}} , \qquad ( 93 )$$

$${L}_{g 0} = \frac{1}{\sqrt{3} Γ} = \frac{{λ}_{u}}{4 π \sqrt{3} {ρ}_{FEL}} , \qquad ( 94 )$$

These parameters define the typical length scale of the exponential increase in power of the emitted X-ray beam. FIGS. 22A and 22B compare the power gain length and the Pierce parameter between the FEL scheme to the coherent ICS scheme as a function of the emitted X-ray wavelength. Graphs are shown for the next configuration: 1) FEL—undulator period: 3 cm, magnetic field: 1.25 T, electron charge density:

$$7 \times 1 {0}^{21} \frac{1}{{m}^{3}} ;$$

and 2) Coherent ICS—laser wavelength: 1 μm, electric field 200 GV/m, electron charge density:

$$7 \times 1 {0}^{21} \frac{1}{{m}^{3}} .$$

FIG. 22A shows the power gain length L_{g0} as a function of the X-ray wavelength. The typical power gain length of coherent ICS is more than three orders of magnitude lower than those of FEL, which enables shrinking the total interaction length from ˜100 m to ˜tens centimeters. FIG. 22B shows the Pierce parameter as a function of the X-ray wavelength for FEL and coherent ICS schemes. The Pierce parameter is an order of magnitude lower for the coherent ICS scheme relative to the FEL scheme. This implies that the requirements on the electron energy spread, and the electron beam emittance are stricter for the coherent ICS scheme than those for FEL. On the other hand, the power gain length of the ICS scheme is more than three orders lower than the power gain length of the FEL scheme, which shows the promising prospects of shrinking the ˜100 m undulator to ˜tens centimeters length ICS scheme.

The electron repulsive force opposes the bunching ponderomotive force. Therefore, a design criterion is for the FEL gain parameter to be larger than the repulsive forces. The space charge length accounts for the repulsion between the electrons in a bunch and is given by:

$${k}_{p} = \sqrt{\frac{2 {k}_{u} {μ}_{0} {n}_{e} {e}^{2} c}{γ {m}_{e} {ω}_{x}}} \qquad ( 95 )$$

Thus, an important design criterion is that the FEL gain parameter is larger than the space charge length, i.e., kₚ<<Γ.

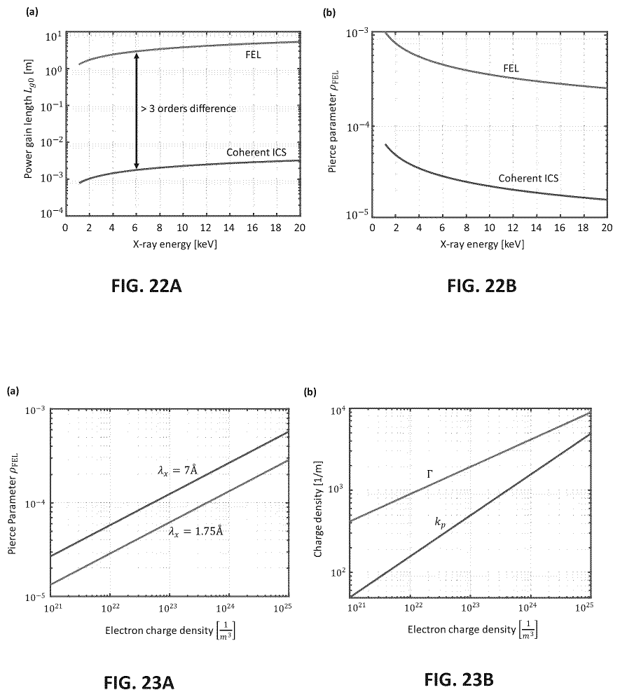

Reference is made to FIGS. 23A and 23B showing the Pierce parameter and the space charge dependence on the electron charge density. FIG. 23A shows the Pierce parameter as a function of the electron charge density for X-ray wavelengths of 7 Å and 1.75 Å; and FIG. 23B shows the space charge density (kₚ) and the gain length (Γ) as a function of the electron charge density. The figures compare the gain parameter and the space charge as a function of the electron charge density. The space charge parameter (kₚ) scales more rapidly than the FEL gain parameter (Γ) as a function of the electron charge density due to the kₚ∝\sqrt{nₑ} and Γ∝nₑ^{1/3} dependence. Therefore, for large electron charge densities (or shorter X-ray wavelengths), the space charge parameter becomes more crucial for the micro-bunching process. This can be overcome partially by using higher electric fields (i.e., higher laser powers), due to the Γ∝K^{2/3} dependence. Moreover, this parameter is less critical for electron micro-bunching compared with the electron beam energy spread.

In the following, the requirements for the full process of electron micro-bunching and coherent X-ray emission are analyzed. The requirements include the electron beam emittance, the electron beam energy spread, the interaction length, the X-ray diffraction condition quantum recoil, and electron pulse density and space charge. The laser system requirements are discussed further below.

The electron beam emittance is the most important and most demanding parameter that influences the FEL mechanism. This is due to several reasons. First, it is responsible for the effective energy spread of the electron beam (FIG. 21A). Second, it sets a lower limit to the X-ray wavelength in a fully coherent scheme as discussed below.

In more details:
X-ray energy spread due to electron beam divergence—as described in Eq. (87) and FIG. 19A, the emitted X-ray energy spread is determined by the electron source divergence. To maintain the conditions for FEL, it is required that:

$${γ}_{e}^{2} {σ}_{{x}^{′}}^{2} = {γ}_{e}^{2} {θ}^{2} < \frac{1}{2} {ρ}_{FEL} , \qquad ( 96 )$$

This requirement on the electron beam divergence also limits the electron beam size:

$${σ}_{x}^{2} = \frac{{ϵ}_{n}^{2}}{{( {γ}_{e} θ )}^{2}} > \frac{2 {ϵ}_{n}^{2}}{{ρ}_{FEL}} , \qquad ( 97 )$$

X-ray beam Rayleigh length—The X-ray beam emittance is mainly determined by the electron source emittance. In particular, the electron beam spot size is equal to the X-ray beam spot size. Thus, the emitted X-ray Rayleigh length is determined by the electron source size and the X-ray wavelength

$$( {Z}_{R} = \frac{4 π {σ}_{x}^{2}}{{λ}_{x}} ) .$$

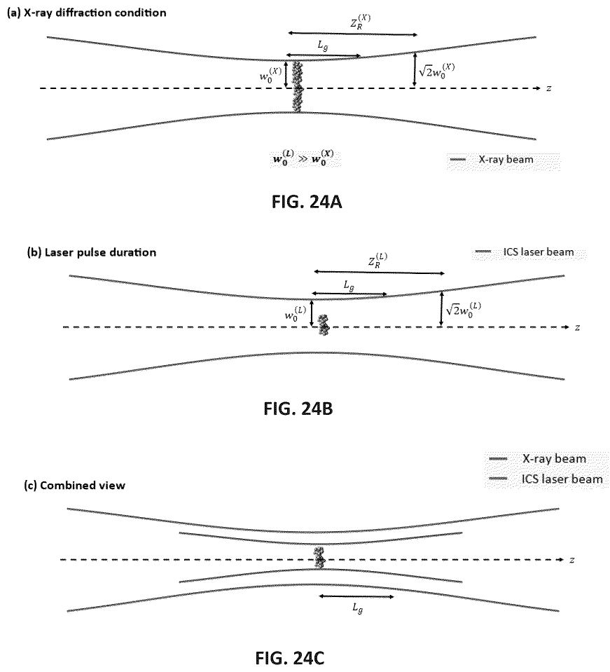

The Rayleigh length should be larger or equal to the FEL gain length, therefore larger beam spot size is preferable. In other words,

$${σ}_{x}^{2} = \frac{{Z}_{R} {λ}_{x}}{4 π} \geq \frac{2 {L}_{g} {λ}_{x}}{4 π} . \\ {σ}_{x}^{2} > \frac{{λ}_{u} {λ}_{x}}{8 {π}^{2} \sqrt{3} {ρ}_{FEL}} \approx \frac{{λ}_{x}^{2} ( 4 {γ}_{e}^{2} )}{8 {π}^{2} \sqrt{3} {ρ}_{FEL}} = \frac{{λ}_{x}^{2} {γ}_{e}^{2}}{2 {π}^{2} \sqrt{3} {ρ}_{FEL}} , \qquad ( 98 )$$

where in the last step we have assumed that K<<1 (Eq. (85)). However, a large beam spot size limits the possible electron pulse density, which in turn decreases the effectiveness of the micro-bunching process (longer interaction would be necessary). FIGS. 24A to 24C show the requirement on the X-ray Rayleigh length.
Electron pulse density—to maintain a quasi-constant electron pulse density during the interaction period, we should demand that the beam divergence multiplied by the FEL gain length will be lower than the beam spot size:

$${σ}_{{x}^{{}_{′}}} {L}_{g} < {σ}_{x} \qquad ( 99 )$$

Arranging this term, gives an additional limit on the minimal beam spot size:

$${σ}_{x}^{2} > \frac{{λ}_{u} {ϵ}_{n}}{4 π \sqrt{3} {ρ}_{FEL} {γ}_{e}} , \qquad ( 100 )$$

Combining conditions Eq. (97) and Eq. (99), gives a requirement on the electron beam emittance, which should be smaller than the radiation wavelength:

$$ϵ = \frac{{ϵ}_{n}}{β {γ}_{e}} = {σ}_{x} {σ}_{{x}^{{}_{′}}} < \sqrt{\frac{{λ}_{x}^{2} {γ}_{e}^{2}}{2 {π}^{2} \sqrt{3} {ρ}_{FEL}} \frac{{ρ}_{FEL}}{2 {γ}_{e}^{2}}} = \frac{{λ}_{x}}{{3}^{1 / 4} 2 π} , \qquad ( 101 )$$

where ϵ is the electron beam emittance, en is the normalized electron beam emittance and λₓ is the X-ray emission wavelength. This shows why higher electron energies (i.e., higher γₑ) are advantageous—as the normalized electron beam emittance is usually constant, higher electron energies have lower emittance, thus allowing lower X-ray wavelengths. To cope with this limitation, a lower emittance electron source is needed to achieve hard X-ray beam. The quantum mechanical theoretical limit of the electron beam emittance permits this scheme to achieve hard X-ray spectrum as will be described further below.

To conclude, the electron beam spot size minimal value is given by:

$${σ}_{x}^{2} \geq max ( \frac{{λ}_{u} {ϵ}_{n}}{4 π \sqrt{3} {ρ}_{FEL} {γ}_{e}} , \frac{{λ}_{u}^{2}}{32 \sqrt{3} {π}^{2} {γ}_{e}^{2} {ρ}_{FEL}} , \frac{2 {ϵ}_{n}^{2}}{{ρ}_{FEL}} ) , \qquad ( 102 )$$

where the left term is due to electron beam emittance and the right term is due to the X-ray diffraction condition. As an example, let us take an electron source with 2 nm-rad emittance (with a relatively low current), electron energy of 10 MeV, a high-power laser with wavelength of λᵤ=1064 nm, and Pierce parameter of ρ_{FEL}=5×10⁻⁵. The minimal electron spot size in the interaction point is σₓ²≈0.4-0.5 um. One should note that the electron beam spot size in ICS is usually much smaller than in the undulator FEL. Undulator FEL facilities use beam spot size of 100 um, while in ICS experiments the beam spot size is two orders below. This permits high electron charge density for the ICS, even with relatively low electron source currents.

In addition to the condition on the electron source emittance in Eq. (102) for the micro-bunching to occur, an additional requirement is needed for fully coherent X-ray beam. The diffraction limit of a Gaussian beam with a wavelength λₓ is given by λₓ/4π, therefore, to achieve a fully coherent beam, the electron beam emittance should be below this value:

$$ϵ = \frac{{ϵ}_{n}}{β {γ}_{e}} = {σ}_{x} {σ}_{{x}^{{}_{′}}} < \frac{{λ}_{x}}{4 π} , \qquad ( 103 )$$

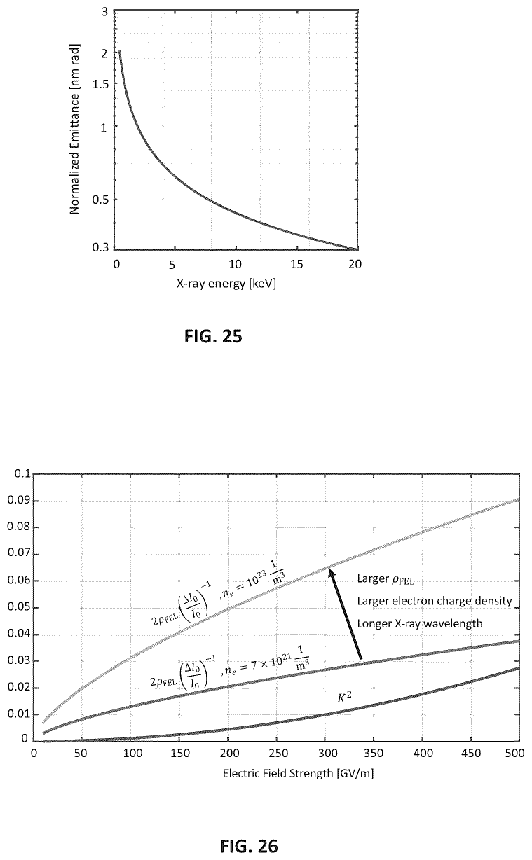

This condition is preferred for a fully coherent beam but is stricter than the condition in Eq. (102) for the micro-bunching process to occur. FIG. 25 shows the dependence between the X-ray wavelength to the required normalized emittance for a fully coherent ICS scheme, as specified by Eq. (103). One should note that dependence on the electron energy in Eq. (103). Due to the λₓ∝γₑ⁻² dependence, the normalized emittance is to be lower for higher X-ray energies

$$( {ϵ}_{n} ∝ {λ}_{x} {γ}_{e} ∝ \frac{{λ}_{u}}{{γ}_{e}} ) .$$

These requirements are very demanding and cannot be met with current electron source technology for the hard X-ray spectrum. However, they can be met for the soft X-ray spectrum (<2 keV). Moreover, the quantum mechanical theoretical limitation for electron brightness also permits a coherent ICS scheme for the hard X-ray spectrum. One should note that these requirements are for a fully coherent emission. The electron micro-bunching process will occur also for the case where the normalized emittance is higher than specified, yet with lower efficiency and X-ray beam brightness.

The electron beam energy spread, including the effective term is to be smaller than Pierce parameter:

$$\frac{{σ}_{E}}{{E}_{e}} < \frac{1}{2} {ρ}_{FEL} , \qquad ( 104 )$$

where σ_{E} is the energy spread which accounts all the terms in Eqs. (85)-(87), ρ_{FEL} is the Pierce parameter. Typically, the Pierce parameter is 10⁻³-10⁻⁴ for the FEL case, but 10⁻⁴-10⁻⁵ for the ICS case, therefore the electron beam energy spread should be an order of magnitude lower than in FEL facilities.

Undulator length is larger than the gain length:

$${N}_{u} {λ}_{u} > {L}_{G} , \qquad ( 105 )$$

where Nu is the number of laser periods and L_{G} is the FEL gain length. This requirement suggests that the laser pulse duration is to be long enough (˜tens of picosecond for soft X-ray to hundreds of picoseconds for hard X-ray).

X-ray diffraction condition states that the gain length must be shorter than the radiation Rayleigh range (radiation of the X-ray beam):

$${L}_{G} / {z}_{R}^{( X )} < 1 / 2 , \qquad ( 106 )$$

where z_{R}^{(X)} is the Rayleigh length of the X-ray beam, given by

$${z}_{R}^{( X )} = \frac{π {w}_{0}^{2}}{{λ}_{x}} .$$

This requirement suggests that the X-ray beam will not broaden too much within a period of FEL gain length. This requirement sets an additional limit on the electron beam spot size:

$${σ}_{x}^{2} > \frac{{λ}_{u}^{2}}{16 \sqrt{3} {π}^{2} {γ}_{e}^{2} {ρ}_{FEL}} , \qquad ( 107 )$$

The quantum recoil parameter satisfies:

$$q = \frac{ℏ {ω}_{x}}{{ρ}_{FEL} {γ}_{e} m {c}^{2}} << 1 , \qquad ( 108 )$$

The inventors neglect the quantum recoil, as the schemes in this disclosure are with typical values of q≤1. Usually, the quantum recoil effect requires slightly higher beam powers.

In the following, electron pulse density and space charge requirements are detailed.

Higher electron pulse density is preferable because of the dependence: L_{g}∝nₑ^{-1/3} of the FEL length. However, the electron pulse density is limited by several factors: the conditions on the minimal electron beam size (Eq. (97)) and due to the repulsive force of the bunched electron pulse. In particular, the space charge density is to be smaller than the FEL gain length:

$${k}_{p} ≪ Γ , \qquad ( 109 )$$

This requirement suggests that the electron repulsion forces will be small compared with the bunching ponderomotive force. Rearranging this term, gives a limit on the electron pulse density:

$${n}_{e} ≪ \frac{{m}_{e} {k}_{u}^{2} {γ}_{e}^{3}}{2 {μ}_{0} {e}^{2}} {K}^{4} \qquad ( 110 )$$

Typically for an ICS source, the RHS of Eq. (105) is

$$∼ {10}^{25} [ \frac{1}{{m}^{3}} ] .$$

This limit is several orders of magnitude higher than the possible electron density due to the limited electron beam spot size. In addition, there is also a quantum-mechanical restriction on the maximal electron pulse current density, given by nₑ≤ρ_{FEL}²λ_{c}⁻³ that will be described further below. Overall, the maximal electron pulse current density is given by:

$${n}_{e} \leq min ( \frac{{m}_{e} {k}_{u}^{2} {γ}_{e}^{3}}{2 {μ}_{0} {e}^{2}} {K}^{4} , \frac{{N}_{e}}{e c {τ}_{p} min ( {σ}_{x}^{2} )} , {ρ}_{FEL}^{2} {λ}_{c}^{- 3} ) \qquad ( 111 )$$

where the first term comes from the requirement on the repulsive force, the second requirement on the minimal beam spot size and the third on the quantum mechanical limitation on the electron beam brightness.

In the above description, the conditions for electron micro-bunching to occur was considered under the assumption that the laser system satisfies the conditions for the micro-bunching (i.e., strong electric field, large beam spot size, long Rayleigh length, and negligible fluctuations). In the following, the requirements for the laser beam are analyzed to satisfy the micro-bunching process. The ideal laser beam is to be of a constant electric field (amplitude+phase), with no dependence on the transverse dimensions or the longitudinal dimension, all over the interaction length, to avoid broadening of the X-ray linewidth. This requirement is desired since the electrons' undulation motion and the X-ray linewidth depend on the electric field applied on the electron beam (Eq. (86).

Thus, to preserve coherence of the X-ray emission during the interaction, constant electric field is needed, resulting in the following requirements on the laser system: 1) a large electric field E₀ for an effective interaction with the electron beam; 2) laser beam spot size, w₀^{(L)}, much larger than the electron beam spot size in order for the electron beam to feel the same electric field in the transversal dimension; 3) Rayleigh length, z_{R}^{(L)}, larger than the FEL gain parameter and low laser fluctuations in order that the electrons would feel the same electric field in the longitudinal dimension; 4) laser pulse duration, τₚ^{(L)}, of a few ˜100 ps in order to have long enough interaction length and that the laser linewidth will be smaller than the Pierce parameter. Of course, under the power and energy constraints of the laser pulse, the above requirements compete, and there is a trade-off between them which is analyzed in the following.

Table 11 presented below summarizes the parameters used throughout the description. For simplicity, the L symbol (which describes the laser beam and not the X-ray beam) is removed in the following description. Throughout the description, the inventors assume that the laser is in a single-mode configuration, thus its electric field is given by:

$$E ( ρ , z ) = {E}_{0} \hat{x} \frac{{w}_{0}}{w ( z )} exp ( - \frac{{ρ}^{2}}{{w}^{2} ( z )} ) exp ( - i ( kz + \frac{k {ρ}^{2}}{2 R ( z )} - ψ ( z ) ) ) \qquad ( 112 )$$

where ρ is the radial distance from the center axis of the beam, z is the axial distance from the beam's waist, w₀ is the beam waist, w(z) is the radius at which the amplitude falls to 1/e of the axial value, R(z) is the radius of curvature of the beam's wavefront at z, and ψ(z) is the Gouy phase, an extra phase term beyond the attributable to the phase velocity of light. They are given by:

$$w ( z ) = {w}_{0} \sqrt{1 + {( \frac{z}{{z}_{R}} )}^{2}} R ( z ) = z [ 1 + {( \frac{{z}_{R}}{z} )}^{2} ] ψ ( z ) = arctan ( \frac{z}{{z}_{R}} ) \qquad ( 113 )$$

TABLE 11

| | Param- | |
|---|---|---|
| # | eter | Description |
| 1 | w₀ | Beam waist. It is to be much larger than the electron beam |
| | | spot size. |
| 2 | z_{R} | Rayleigh length. It is to be much longer than the FEL gain |
| | | length for constant electric field in the longitude dimension. |
| 3 | τₚ | The laser pulse duration. It is to be long enough for the |
| | | interaction length and also for low laser linewidth: |
| | | $\frac{{λ}_{u}}{c {τ}_{p}} ≪ {ρ}_{FEL}$ |
| 4 | w(z) | The radius at which the amplitude falls to 1/e of the axial |
| | | value |
| 5 | R(z) | Radius of curvature of the beam's wavefront at z |
| 6 | ψ(z) | Gouy phase |

In the following, each one of the requirements is analyzed in detail, i.e., the laser phase, intensity, duration, beam spot size and the Rayleigh length.

First, the inventors treat the electric field phase term. It is desired that the phase will be constant during the interaction, i.e., it is to be as close to kz as possible with no dependence on the transversal distance from the z axis (i.e., no dependence on ρ). Under the approximation of long Rayleigh length compared with the interaction length (L_{g}<<z_{R}) and large laser beam waist compared with the electron beam size (r_{b}<<w₀), the above quantities can be approximated as follows:

$$w ( z ) \approx {w}_{0} [ 1 + \frac{1}{2} {( \frac{z}{{z}_{R}} )}^{2} ] R ( z ) \approx \frac{{z}_{R}^{2}}{z} ψ ( z ) \approx \frac{z}{{z}_{R}} \qquad ( 114 )$$

Substituting Eq. (109) into Eq. (107), the following phase term is obtained:

$$k z + \frac{k {ρ}^{2}}{2 R ( z )} - ψ ( z ) \approx k z + \frac{k {ρ}^{2}}{2 {z}_{R}^{2}} z - \frac{z}{{z}_{R}} = kz ( 1 + \frac{{ρ}^{2}}{2 {z}_{R}^{2}} - \frac{1}{k {z}_{R}} ) \qquad ( 115 )$$

Here, the inventors consider additional requirements of

$$\frac{{r}_{b}^{2}}{2 {z}_{R}^{2}} ≪ {ρ}_{FEL} and \frac{1}{k {z}_{R}} ≪ {ρ}_{FEL}$$

(For example, typical values of z_{R}˜20 cm, r_{b}˜few μm, kᵤ˜5×10⁶ satisfy these conditions).

The phase term can be simplified to kz:

$$kz ( 1 + \frac{{ρ}^{2}}{2 {z}_{R}^{2}} - \frac{1}{k {z}_{R}} ) \approx kz \qquad ( 116 )$$

And the electric field is simplified to:

$$E ( ρ , z ) \approx \hat{x} {E}_{0} \hat{x} \frac{{w}_{0}}{w ( z )} exp ( - \frac{{ρ}^{2}}{{w}^{2} ( z )} ) exp ( - i k z ) \qquad ( 117 )$$

In the following, the laser beam intensity fluctuation is analyzed.

From Eq. (86), the X-ray linewidth is determined (among other parameters) from the laser fluctuation. For the case of the linear ICS regime (K<<1), the equation can be simplified to:

$${( \frac{{Δλ}_{x}}{{λ}_{x}} )}_{laser fluctuations} \approx {K}^{2} \frac{Δ K}{K} = {K}^{2} \frac{Δ {E}_{0}}{{E}_{0}} \qquad ( 118 )$$

This term is to be much smaller than the Pierce parameter. Eq. (118) can be rearranged in terms of the laser intensity as follows:

$${K}^{2} \frac{Δ {E}_{0}}{{E}_{0}} = \frac{1}{2} {K}^{2} \frac{Δ {I}_{0}}{{I}_{0}}$$

Therefore, the requirement

$${K}^{2} ≪ 2 {{ρ}_{FEL} ( \frac{Δ {I}_{0}}{{I}_{0}} )}^{- 1} \qquad ( 119 )$$

where I₀ is the laser average intensity and ΔI₀ is the rms of the laser beam intensity fluctuation. One should note that while the left hand side (LHS) scales as K²∝I₀, the right hand side (RHS) scales as ρ_{FEL}∝I₀^{1/3}, therefore this requirement puts a limit on the maximal laser pulse intensity that can be used. For typical values of K≈0.05, and ρ_{FEL}≈5×10⁻⁵, it implies that the electric field fluctuation is to be

$$\frac{Δ {E}_{0}}{{E}_{0}} ≪ 0.02 or \frac{Δ I}{{I}_{0}} ≪ 0.04 .$$

Therefore, the laser intensity fluctuation is to be below 1%. The laser fluctuations can rise due to instabilities in the production of the beam or due to the beam divergence after the Rayleigh length. Typical values for laser fluctuation of the first kind are ˜0.5%, thus it remains to analyze the electric field change due to the beam divergence. The electric field amplitude term can be simplified since

$${K}^{2} \frac{{r}_{b}^{2}}{{w}_{0}^{2}} ≪ {ρ}_{FEL} ;$$

thus, the overall laser electric field can be approximated:

$$E ( ρ , z ) \approx \hat{x} {E}_{0} [ 1 + \frac{1}{2} {( \frac{z}{{z}_{R}} )}^{2} ] exp ( - ikz ) \qquad ( 120 )$$

Therefore, the electric field strength change due to the laser beam divergence is given by:

$$\frac{Δ {E}_{0}}{{E}_{0}} = \frac{1}{2} {( \frac{z}{{z}_{R}} )}^{2} \qquad ( 121 )$$

If the electric field fluctuation in Eq. (121) is small enough, such that the condition of Eq. (118) is satisfied, the assumption on coherent ICS scheme will be similar to the external field applied by an undulator magnet. Thus, the condition that is to be fulfilled in an undulator FEL should be fulfilled also for an ICS FEL mechanism.

In the following, the electric field strength is analyzed.

FIG. 26 shows the dependence of the electric field on the requirements of Eq. (119). As the electric field increases, this requirement is harder to satisfy due to K²∝E₀², ρ_{FEL}∝E₀^{2/3} dependence. The parameters that were used to generate the graph: X-ray wavelength λₓ=7 Å, λᵤ=1064 nm,

$$\frac{Δ {I}_{0}}{{I}_{0}} = 0.5 \% .$$

The blue line is K², the orange line is

$$2 {{ρ}_{FEL} ( \frac{Δ {I}_{0}}{{I}_{0}} )}^{- 1} ,$$

with electron charge density of

$${n}_{e} = 7 \times {10}^{21} \frac{1}{{m}^{3}}$$

and the yellow line is

$$2 {{ρ}_{FEL} ( \frac{Δ {I}_{0}}{{I}_{0}} )}^{- 1} with {n}_{e} = {10}^{23} \frac{1}{{m}^{3}} .$$

### By Eq. (113),

$${K}^{2} ≪ 2 {{ρ}_{FEL} ( \frac{Δ {I}_{0}}{{I}_{0}} )}^{- 1}$$

should be satisfied. As the electric field increases, this requirement is harder to satisfy due to K²∝E₀², ρ_{FEL}∝E₀^{2/3} dependence. The requirement can be relaxed by increasing the Pierce parameter, either by increasing the electron charge density or using longer X-ray wavelengths. The typical range of electric fields that we analyze is 100-250 GV/m.

In the following, the laser beam waist and the Rayleigh length are analyzed.

The intensity fluctuation due to the laser beam divergence is given from Eq. (121) by:

$$\frac{Δ K}{K} = \frac{1}{2} {( \frac{z}{{z}_{R}} )}^{2} \qquad ( 122 )$$

where it is assumed that z<<z_{R}. Overall, the X-ray linewidth broadening due to the laser fluctuation is the sum of the laser source fluctuation and the fluctuation due to the laser divergence. If the laser beam fluctuations were in the regime which

$${K}^{2} \frac{Δ K}{K} ≪ {ρ}_{FEL} ,$$

a high K parameter (i.e., a high intensity laser) could be used. However, since

$$\frac{Δ K}{K} ≫ {ρ}_{FEL} ,$$

the maximal laser intensity that can be used is limited by the beam intensity fluctuations. Usually, the intensity fluctuation due to the laser beam divergence is playing a much more crucial role and limitation on the energy spread. Plugging Eq. (122) into Eq. (118) gives the following condition for the laser beam fluctuations:

$$\frac{1}{2} {{K}^{2} ( \frac{z}{{z}_{R}} )}^{2} << {ρ}_{FEL} , \qquad ( 123 )$$

Assuming the total interaction length is L_{g}≈20L_{g0}, therefore one should limit: z=10L_{g0}:

$$50 {{K}^{2} ( \frac{{L}_{g 0}}{{z}_{R}} )}^{2} << {ρ}_{FEL} \qquad ( 124 )$$

Substituting the term for the FEL gain length L₉₀, gives the following condition for the Rayleigh length:

$${z}_{R} >> \sqrt{\frac{50 {K}^{2} {L}_{g 0}^{2}}{{ρ}_{FEL}}} \approx \frac{K {λ}_{u}}{π {ρ}_{FEL}^{3 / 2}} \qquad ( 125 )$$

Due to the relation between the Rayleigh length and the beam waist:

$${z}_{R} = \frac{π {w}_{0}^{2}}{{λ}_{u}} \to {w}_{0} = \sqrt{\frac{{z}_{R} {λ}_{u}}{π}} , \qquad ( 126 )$$

a lower limit to the laser beam waist is derived:

$${w}_{0} >> \frac{{λ}_{u}}{π} \sqrt[4]{\frac{8 {k}_{u}^{2} {γ}_{e}^{3}}{π {r}_{e} {n}_{e}}} \qquad ( 127 )$$

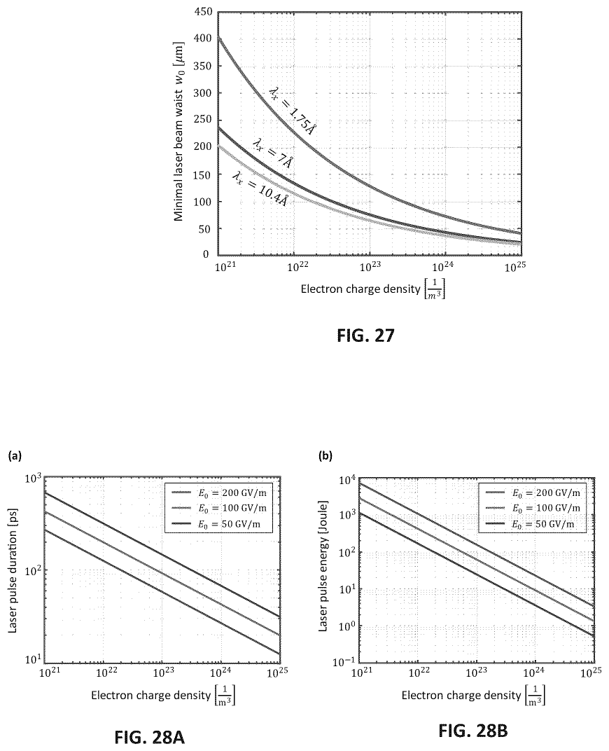

Eq. (127) shows the relation between the requirements of the laser beam to the requirements of the electron beam. For higher electron charge densities and lower electron beam energies, the beam waist lower limit would be smaller, relaxing the requirement on the laser beam total power. FIG. 27 shows the minimal laser beam waist as a function of the electron charge density and for different X-ray wavelengths. The graph was produced for λᵤ=1064 nm.

The laser beam power requirements can be considered as follows: Since the laser beam waist is to be larger than 100 μm and the electric field should be about ˜150 GV/m, the laser beam intensity is:

$${I}_{0} = \frac{c {ϵ}_{0} {\vert {E}_{0} \vert}^{2}}{2} \approx 3 \times 1 {0}^{15} \frac{W}{{cm}^{2}}$$

and the laser pulse power is:

$${P}_{0} = {I}_{0} π {ω}_{0}^{2} \approx 1 TW$$

The laser pulse duration is to be long enough for two reasons: 1) the interaction length is to be longer than the interaction length, i.e., greater than L_{g}≈20L_{g0}. 2) assuming the laser system is optimized for the Fourier-transform limit of the pulse duration, the laser pulse linewidth is to be lower than the Pierce parameter, i.e.,

$$\frac{1}{{τ}_{p}} << \frac{c}{{λ}_{u}} {ρ}_{FEL} \to {τ}_{p} >> \frac{{λ}_{u}}{c} \frac{1}{{ρ}_{FEL}} .$$

Therefore, the condition for the laser pulse length is:

$${τ}_{p} >> max \{ \frac{20 {L}_{q 0}}{c} , \frac{{λ}_{u}}{c} \frac{1}{{ρ}_{FEL}} \}$$

The total energy of the laser pulse is given by:

$${E}_{p}^{( laser )} = {P}_{0} {τ}_{p} >> \frac{c {ϵ}_{0} {\vert {E}_{0} \vert}^{2}}{2} \frac{K {λ}_{u}^{3}}{π c {ρ}_{F E L}^{5 / 2}} \qquad ( 128 )$$

FIGS. 28A and 28B show the requirements for the laser pulse duration (FIG. 28A) and pulse energy (FIG. 28B) as a function of the electron pulse density and for different values of laser pulse power. The following laser pulse powers and intensities are shown:

$$1 ) {E}_{0} = 200 \frac{G V}{m} , {I}_{0} = 5 \times 1 {0}^{15} \frac{W}{c {m}^{2}} ;$$

$$2 ) {E}_{0} = 100 \frac{G V}{m} , {I}_{0} = 1.3 \times 1 {0}^{15} \frac{W}{c {m}^{2}} ;$$

$$3 ) {E}_{0} = 50 \frac{G V}{m} , {I}_{0} = 3.3 \times 1 {0}^{14} \frac{W}{c {m}^{2}} .$$

The graphs were produced for λᵤ=1064 nm and λₓ=7 Å.

Denser electron charge eases the requirements on the laser beam. Moreover, while the pulse duration increases for weaker electric field strength, the total electron pulse energy decreases due to the dependence on

$${E}_{p}^{( laser )} ∝ \frac{{\vert {E}_{0} \vert}^{2} K}{{ρ}_{FEL}^{5 / 2}} ∝ {E}_{0}^{4 / 3} .$$

In addition, the laser pulse energy scales as Eₚ^{(laser)}∝γₑ^{5/2}λᵤ^{2/3}; therefore, either shorter laser wavelength or lower electron energies will ease the requirements on the laser pulse energy. For hard X-rays, these requirements are hard to achieve with current laser technology; thus, a scheme based on the low-gain ICS (oscillator ICS) will be discussed below.

In the following the inventors describe the theoretical bound of electron source emittance under the quantum mechanical constraints on the electron source brightness.

The fundamental limits in beam brightness set by quantum mechanics are at least five orders of magnitude higher than the performance of state-of-the-art pulsed electron sources. Therefore, presenting an optimistic view of the opportunities for significant improvements and further breakthroughs in the spectrum of bright electron beam applications. The quantum mechanical normalized brightness limitation of an electron beam in the absence of electromagnetic fields is given by [12]:

$${B}_{n , e}^{Q M - lim i t} = \frac{2 Δ {γ}_{e} e c {λ}_{c}^{- 3}}{π} , \qquad ( 129 )$$

$$where {λ}_{c} = \frac{h}{mc} = 2.43 pm$$

is the Compton wavelength. Rearranging Eq. (129):

$${B}_{n , e}^{Q M - lim i t} = \frac{2 e c {λ}_{c}^{- 3}}{π} ( \frac{Δ {γ}_{e}}{{γ}_{e}} ) {γ}_{e} , \qquad ( 130 )$$

Let us denote the electron pulse charge with Qₑ, the pulse duration as τₚ and the beam emittance ϵₙ²:

$${B}_{n , e} = \frac{{Q}_{e}}{{τ}_{p} {ϵ}_{n}^{2}} \leq \frac{2 Δ {γ}_{e} e c {λ}_{c}^{- 3}}{π} = \frac{2 e c {λ}_{c}^{- 3}}{π} ( \frac{Δ {γ}_{e}}{{γ}_{e}} ) {γ}_{e} , \qquad ( 131 )$$

Next, the inventors represent this limit as a function of the electron charge density nₑ, the electron beam emittance ϵₙ², and energy spread Δγₑ/γₑ. The derivation will follow the following steps: 1) Find the electron charge density nₑ by the requirement that the repulsion between the electron should be weaker than the ponderomotive force. 2) Set the Pierce parameter by the derived electron charge density. 3) The Pierce parameter will set the maximal electron energy spread and divergence allowed. 4) Derive the maximal electron source current by setting these limits into Eq. (131). 5) Derive the coherent ICS X-ray quantum-mechanical brightness limit in a high-gain regime.

The desired electron pulse charge nₑ from the requirement on the space charge is derived:

$${n}_{e} < \frac{{k}_{u}^{2} {γ}_{e}^{3} {K}^{4}}{8 π {r}_{e}} , \qquad ( 132 )$$

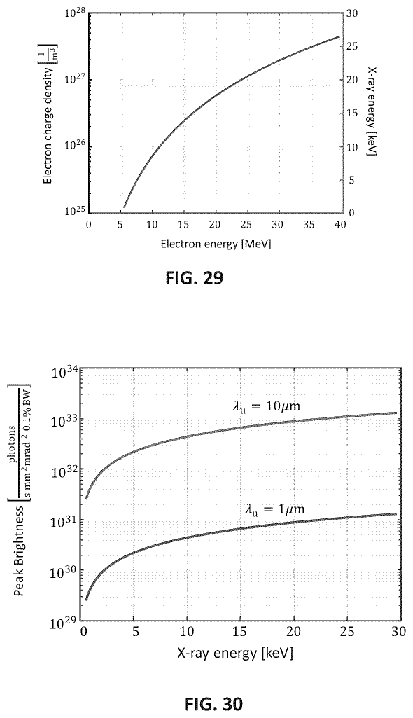

As expected, the electron pulse charge upper bound is higher for either higher electron beam energies (∝γₑ³) or stronger laser fields (∝K⁴). FIG. 29 shows the allowed charge density as a function of electron energy.

Substituting Eq. (132) into Eq. (91) yields the following Pierce parameter bound:

$${ρ}_{FEL} < \frac{{K}^{2}}{4} , \qquad ( 133 )$$

This result is surprising since the Pierce parameter depends only on the counter-propagating laser parameters. In particular, the requirement on the laser beam can be significantly relaxed under the assumption of an ideal electron source. For example, the laser pulse energy becomes (Eq. (128)):

$${E}_{p}^{( laser )} >> \frac{c {ϵ}_{0} {\vert {E}_{0} \vert}^{2}}{2} \frac{32 {λ}_{u}^{3}}{π {cK}^{4}} , \qquad ( 134 )$$

The required laser pulse energy decreases to a few Joules, the pulse waist reduces to tens micro-meter, and the pulse duration to tens of picoseconds. This result shows the interchangeable requirements between the electron source to the laser beam—progress in one of them enables less strict requirements on the other (assuming the same X-ray wavelength emission). Since the allowed energy spread is limited by the Pierce parameter, the following requirement holds:

$$\frac{Δ {γ}_{e}}{{γ}_{e}} = {α}_{1} {ρ}_{FEL} = \frac{{α}_{1} {K}^{2}}{4} , \qquad ( 135 )$$

where α₁ is a dimensionless parameter. The electron beam emittance is set to fulfill the fully coherent condition (Eq. (103), i.e.

$${ϵ}_{n} = \frac{{λ}_{x}}{4 π} {γ}_{e}$$

and the upper limit to the electron source current is derived:

$$I \leq \frac{2 e c {λ}_{c}^{- 3}}{π} \frac{{α}_{1} {K}^{2}}{4} {( \frac{{λ}_{x}}{4 π} )}^{2} {γ}_{e}^{3} , \qquad ( 136 )$$

Next, X-ray beam power and brightness bound for an ideal electron source beam are derived. If the conditions for electron micro-bunching are met, a bright X-ray beam is emitted. In undulator FEL facilities, the peak power can reach tens GW and a brightness of

$$∼ 1 {0}^{33} \frac{phot o n s}{s {mm}^{2} {mrad}^{2} 0.1 \% BW} .$$

In the coherent ICS scheme, however, the peak power and the peak brightness will be lower since the total power and energy of the electron beam are much lower. The inventors derive, in the following, the scaling law of the peak power and the peak brightness as a function of the electron beam energy and the undulator period. First, the number of photons produced per electron is given by:

$${N}_{p h}^{single - electron} = {ρ}_{FEL} {E}_{e} / {E}_{ph} , \qquad ( 137 )$$

The Pierce parameter ρ_{FEL} describes the efficiency (or the conversion ratio) between the electron beam energy to the X-ray beam energy. Thus, the X-ray beam power is given by:

$$\begin{matrix}{P}_{sat} = {ρ}_{FEL} {P}_{e} = {ρ}_{FEL} {γ}_{e} {m}_{e} {c}^{2} {I}_{e} = {ρ}_{FEL} {γ}_{e} {m}_{e} {c}^{2} \frac{2 e c {λ}_{c}^{- 3}}{π} \frac{{α}_{1} {K}^{2}}{4} {( \frac{{λ}_{x}}{4 π} )}^{2} {γ}_{e}^{3} \\ = {ρ}_{FEL} {m}_{e} {c}^{2} \frac{2 e c {λ}_{c}^{- 3}}{π} \frac{{α}_{1} {K}^{2}}{4} {( \frac{{λ}_{u}}{8 π} )}^{2}\end{matrix} \qquad ( 138 )$$

$${P}_{sat} = {ρ}_{FEL} {m}_{e} {c}^{2} \frac{2 e c {λ}_{c}^{- 3}}{π} \frac{{α}_{1} {K}^{2}}{4} {( \frac{{λ}_{u}}{8 π} )}^{2} ,$$

The typical values for the saturation power are ˜1 GW for a laser wavelength of 1 um. Longer undulations will have greater saturation power, i.e., the peak power theoretical bound of the undulator FEL will be ˜8 orders of magnitude higher than a coherent ICS scheme with an undulation period of 1 um. The peak power does not depend directly on the electron energy (i.e., the scaling of the electron energy and maximal current cancels). The coherent ICS peak saturation power derived in Eq. (138) is the quantum-mechanical bound. This value is close to current state-of-the-art undulator FEL facilities. However, for state-of-the-art electron sources, the coherent ICS saturation power will be much lower, as discussed later.

Next, the bound on the X-ray beam brightness is derived. The X-ray beam brightness is given by:

$${B}_{p h} = \frac{{N}_{p h}}{4 {π}^{2} {ϵ}_{x} {ϵ}_{y} 2 π {σ}_{t} {σ}_{ω} / ω} , \qquad ( 139 )$$

where Nₚₕ is the total photon emitted, ϵₓ, ϵ_{y} are the X-ray beam emittance, σₜ is the RMS of the pulse duration and σ_{ω}/ω is the X-ray beam linewidth. For the high-gain regime, the X-ray linewidth is:

$${σ}_{ω} / ω = 3 \sqrt{2} {ρ}_{FEL} \sqrt{\frac{{L}_{g 0}}{z}} , \qquad ( 140 )$$

For typical interaction length of z=20L_{g0}, the linewidth is approximately σ_{ω}/ω≈ρ_{FEL} Substituting Eq. (103) and Eq. (140) into Eq. (139) gives:

$${B}_{coherent ICS}^{( peak )} = \frac{1}{16 {π}^{4}} \frac{{λ}_{u}}{{λ}_{c}^{4}} c \frac{{α}_{1} {K}^{4}}{16} {γ}_{e}^{2} , \qquad ( 141 )$$

FIG. 30 shows the peak brightness of the coherent ICS scheme in a high-gain region for λᵤ=1 μm and λᵤ=10 μm. The parameters that were used to generate the graphs are K=0.05, α₁=¼. The scaling laws prefer longer laser wavelengths due to the B_{coherent ICS}^{(peak)}∝λₓγₑ⁴ dependence, i.e., higher electron beam energies and longer wavelengths are advantageous with respect to the source brightness. However, longer laser wavelengths require more laser pulse energy, i.e., this is a trade-off between the X-ray beam brightness and the requirements of the counter-propagating laser beam. Typical values of state-of-the-art FEL are 10³³ photons/s mm² mrad² 0.1% BW; therefore, the theoretical quantum mechanical limit of the coherent ICS scheme approaches this value.

Next, the inventors compare the coherent ICS and the incoherent ICS, assuming the electron source achieves the quantum-mechanical bound. For the incoherent case, it is assumed that the interaction length is L_{g0} (i.e., before the electron micro-bunching starts), yet the laser pulse power and intensity are the same between the two schemes. Under these assumptions, the number of photons produced per single electron in the incoherent case is:

$${N}_{p h}^{s i ngle - electron} = \frac{4 {r}_{e}}{{λ}_{c} 3 \sqrt{3}} \approx 1 {0}^{- 3} , \qquad ( 142 )$$

Therefore, the number of photons produced per electron is 3 orders of magnitude lower in the incoherent scheme compared with the coherent scheme. In addition, the brightness of the coherent scheme is 8 orders of magnitude higher than the incoherent scheme, due to narrower linewidth and lower beam emittance (i.e., 3 orders of magnitude come from the number of photons produced per electron, and additional 5 orders of magnitude come from the lower linewidth and emittance).

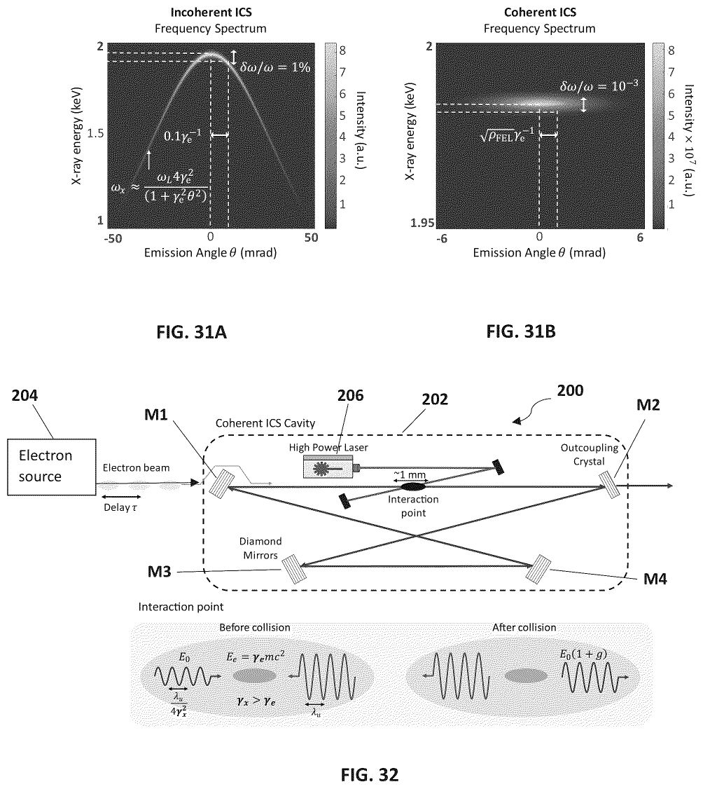

FIGS. 31A and 31B compare the emission spectrums of the incoherent ICS (FIG. 31A) with the coherent ICS (FIG. 31B) for the parameters discussed above. Note the different scaling of the x-axis and y-axis. Also, note the different X-axis and Y-axis and the peak intensity of the two graphs. In FIG. 31A, showing the incoherent scheme, the opening angle of the beam is ˜γₑ⁻¹\sqrt{δω/ω} in which the linewidth is δω/ω. However, the emission is also significant up to the cone of γₑ⁻¹, where the X-ray linewidth is much larger (Eq. (4)). In FIG. 31B, showing the coherent ICS scheme, the emission is concentrated within ˜γₑ⁻¹ ρ_{FEL} with a linewidth of ρ_{FEL}. The spread for larger emission cones is negligible in this scheme compared with the incoherent scheme. While the tight collimation of the incoherent ICS beam applies only if the beam is within the permitted emission linewidth, the incoherent ICS emission cone is wide (γₑ⁻¹), for larger bandwidth acceptation. On the other hand, the coherent ICS emits into a narrow emission cone˜γₑ⁻¹\sqrt{ρ_{FEL}} with linewidth of ρ_{FEL}. The intensity outside of this spectrum is negligible, therefore the peak intensity is much higher.

In the following the inventors describe the experimental realization of the high-gain ICS with state-of-the-art electron and laser beams.

The following two schemes are examined: 1) X-ray emission wavelength of 1 nm, which is appropriate for soft X-ray applications; and 2) EUV emission wavelength of 13.5 nm, which has many applications in the EUV lithography industry. Moreover, the laser sources that fulfill the requirements for each one of the schemes are discussed (i.e., wavelength, power, duration, energy, coherence, and divergence). The requirement of a fully coherent X-ray emission sets the following upper limit on the electron energy:

$${γ}_{e} < \frac{{λ}_{u}}{8 {πϵ}_{n}} , \qquad ( 143 )$$

Therefore, longer undulations or lower normalized electron beam emittance allows higher electron energies. In the examined schemes, the electron source energy and the undulation period were chosen by this requirement.

The current state-of-the-art electron sources' brightness is several orders below the quantum mechanical limitation. However, in recent years, significant progress has been made for the XFEL, UEM, and UED applications. The UEM and the warm XFEL can serve as the electron source beam for coherent ICS in different emission wavelengths. For coherent ICS applications in the X-ray wavelengths of a few nm (<10 nm), the UEM electron source is the most promising due to its low energy spread and low emittance. For applications with soft X-ray\UV wavelengths of ˜tens nanometers, the warm XFEL electron source is more appropriate due to its higher current, normalized emittance of tens nanoseconds, and energy spread of 10⁻⁴. Table 12 shows two typical schemes involving the UEM and XFEL source.

TABLE 12

| | Parameter | Soft X-ray | EUV |
|---|---|---|---|
| Electron | Source type | UEM | XFEL (warm) |
| beam | Normalized emittance | <2 nm | <50 nm |
| | Energy | 8.1 MeV | 6.96 MeV |
| | Energy spread | 10⁻⁵ | 10⁻⁴ |
| | Current | 100 mA | 200 A |
| | Normalized brightness | 2.5 × 10¹⁶ | 8 × 10¹⁶ |
| | $[ \frac{C}{s {m}^{2} {rad}^{2}} ]$ | | |
| | Spot size at IP | 1 μm | 6 μm |
| | Beam divergence | 0.1 mrad | 0.6 mrad |
| Laser | Laser wavelength | 1 μm (NIR) | 10 μm (LWIR) |
| beam | Undulator parameter | 0.05 | 0.07 |
| | Electric field | 300 GV/m | 50 GV/m |
| | Pulse power | 5 TW | 650 GW |
| | Pulse duration | 134 ps | 100 ps |
| | Pulse energy | 720 Joule | 65 Joule |
| X-ray | Wavelength | 1 nm | 13.5 nm |
| beam | Energy | 1240 eV | 92 eV |
| | Pierce parameter ρ_{FEL} | 2 × 10⁻⁵ | 2.2 × 10⁻⁴ |
| | FEL gain length L_{g0} | 2 mm | 1.5 mm |
| | Interaction length Lₛₐₜ | 4 cm | 3 cm |
| | Saturation power | ~1 W | ~100 KW |
| | Peak brightness | ~10²⁴ | ~10²⁶ |
| | $[ \frac{photons}{s {mm}^{2} {m rad}^{2} 0.1 \% BW} ]$ | | |
| | Peak flux | ~10¹⁷ | ~10²² |
| | $[ \frac{photons}{s {mm}^{2}} ]$ | | |

The first scheme is based on a UEM electron source with a laser beam in the near-infrared (NIR) spectrum. From the requirement on the fully coherent emission (Eq. (103)), this source can generate emission wavelengths of ˜1 nm due to its low emittance. Since the UEM electron source energy is limited by ˜10 MeV, the laser beam wavelength is to be short (NIR) to achieve short emission wavelengths. The shown coherent ICS configuration has an X-ray emission wavelength of 1 nm (1240 eV), with a peak brightness of

$$∼ 1 {0}^{24} \frac{phot o n s}{s {mm}^{2} {mrad}^{2} 0.1 \% BW}$$

and a peak flux of 10¹⁸ photons/s mm². It requires a terawatt laser with a pulse duration of a few hundredths' picoseconds and total energy per pulse of ˜1 kJ. The relatively low flux of this source is due to the low current of the electron source, yet its brightness is relatively high due to the low electron beam emittance. This scheme has a few challenges due to the relatively low electron beam current. The Pierce parameter is ρ_{FEL}˜2×10⁻⁵, which puts strict requirements on the electron source and laser beam.

The second scheme is based on the XFEL electron source with a laser beam in the long wave infrared (LWIR) spectrum. Since the XFEL electron beam normalized emittance is ˜50 nm-rad, it is necessary to have longer counter-propagating laser wavelengths for longer emission wavelengths. The emission wavelength of this scheme is 13.5 nm, which has many applications in the Extreme Ultraviolet (EUV) lithography industry. Although this scheme does not satisfy the fully coherent X-ray emission condition, its flux is much higher (˜5 orders of magnitude) than the previous scheme due to a much higher electron source current. However, the X-ray brightness is only two orders of magnitude higher than the previous scheme due to its higher electron beam emittance. The requirements on the laser source for this scheme are less strict than the previous one due to the lower electric field strength needed for longer laser wavelengths, i.e., sub-terawatt power and pulse energy of tens of Joule.

These two schemes achieve 5-7 orders of magnitude higher brightness relative to state-of-the-art incoherent ICS schemes. The number of produced photons per electron is the same between the incoherent and the coherent ICS, however the main difference is that the coherent ICS brightness is much higher due to the lower linewidth and the lower emittance. This gives ˜5-7 orders of magnitude higher brightness values.

Since the required electron energy for the generation of X-rays in the spectrum of a few nanometers requires electron source energies below the neutron production threshold (˜10 MeV), the shielding requirements are much less strict and can potentially fit to a compact machine.

In the following the inventors describe the low-gain ICS scheme for the generation of hard X-rays.

Following the pervious discussion, the high-gain ICS scaling for shorter X-ray wavelengths and higher electron beam energies is challenging: 1) the Pierce dependence on the electron beam energy ρ_{FEL}∝γₑ⁻¹ implies that the requirements on the electron beam energy spread should be stricter. 2) the laser pulse energy scales as Eₚ^{(laser)}∝γₑ^{5/2} (Eq. (128)); thus, higher laser pulse energies are necessary. 3) quantum-recoil effects become significant (Eq. (108)). Therefore, the inventors examine an additional coherent emission scheme based on the ICS low-gain regime (“ICS oscillator”). While in the ICS high-gain regime, the X-ray beam power and brightness increase due to the electron micro-bunching process, the low-gain regime is analogous to a standard laser, composed of a cavity with a gaining medium. In this scheme, the cavity is made from Diamond crystals acting as mirrors, while the gaining medium is based on the energy transfer from the undulator motion of the electrons to the X-ray wave.

FIG. 32 shows schematically an X-ray generator 200 operable as a coherent ICS oscillator of the present disclosure. Such X-ray generator 200 includes: a cavity 202 defining radiation propagation path between four mirrors M1-M4, and an interaction region (point) on the propagation path; an electron source 204 producing a pulsed electron beam propagating along an electron beam path towards the interaction region; and a laser source unit 206 producing a pulsed laser beam propagating along a laser beam path towards the interaction region. The configuration is such that the pulsed laser beam counter-propagates with the electron beam along a radiation propagation path thereby generating an X-ray wave caused by undulation motion of the electrons. Multiple interactions between the X-ray wave, the electron beam, and the laser beam within the cavity at the interaction region provide exponentially increasing power of coherent X-ray emission of X-rays being generated to a predetermined saturation power.

The cavity is based on four Diamond mirrors with a single outcoupling crystal to allow the tunability of the X-ray beam. The X-ray wave interacts with the electron beam and the counter-propagating laser beam in the interaction point, with a typical interaction length of ˜1 cm. If the X-ray cavity energy is slightly lower than the electron energy, the electron beam transfers energy to the X-ray wave. If the gain of the X-ray wave is larger than the losses from the mirrors and focusing devices, then the X-ray wave will gain net energy in each pass, leading to an exponential increase after many passes. The electron beam repetition rate specifies the cavity length. For example, for a repetition rate of −100 MHz (i.e., ˜10 ns between adjacent bunches), the cavity length will be ˜3 m. In order to reuse the laser beam in multiple passes, the counter-propagating laser beam s to be in its cavity. However, the laser beam loses energy due to the interaction with the electron beam and the natural loss of the cavity. To compensate for the losses, an amplifier is to amplify the laser in each pass.

As described below, the main advantages of the coherent ICS oscillator scheme include: 1) lower laser power and energy requirements (two orders of magnitude lower pulse energy, one order of magnitude lower pulse power). 2) lower X-ray linewidth due to the crystals transfer function. 3) quantum recoil effects are negligible in this scheme. 4) the counter-propagating laser beam can be used several times in the interaction point, reducing the total energy consumption of the scheme.

In the ICS oscillator scheme, the X-ray wave gains a small amount of power in each pass. After many passes, the X-ray wave intensity increases exponentially and saturates. The power increase can be described by:

$$\begin{matrix}{P}_{1} = {P}_{s} \\ {P}_{n} = R ( 1 + G ) {P}_{n - 1} + {P}_{s} ,\end{matrix} \qquad ( 144 )$$

$$n > 1 ,$$

where Pₛ is the spontaneous emission, R represent the total loss due to mirrors and focusing devices, and G is the FEL gain. By Madey theory, the gain in each pass is given by:

$$\begin{matrix}G ( ξ ) = - \frac{π {e}^{2} {K}^{2} {N}_{u}^{3} {λ}_{u}^{2} {n}_{e}}{4 {ϵ}_{0} {m}_{e} {c}^{2} {γ}_{e}^{3}} \frac{d}{d ξ} ( \frac{{sin}^{2} ξ}{{ξ}^{2}} ) \\ = - {π}^{2} {r}_{e} \frac{{K}^{2} {N}_{u}^{3} {λ}_{u}^{2} {n}_{e}}{{γ}_{e}^{3}} \frac{d}{d ξ} ( \frac{{sin}^{2} ξ}{{ξ}^{2}} )\end{matrix} , \qquad ( 145 )$$

where K is the undulator parameter, λᵤ is the undulator period, nₑ is the electron density, η is the relative energy deviation between the electron beam and the resonance energy of the cavity and ξ=2πNᵤη is the detuning parameter:

$$ξ = 2 π {N}_{u} \frac{( {γ}_{e} - {γ}_{r} )}{{γ}_{r}} = 2 π {N}_{u} η , \qquad ( 146 )$$

where Eₑ=γₑmc² is the electron energy, and γᵣ represents the resonator wavelength as specified by Eq. (83). Electrons with positive η (i.e., higher than the resonator energy) enhance the intensity of the light wave, while those with negative η reduce it.

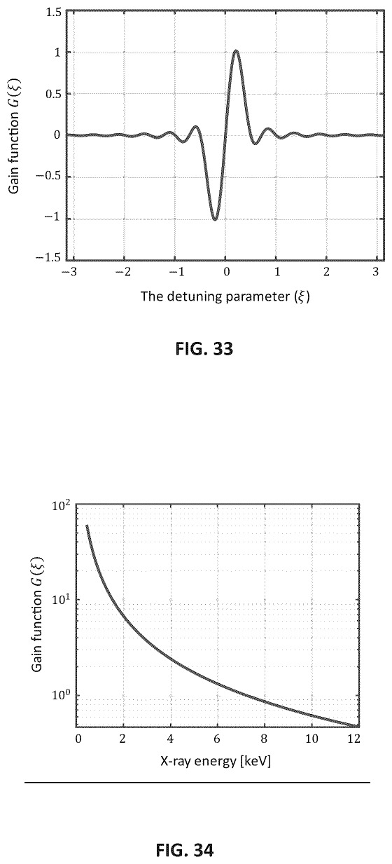

FIG. 33 shows the coherent ICS low gain function, G(ξ), as a function of the detuning parameter for the following parameters: electron beam density of

$${n}_{e} = 2 \times 1 {0}^{21} [ \frac{1}{{m}^{3}} ] ,$$

number of undulation periods of Nᵤ=10⁴, undulation parameter of K=0.03, Lorentz factor of γₑ=19.56, and NIR laser wavelength of λ_{L}=1064 nm. In this configuration, the emitted X-ray wavelength is a λₓ≈7 Å (˜1780 eV), and the interaction length is ˜1 cm. For this configuration, the maximal energy transfer in a single pass is ˜100%. However, the typical cavity loss is R≈20%; therefore, the total gain in a single pass is ˜80%. The peak gain is achieved for a relative energy spread of

$$η \approx \frac{1.3}{2 π {N}_{u}} ,$$

defining the allowed energy spread of the electron beam to be below this value (RMS). The relative energy deviation specifies the allowed X-ray wave linewidth and is analogous to the Pierce parameter in the high-gain regime, i.e., the requirements that depend on the Pierce parameter can be replaced by

$$η \approx \frac{1.3}{2 π {N}_{u}} .$$

Therefore, longer interaction length will increase the gain in each pass, at the expense of stricter requirements of the electron beam energy spread.

FIG. 34 shows the peak gain function as a function of the X-ray energy. The graph was produced with the following parameters:

$${λ}_{L} = 1064 nm , {N}_{u} = 20000 , {n}_{e} = 2 \times 1 {0}^{21} [ \frac{1}{{m}^{3}} ] , K = 0.0 3.$$

With higher X-ray energies (i.e., higher electron beam energies), the peak gain decreases by ∝γₑ⁻³. However, for the examined configuration, the peak gain is about 40% for 12 keV X-ray energy, a much better scaling compared with the high-gain SASE. To further increase the X-ray energies, either higher undulator parameters (K) or longer laser wavelengths are to be used (i.e., lasers in the LWIR range). The last is due to the ∝λₓγₑ dependence of the gain factor for a fixed X-ray wavelength.

The exponential growth of the intracavity radiation power does not continue indefinitely. Rather, the X-ray beam power eventually becomes large enough to trap electrons in the ponderomotive potential and then rotate them to an absorptive phase where they extract energy from the field. The saturation power is:

$${P}_{sat} = \frac{{P}_{e}}{{N}_{u} ( 1 - R )} , \qquad ( 147 )$$

where Pₑ is the electron beam power. Compared to SASE from a high-gain FEL, the pulse intensity of an X-FELO is lower due to the lower electron power in each pulse, but its spectrum is narrower by more than three orders of magnitude due to the narrow energy bandwidth transfer of the crystals and can be as low as a few meV. Therefore, the peak brightness is rather similar between the ICS oscillator and the coherent high-gain ICS.

Since the ICS oscillator requires an order of magnitude shorter interaction length than the ICS high-gain regime, the laser pulse can be shortened significantly, reducing the requirements on the laser beam energy. The required Rayleigh length is shorter by a factor of ×10, and the laser beam waist by a factor of ˜3. Overall, the laser pulse energy is lower by two orders of magnitude—an order of magnitude due to the shorter bunch length and the second order of magnitude due to the lower beam waist.

An additional advantage of the low-gain regime is due to the quantum recoil between the electron and laser beams. While in the coherent ICS high-gain regime, higher X-ray energies do not meet the requirement on the quantum recoil (Eq. (108)), i.e., the quantum recoil significantly changes the statistics of the electron beam, in the low-gain regime, the quantum recoil effect is negligible. If a single pass is considered, the cross-section between the electron beam and the laser is small, i.e., only a few percentages of the electrons lose energy for photon production. Therefore, the electron beam energy spread only slightly increases due to the quantum recoil and has a negligible effect on the emission pattern.

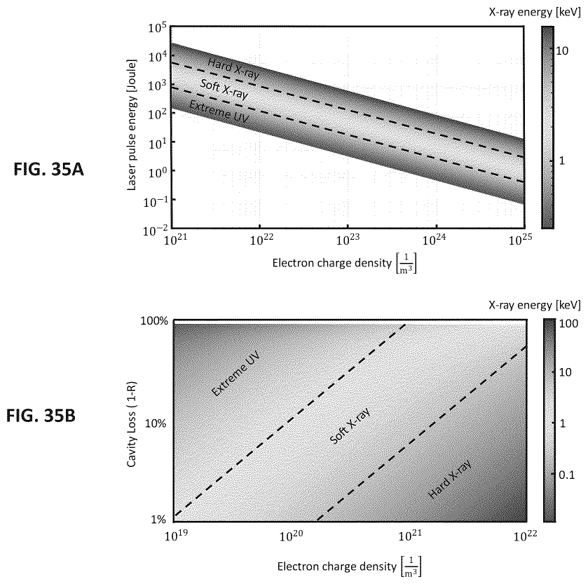

FIGS. 35A and 35B illustrate the high-gain ICS and low-gain ICS emission energy. FIG. 35A shows the emission energy in the high-gain regime as a function of the electron charge density and the laser pulse energy. FIG. 35B shows the emission energy in the low-gain regime as a function of the electron charge density and the cavity loss. The required laser pulse energy is of a few tens of Joules for NIR laser. These figures show that, when operating with high-gain ICS scheme, for a given X-ray range to be obtained (e.g., hard X-ray, soft X-ray or extreme UV radiation), a laser beam of the higher laser pulse energy requires interaction with an electron beam of a lower electron charge density. As for the low-gain ICS scheme, electron charge density dependence on cavity losses should be considered in order to obtain a desired X-ray range while avoiding undesirable cavity losses.

1. An X-ray generator comprising:
an electron source configured and operable to generate an accelerated electron beam propagating along a first propagation path with a first general propagation direction;
a first crystalline structure arranged in said first propagation path, the first crystalline structure defining a first crystal plane oriented at a predetermined non-zero angle with said first propagation path, the first crystalline structure being configured to transmit said accelerated electron beam therethrough and generate parametric X-ray emission, being first directional emission of a photon flux, along a second propagation path tilted with respect to said first general propagation direction, and
a second crystalline structure located in said second propagation path and being configured as a monochromator with respect to said parametric X-ray emission, the second crystalline structure defining a second crystal plane oriented at said predetermined non-zero angle with respect to said second propagation path to thereby provide second directionality for the parametric X-ray emission, thereby producing a directional output photon flux.

2. The X-ray generator according to claim 1, configured and operable as a tunable generator.

3. The X-ray generator according to claim 1, wherein the electron source comprises: an electron gun and an electron accelerator.

4. The X-ray generator according to claim 1, wherein the electron source is configured to focus the electron beam onto a predetermined spot size on the first crystalline structure.

5. The X-ray generator according to claim 4, wherein the electron source comprises a quadrupole magnet.

6. The X-ray generator according to claim 1, wherein the electron source is controllably operable with predetermined repetition rate of electron beam generation.

7. The X-ray generator according to claim 1, wherein said first crystalline structure comprises a stack of multiple crystals.

8. The X-ray generator according to claim 7, characterized by at least one of the following:
a thickness of each crystal in said stack is smaller than a characteristic absorption length for absorption of said parametric X-ray emission within a material of the crystal;
a distance between each two adjacent crystals in said stack of the multiple crystals is selected to provide that an escape path of said parametric x-ray emission avoids going through the adjacent crystal, thereby increasing yield of said parametric x-ray emission;
an overall thickness, Lₒₚₜ, of said stack of the multiple crystals is about 0.1X₀, where X₀ is a characteristic radiation length of material of the respective crystal.

9. The X-ray generator according to claim 1, characterized by one of the following: the photon flux of the parametric X-ray emission is above 1.5×10¹⁰ for photon energies below 25 keV and for any one of the following materials: tungsten, molybdenum, copper, silicon; or the photon flux of the parametric X-ray emission is above 1.1×10¹¹ for photon energies below 25 keV for graphite.

10. The X-ray generator according to claim 1, wherein said electron beam is transmitted through said first crystalline structure substantially parallel to a crystal edge surface.

11. The X-ray generator according to claim 4, wherein the electron beam spot size is smaller than an absorption length of the parametric x-ray emission in material of the first crystalline structure.

12. The X-ray generator according to claim 1, wherein said electron source comprises a pulsed thermionic RF gun.

13. The X-ray generator according to claim 12, characterized by one of the following: said pulsed thermionic RF gun is configured to operate at repetition rates between about 200 Hz and about 460 Hz; or said pulsed thermionic RF gun is configured to operate at a repetition rate determined depending on said predetermined spot size of the electron beam and a thermal diffusion coefficient of the material of said first crystalline structure.

14. The X-ray generator according to claim 1, having dimensions of about 3×3 m².

15. The X-ray generator according to claim 1, further comprising one or more of the following: a power supply, RF modulator, a Klystron, a control system; and an optical transition radiation (OTR) system configured and operable to monitor a position and width of the electron beam on said first crystalline structure.

16. The X-ray generator according to claim 1, configured and operable to generate said electron beam with maximal average current values in a range 500 μA-3 mA.

17. An X-ray generator comprising:
an electron source configured and operable to produce a pulsed electron beam;
a laser source configured and operable to produce a pulsed laser beam,
wherein the pulsed laser beam counter-propagates with the electron beam thereby generating an X-ray wave caused by undulation motion of the electrons; and
wherein interaction between the X-ray wave and the electron beam along an interaction length provides electron micro-bunching with periodicity of an X-ray wavelength and generation of collective coherent X-ray emission of X-rays by micro-bunched electrons, said X-rays substantially co-propagating with the electron beam.

18. The X-ray generator of claim 17, characterized by at least one of the following: the electron beam produced by the electron source has energy spread substantially not exceeding 10⁻⁵; and the electron source has emittance <2 nm-rad.

19. The X-ray generator of claim 17, wherein the pulsed electron beam is characterized by at least one of the following: the electron beam has a beam spot size of a few micrometers; and the pulsed electron beam has electron pulse density of at least
$$1 {0}^{21} - 1 {0}^{22} \frac{1}{{m}^{3}} .$$

20. The X-ray generator of claim 17, wherein the laser beam is characterized by at least one of the following:
the laser beam has a spot size ≥100 μm;
the laser beam has a spot size bigger than a spot size of the electron beam;
intensity fluctuations of the laser beam are <0.5%;
Rayleigh range of the laser beam is larger than the interaction length;
duration of the laser pulse is at least 10 picoseconds for soft X-ray and at least 100 picoseconds for hard X-ray;
the laser beam has a linewidth which satisfies Fourier transform-limited pulse duration and is smaller than the Pierce parameter defining said electron micro-bunching;
divergence of the laser beam is smaller than divergence of the electron beam;
parameters of the laser beam are selected in accordance with an operative wavelength of the laser source and in accordance with parameters of the electron beam source.

21. The X-ray generator of claim 17, wherein the laser beam has a spot size of a few hundredths micrometers, and the electron beam has a spot size of a few micrometers.

22. The X-ray generator of claim 17, wherein the laser beam a linewidth which satisfies Fourier transform-limited pulse duration and is smaller than the Pierce parameter defining said electron micro-bunching, an electric field strength of the laser beam being in a range of 100-250 GV/m.

23. The X-ray generator of claim 17, wherein parameters of the laser beam are selected in accordance with an operative wavelength of the laser source and in accordance with parameters of the electron beam source, said parameters of the laser beam comprising two or more of the following: laser beam energy, power, duration, coherence length, waist spot size and Rayleigh length.

24. The X-ray generator of claim 23, wherein the laser pulse energy, E (laser) is selected to satisfy the following condition:
$${E}_{p}^{( laser )} > \frac{{ϵ}_{0} {\vert {E}_{0} \vert}^{2}}{2} \frac{K {λ}_{u}^{3}}{{πρ}_{FEL}^{5 / 2}}$$
where ϵ₀ is a vacuum permittivity; E₀ is an electric field of the laser source; λᵤ is the operative wavelength of the laser source; K is the undulator parameter; and ρ_{FEL} is a Pierce parameter.

25. The X-ray source of claim 24, wherein the undulator parameter is determined as:
eE₀λᵤ/2πmₑc²
where e is the electron charge, mₑ is the electron mass; and c is the speed of light.

26. The X-ray source of claim 23, wherein the laser pulse energy is in a range of hundreds of Joules (J) to a few kJ.

27. The X-ray source of claim 23, wherein the pulse duration, τₚ, is selected to satisfy a condition:
$${τ}_{p} > \frac{{λ}_{u}}{c} \frac{1}{{ρ}_{FEL}}$$

28. The X-ray generator of claim 27, wherein the pulse duration is of a few hundredths picoseconds.

29. The X-ray source of claim 23, wherein the laser beam waist, w₀, is selected to satisfy a condition:
$${w}_{0} > \frac{{λ}_{u}^{4}}{π} \sqrt{\frac{8 {k}_{u}^{2} {γ}_{e}^{3}}{π {r}_{e} {n}_{e}}}$$
$$where$$
$${k}_{u} = \frac{2 π}{{λ}_{u}}$$
is a wave number; γₑ is the electron energy; rₑ is the electron radius, nₑ is the electron pulse density.

30. An X-ray generator comprising:
a cavity defining radiation propagation path between four mirrors, said cavity comprising an interaction region (point) on said propagation path;
an electron source configured and operable to produce a pulsed electron beam propagating along an electron beam path towards said interaction region;
a laser source unit configured and operable to produce a pulsed laser beam propagating along a laser beam path towards said interaction region,
wherein the pulsed laser beam counter-propagates with the electron beam along said radiation propagation path thereby generating an X-ray wave caused by undulation motion of the electrons; and
wherein multiple interactions between the X-ray wave, the electron beam, and the laser beam within said cavity at said interaction region provide exponentially increasing power of coherent X-ray emission of X-rays being generated to a predetermined saturation power.
